(19) United States
(12) Patent Application Publication
(10) Pub. No.: US 2026/0246965 A1
(43) Pub. Date: Aug. 20, 2026

(54) METHOD FOR IMAGE ENCODING/DECODING AND RECORDING MEDIUM STORING BITSTREAM

(71) Applicants: ELECTRONICS AND TELECOMMUNICATIONS RESEARCH INSTITUTE, Daejeon (KR); HANBAT NATIONAL UNIVERSITY INDUSTRY-ACADEMIC COOPERATION FOUNDATION, Daejeon (KR)

(72) Inventors: Woong LIM, Daejeon (KR); Dong Hyun KIM, Daejeon (KR); Jong Ho KIM, Daejeon (KR); Sung Chang LIM, Daejeon (KR); Jin Soo CHOI, Daejeon (KR); Hae Chul CHOI, Daejeon (KR); Hee Ji HAN, Daejeon (KR)

(21) Appl. No.: 19/161,682

(22) PCT Filed: Mar. 14, 2024
(86) PCT No.: PCT/KR2024/003272

§ 371 Date: Sep. 2, 2025

(30) Foreign Application Priority Data
Mar. 15, 2023 (KR) 10-2023-0034125

(51) Int. Cl. H04N 19/56; H04N 19/105; H04N 19/137; H04N 19/176

(52) U.S. Cl. CPC H04N 19/56; H04N 19/105; H04N 19/137; H04N 19/176

(57) ABSTRACT

The present disclosure provides a bilateral matching (BM)-based image encoding/decoding method and a recording medium. As an example, the image decoding method according to the present disclosure may comprise the steps of: deriving a first initial motion vector and a second initial motion vector for a target block; performing BM search for a first BM reference image and a second BM reference image by using the first initial motion vector and the second initial motion vector; and reconstructing the target block by using a first BM reference block and a second BM reference block acquired through the BM search.

### TECHNICAL FIELD

The present disclosure relates to a method, a device and a recording medium for image encoding/decoding.

### BACKGROUND ART

With the continuous development of the information and communication industries, broadcasting services supporting High-Definition (HD) resolution have been popularized all over the world. Through this popularization, a large number of users have become accustomed to high-resolution and high-definition images and/or video.

To satisfy users' demand for high definition, many institutions have accelerated the development of next-generation imaging devices. Users' interest in UHD TVs, having resolution that is more than four times as high as that of Full HD (FHD) TVs, as well as High-Definition TVs (HDTV) and FHD TVs, has increased. As interest therein has increased, image encoding/decoding technology for images having higher resolution and higher definition is currently required.

As image compression technology, there are various technologies, such as inter-prediction technology, intra-prediction technology, transform, quantization technology, filtering technology and entropy coding technology.

Inter-prediction technology is technology for predicting the value of a pixel included in a current picture using a picture previous to and/or a picture subsequent to the current picture. Intra-prediction technology is technology for predicting the value of a pixel included in a current picture using information about pixels in the current picture. Transform and quantization technology may be technology for compressing the energy of a residual signal. The entropy coding technology is technology for assigning a short codeword to a frequently occurring value and assigning a long codeword to a less frequently occurring value.

By utilizing this image compression technology, data about images may be effectively compressed, transmitted, and stored.

### DISCLOSURE

### Technical Problem

The present disclosure is to provide a BM-based image encoding/decoding device, method and recording medium.

Specifically, the present disclosure is to provide a method for predicting a target block based on BM in encoding/decoding an image.

Specifically, the present disclosure is to provide a method for predicting a residual signal of a target block based on BM in encoding/decoding an image.

Specifically, the present disclosure is to provide a method for refining a motion vector of a target block based on BM in encoding/decoding an image.

### Technical Solution

An image decoding method according to an embodiment of the present disclosure may include deriving a first initial motion vector and a second initial motion vector for a target block; performing bilateral matching (BM) search for a first BM reference image and a second BM reference image by using the first initial motion vector and the second initial motion vector; and reconstructing the target block by using a first BM reference block and a second BM reference block obtained through the BM search.

In an image decoding method according to an embodiment of the present disclosure, a BM optimal block may be derived based on an average operation or a weighted sum operation of the first BM reference block and the second BM reference block.

In an image decoding method according to an embodiment of the present disclosure, the BM optimal block may be configured as a prediction block of the target block.

In an image decoding method according to an embodiment of the present disclosure, a final prediction block of the target block may be obtained by performing a weighted sum operation between the BM block and an intra prediction block obtained by performing intra prediction on the target block.

In an image decoding method according to an embodiment of the present disclosure, the intra prediction block may be obtained by using an intra prediction mode predefined in a decoder.

In an image decoding method according to an embodiment of the present disclosure, an intra prediction mode for the intra prediction may be derived from the first BM reference block or the second BM reference block encoded by intra prediction.

In an image decoding method according to an embodiment of the present disclosure, a first weight applied to the intra prediction block and a second weight applied to the BM optimal block may be determined by comparing a threshold value with matching criteria between the first BM reference block and the second BM reference block.

In an image decoding method according to an embodiment of the present disclosure, a final prediction block of the target block may be obtained by performing a weighted sum operation between the BM block and an inter prediction block obtained by performing inter prediction on the target block.

In an image decoding method according to an embodiment of the present disclosure, the first BM reference image or the second BM reference image may be configured as a reference image for the inter prediction.

In an image decoding method according to an embodiment of the present disclosure, a residual block of the target block may be derived as a sum of a prediction residual block and a BM residual block, and the BM residual block may be obtained from residual coefficients decoded from a bitstream, and a residual block of the BM optimal block may be configured as the prediction residual block.

In an image decoding method according to an embodiment of the present disclosure, a residual block of the BM optimal block may be derived by subtracting a prediction block of the target block from the BM optimal block.

In an image decoding method according to an embodiment of the present disclosure, residual samples in the residual block may be reconstructed by using prediction residual samples in the prediction residual block only in a partial region of the target block.

In an image decoding method according to an embodiment of the present disclosure, the first initial motion vector may be derived based on Advanced Motion Vector Prediction (AMVP) encoding information, and the second initial motion vector may be derived based on merge encoding information.

In an image decoding method according to an embodiment of the present disclosure, the first initial motion vector may be configured to be the same as a motion vector of a merge candidate included in a merge candidate list, and a vector with the same size as and an opposite direction as the first initial motion vector may be configured as the second initial motion vector.

In an image decoding method according to an embodiment of the present disclosure, the BM search may be performed only in a BM search region within the first BM reference image and the second BM reference image.

In an image decoding method according to an embodiment of the present disclosure, a shape of the BM search region is determined based on index information indicating one of shape candidates and among the shape candidates, a first shape candidate may be a rectangular shape and a second shape candidate may be a rhombus shape.

In an image decoding method according to an embodiment of the present disclosure, the BM search region is configured as N times a size of a basic unit (N is a natural number greater than or equal to 1) based on a position indicated by an initial motion vector, and the basic unit may be at least one of the target unit, a coding tree unit or a virtual pipeline data unit (VPDU).

In an image decoding method according to an embodiment of the present disclosure, when at least a part of a region to be configured as the BM search region is beyond an image boundary, a residual region excluding a region beyond the image boundary may be configured as the BM search region.

An image encoding method according to an embodiment of the present disclosure may include deriving a first initial motion vector and a second initial motion vector for a target block; performing a BM search for a first bilateral matching (BM) reference image and a second BM reference image by using the first initial motion vector and the second initial motion vector; and reconstructing the target block by using a first BM reference block and a second BM reference block obtained through the BM search.

In the present disclosure, a recording medium for recording a bitstream generated by the image encoding method may be provided.

### Technical Effect

According to the present disclosure, a BM-based image encoding/decoding device, method and recording medium are provided.

According to the present disclosure, in encoding/decoding an image, there is an effect of improving prediction accuracy by predicting a target block based on BM.

According to the present disclosure, in encoding/decoding an image, there is an effect of reducing the amount of residual data to be encoded/decoded by predicting a residual signal based on BM.

According to the present disclosure, in encoding/decoding an image, there is an effect of improving prediction accuracy by refining a motion vector of a target block based on BM.

### BRIEF DESCRIPTION OF DRAWINGS

FIG. 1 is a block diagram illustrating the configuration of an embodiment of an encoding apparatus to which the present disclosure is applied.

FIG. 2 is a block diagram illustrating the configuration of an embodiment of a decoding apparatus to which the present disclosure is applied.

FIG. 3 is a diagram schematically illustrating the partition structure of an image when the image is encoded and decoded.

FIG. 4 is a diagram illustrating the form of a Prediction Unit (PU) that a Coding Unit (CU) can include.

FIG. 5 is a diagram illustrating the form of a Transform Unit (TU) that can be included in a CU.

FIG. 6 illustrates splitting of a block according to an example.

FIG. 7 is a diagram for explaining an embodiment of an intra-prediction procedure.

FIG. 8 is a diagram illustrating reference samples used in an intra-prediction procedure.

FIG. 9 is a diagram for explaining an embodiment of an inter-prediction procedure.

FIG. 10 illustrates spatial candidates according to an embodiment.

FIG. 11 illustrates the order of addition of motion information of spatial candidates to a merge list according to an embodiment.

FIG. 12 illustrates a transform and quantization process according to an example.

FIG. 13 illustrates diagonal scanning according to an example.

FIG. 14 illustrates horizontal scanning according to an example.

FIG. 15 illustrates vertical scanning according to an example.

FIG. 16 is a configuration diagram of an encoding apparatus according to an embodiment.

FIG. 17 is a configuration diagram of a decoding apparatus according to an embodiment.

FIG. 18 is a flowchart of a method for obtaining a prediction block based on a BM method according to an embodiment of the present disclosure.

FIGS. 19 and 20 show an example in which a BM reference block is determined by using a BM reference image.

FIGS. 21 and 22 show a BM motion vector derived through BM search.

FIG. 23 to FIG. 34 show an example related to a BM search region.

FIG. 35 shows an example in which a position of a target block is configured as a BM search start position.

FIG. 36 shows an example in which an initial motion vector is derived from a block adjacent to a target block.

FIG. 37 shows an example in which matching criteria are calculated by using pixels at a sub-sampled position.

FIG. 38 shows an example in which a BM residual signal is derived based on a BM optimal block.

FIG. 39 to FIG. 42 illustrate a region to which residual signal prediction in a target block is applied.

FIG. 43 is a drawing for describing an example of correcting a BM optimal block.

FIG. 44 shows an example in which a linear model coefficient is derived by using only some position pixels within a template.

FIG. 45 shows an example in which a downsampling filter is applied to a template.

FIG. 46 is a drawing for describing an application aspect of intra and BM blending prediction.

FIG. 47 is a drawing for describing an application aspect of inter and BM blending prediction.

### MODE FOR INVENTION

The present invention may be variously changed, and may have various embodiments, and specific embodiments will be described in detail below with reference to the attached drawings. However, it should be understood that those embodiments are not intended to limit the present invention to specific disclosure forms, and that they include all changes, equivalents or modifications included in the spirit and scope of the present invention.

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

Terms such as “first” and “second” may be used to describe various components, but the components are not restricted by the terms. The terms are used only to distinguish one component from another component. For example, a first component may be named a second component without departing from the scope of the present specification. Likewise, a second component may be named a first component. The terms “and/or” may include combinations of a plurality of related described items or any of a plurality of related described items.

It will be understood that when a component is referred to as being “connected” or “coupled” to another component, the two components may be directly connected or coupled to each other, or intervening components may be present between the two components. On the other hand, it will be understood that when a component is referred to as being “directly connected or coupled”, no intervening components are present between the two components.

Also, components described in the embodiments are independently shown in order to indicate different characteristic functions, but this does not mean that each of the components is formed of a separate piece of hardware or software. That is, the components are arranged and included separately for convenience of description. For example, at least two of the components may be integrated into a single component. Conversely, one component may be divided into multiple components. An embodiment into which the components are integrated or an embodiment in which some components are separated is included in the scope of the present specification as long as it does not depart from the essence of the present specification.

The terms used in the embodiment are merely used to describe specific embodiments and are not intended to limit the present invention. A singular expression includes a plural expression unless a description to the contrary is specifically pointed out in context. In the embodiments, it should be understood that the terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present invention or the technical spirit of the present invention, but does not preclude the presence of components other than the specific component.

In the embodiments, a term “at least one” may mean one of one or more numbers, such as 1, 2, 3, and 4. In the embodiments, a term “a plurality of” may mean one of two or more numbers, such as 2, 3 and 4.

Some components of the embodiments are not essential components for performing essential functions, but may be optional components for improving only performance. The embodiments may be implemented using only essential components for implementing the essence of the embodiments. For example, a structure including only essential components, excluding optional components used only to improve performance, is also included in the scope of the embodiments.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted. Further, the same reference numerals are used to designate the same components throughout the drawings, and repeated descriptions of the same components will be omitted.

Hereinafter, “image” may mean a single picture constituting a video, or may mean the video itself. For example, “encoding and/or decoding of an image” may mean “encoding and/or decoding of a video”, and may also mean “encoding and/or decoding of any one of images constituting the video”.

Hereinafter, the terms “video” and “motion picture” may be used to have the same meaning, and may be used interchangeably with each other.

Hereinafter, a target image may be an encoding target image, which is the target to be encoded, and/or a decoding target image, which is the target to be decoded. Further, the target image may be an input image that is input to an encoding apparatus or an input image that is input to a decoding apparatus. And, a target image may be a current image, that is, the target to be currently encoded and/or decoded. For example, the terms “target image” and “current image” may be used to have the same meaning, and may be used interchangeably with each other.

Hereinafter, the terms “image”, “picture”, “frame”, and “screen” may be used to have the same meaning and may be used interchangeably with each other.

Hereinafter, a target block may be an encoding target block, i.e. the target to be encoded and/or a decoding target block, i.e. the target to be decoded. Further, the target block may be a current block, i.e. the target to be currently encoded and/or decoded. Here, the terms “target block” and “current block” may be used to have the same meaning, and may be used interchangeably with each other. A current block may denote an encoding target block, which is the target of encoding, during encoding and/or a decoding target block, which is the target of decoding, during decoding. Also, the current block may be at least one of a coding block, a prediction block, a residual block, and a transform block.

Hereinafter, the terms “block” and “unit” may be used to have the same meaning, and may be used interchangeably with each other. Alternatively, “block” may denote a specific unit.

Hereinafter, the terms “region” and “segment” may be used interchangeably with each other.

In the following embodiments, specific information, data, a flag, an index, an element, and an attribute may have their respective values. A value of “0” corresponding to each of the information, data, flag, index, element, and attribute may indicate a false, a logical false or a first predefined value. In other words, the value of “0”, a false, logical false, and a first predefined value may be used interchangeably with each other. A value of “1” corresponding to each of the information, data, flag, index, element, and attribute may indicate a true, a logical true or a second predefined value. In other words, the value of “1”, true, logical true, and a second predefined value may be used interchangeably with each other.

When a variable such as i or j is used to indicate a row, a column, or an index, the value of i may be an integer of 0 or more or an integer of 1 or more. In other words, in the embodiments, each of a row, a column, and an index may be counted from 0 or may be counted from 1.

In embodiments, the term “one or more” or the term “at least one” may mean the term “plural”. The term “one or more” or the term “at least one” may be used interchangeably with “plural”.

Below, the terms to be used in embodiments will be described.

Encoder: An encoder denotes a device for performing encoding. That is, an encoder may mean an encoding apparatus.

Decoder: A decoder denotes a device for performing decoding. That is, a decoder may mean a decoding apparatus.

Unit: A unit may denote the unit of image encoding and decoding. The terms “unit” and “block” may be used to have the same meaning, and may be used interchangeably with each other.
A unit may be an M×N array of samples. Each of M and N may be a positive integer. A unit may typically mean an array of samples in the form of two-dimensions.
In the encoding and decoding of an image, “unit” may be an area generated by the partitioning of one image. In other words, “unit” may be a region specified in one image. A single image may be partitioned into multiple units. Alternatively, one image may be partitioned into sub-parts, and the unit may denote each partitioned sub-part when encoding or decoding is performed on the partitioned sub-part.
In the encoding and decoding of an image, predefined processing may be performed on each unit depending on the type of the unit.
Depending on functions, the unit types may be classified into a macro unit, a Coding Unit (CU), a Prediction Unit (PU), a residual unit, a Transform Unit (TU), etc. Alternatively, depending on functions, the unit may denote a block, a macroblock, a coding tree unit, a coding tree block, a coding unit, a coding block, a prediction unit, a prediction block, a residual unit, a residual block, a transform unit, a transform block, etc. For example, a target unit, which is the target of encoding and/or decoding, may be at least one of a CU, a PU, a residual unit, and a TU.
The term “unit” may mean information including a luminance (luma) component block, a chrominance (chroma) component block corresponding thereto, and syntax elements for respective blocks so that the unit is designated to be distinguished from a block.
The size and shape of a unit may be variously implemented. Further, a unit may have any of various sizes and shapes. In particular, the shapes of the unit may include not only a square, but also a geometric figure that can be represented in two dimensions (2D), such as a rectangle, a trapezoid, a triangle, and a pentagon.
Further, unit information may include one or more of the type of a unit, the size of a unit, the depth of a unit, the order of encoding of a unit and the order of decoding of a unit, etc. For example, the type of a unit may indicate one of a CU, a PU, a residual unit and a TU.
One unit may be partitioned into sub-units, each having a smaller size than that of the relevant unit.

Depth: A depth may mean an extent to which the unit is partitioned. Further, the depth of the unit may indicate the level at which the corresponding unit is present when unit(s) are represented by a tree structure.
Unit partition information may include a depth indicating the depth of a unit. A depth may indicate the number of times the unit is partitioned and/or the degree to which the unit is partitioned.
In a tree structure, it may be considered that the depth of a root node is the smallest, and the depth of a leaf node is the largest. The root node may be the highest (top) node. The leaf node may be a lowest node.
A single unit may be hierarchically partitioned into multiple sub-units while having depth information based on a tree structure. In other words, the unit and sub-units, generated by partitioning the unit, may correspond to a node and child nodes of the node, respectively. Each of the partitioned sub-units may have a unit depth. Since the depth indicates the number of times the unit is partitioned and/or the degree to which the unit is partitioned, the partition information of the sub-units may include information about the sizes of the sub-units.
In a tree structure, the top node may correspond to the initial node before partitioning. The top node may be referred to as a “root node”. Further, the root node may have a minimum depth value. Here, the top node may have a depth of level ‘0’.
A node having a depth of level ‘1’ may denote a unit generated when the initial unit is partitioned once. A node having a depth of level ‘2’ may denote a unit generated when the initial unit is partitioned twice.
A leaf node having a depth of level ‘n’ may denote a unit generated when the initial unit has been partitioned n times.
The leaf node may be a bottom node, which cannot be partitioned any further. The depth of the leaf node may be the maximum level. For example, a predefined value for the maximum level may be 3.
A QT depth may denote a depth for a quad-partitioning. A BT depth may denote a depth for a binary-partitioning. A TT depth may denote a depth for a ternary-partitioning.

Sample: A sample may be a base unit constituting a block. A sample may be represented by values from 0 to 2Bd-1 depending on the bit depth (Bd).
A sample may be a pixel or a pixel value.
Hereinafter, the terms “pixel” and “sample” may be used to have the same meaning, and may be used interchangeably with each other.

A Coding Tree Unit (CTU): A CTU may be composed of a single luma component (Y) coding tree block and two chroma component (Cb, Cr) coding tree blocks related to the luma component coding tree block. Further, a CTU may mean information including the above blocks and a syntax element for each of the blocks.
Each coding tree unit (CTU) may be partitioned using one or more partitioning methods, such as a quad tree (QT), a binary tree (BT), and a ternary tree (TT) so as to configure sub-units, such as a coding unit, a prediction unit, and a transform unit. A quad tree may mean a quarternary tree. Further, each coding tree unit may be partitioned using a multitype tree (MTT) using one or more partitioning methods.
“CTU” may be used as a term designating a pixel block, which is a processing unit in an image-decoding and encoding process, as in the case of partitioning of an input image.

Coding Tree Block (CTB): “CTB” may be used as a term designating any one of a Y coding tree block, a Cb coding tree block, and a Cr coding tree block.

Neighbor block: A neighbor block (or neighboring block) may mean a block adjacent to a target block. A neighbor block may mean a reconstructed neighbor block.
Hereinafter, the terms “neighbor block” and “adjacent block” may be used to have the same meaning and may be used interchangeably with each other.
A neighbor block may mean a reconstructed neighbor block.

Spatial neighbor block; A spatial neighbor block may a block spatially adjacent to a target block. A neighbor block may include a spatial neighbor block.
The target block and the spatial neighbor block may be included in a target picture.
The spatial neighbor block may mean a block, the boundary of which is in contact with the target block, or a block located within a predetermined distance from the target block.
The spatial neighbor block may mean a block adjacent to the vertex of the target block. Here, the block adjacent to the vertex of the target block may mean a block vertically adjacent to a neighbor block which is horizontally adjacent to the target block or a block horizontally adjacent to a neighbor block which is vertically adjacent to the target block.

Temporal neighbor block: A temporal neighbor block may be a block temporally adjacent to a target block. A neighbor block may include a temporal neighbor block.
The temporal neighbor block may include a co-located block (col block).
The col block may be a block in a previously reconstructed co-located picture (col picture). The location of the col block in the col-picture may correspond to the location of the target block in a target picture. Alternatively, the location of the col block in the col-picture may be equal to the location of the target block in the target picture. The col picture may be a picture included in a reference picture list.
The temporal neighbor block may be a block temporally adjacent to a spatial neighbor block of a target block.

Prediction mode: The prediction mode may be information indicating the mode used for intra prediction, or the mode used for inter prediction.

Prediction unit: A prediction unit may be a base unit for prediction, such as inter prediction, intra prediction, inter compensation, intra compensation, and motion compensation.

A single prediction unit may be divided into multiple partitions having smaller sizes or sub-prediction units. The multiple partitions may also be base units in the performance of prediction or compensation. The partitions generated by dividing the prediction unit may also be prediction units.

Prediction unit partition: A prediction unit partition may be the shape into which a prediction unit is divided.

Reconstructed neighbor unit: A reconstructed neighbor unit may be a unit which has already been decoded and reconstructed neighboring a target unit.
A reconstructed neighbor unit may be a unit that is spatially adjacent to the target unit or that is temporally adjacent to the target unit.
A reconstructed spatial neighbor unit may be a unit which is included in a target picture and which has already been reconstructed through encoding and/or decoding.
A reconstructed temporal neighbor unit may be a unit which is included in a reference image and which has already been reconstructed through encoding and/or decoding. The location of the reconstructed temporal neighbor unit in the reference image may be identical to that of the target unit in the target picture, or may correspond to the location of the target unit in the target picture. Also, a reconstructed temporal neighbor unit may be a block neighboring the corresponding block in a reference image. Here, the location of the corresponding block in the reference image may correspond to the location of the target block in the target image. Here, the fact that the locations of blocks correspond to each other may mean that the locations of the blocks are identical to each other, may mean that one block is included in another block, or may mean that one block occupies a specific location in another block.

Sub-picture: A picture may be divided into one or more sub-pictures. A sub-picture may be composed of one or more tile rows and one or more tile columns.
A sub-picture may be a region having a square shape or a rectangular (i.e., a non-square rectangular) shape in a picture. Further, a sub-picture may include one or more CTUs.
A sub-picture may be a rectangular region of one or more slices in a picture.
One sub-picture may include one or more tiles, one or more bricks, and/or one or more slices.

Tile: A tile may be a region having a square shape or rectangular (i.e., a non-square rectangular) shape in a picture.
A tile may include one or more CTUs.
A tile may be partitioned into one or more bricks.

Brick: A brick may denote one or more CTU rows in a tile.
A tile may be partitioned into one or more bricks. Each brick may include one or more CTU rows.
A tile that is not partitioned into two parts may also denote a brick.

Slice: A slice may include one or more tiles in a picture. Alternatively, a slice may include one or more bricks in a tile.
A sub-picture may contain one or more slices that collectively cover a rectangular region of a picture. Consequently, each sub-picture boundary is also always a slice boundary, and each vertical sub-picture boundary is always also a vertical tile boundary.

Parameter set: A parameter set may correspond to header information in the internal structure of a bitstream.
A parameter set may include at least one of a video parameter set (VPS), a sequence parameter set (SPS), a picture parameter set (PPS), an adaptation parameter set (APS), a decoding parameter set (DPS), etc.

Information signaled through each parameter set may be applied to pictures which refer to the corresponding parameter set. For example, information in a VPS may be applied to pictures which refer to the VPS. Information in an SPS may be applied to pictures which refer to the SPS. Information in a PPS may be applied to pictures which refer to the PPS.

Each parameter set may refer to a higher parameter set. For example, a PPS may refer to an SPS. An SPS may refer to a VPS.
Further, a parameter set may include a tile group, slice header information, and tile header information. The tile group may be a group including multiple tiles. Also, the meaning of “tile group” may be identical to that of “slice”.

Rate-distortion optimization: An encoding apparatus may use rate-distortion optimization so as to provide high coding efficiency by utilizing combinations of the size of a coding unit (CU), a prediction mode, the size of a prediction unit (PU), motion information, and the size of a transform unit (TU).
A rate-distortion optimization scheme may calculate rate-distortion costs of respective combinations so as to select an optimal combination from among the combinations. The rate-distortion costs may be calculated using the equation “D+λ*R”. Generally, a combination enabling the rate-distortion cost to be minimized may be selected as the optimal combination in the rate-distortion optimization scheme.
D may denote distortion. D may be the mean of squares of differences (i.e. mean square error) between original transform coefficients and reconstructed transform coefficients in a transform unit.
R may denote the rate, which may denote a bit rate using related-context information.
λ denotes a Lagrangian multiplier. R may include not only coding parameter information, such as a prediction mode, motion information, and a coded block flag, but also bits generated due to the encoding of transform coefficients.
An encoding apparatus may perform procedures, such as inter prediction and/or intra prediction, transform, quantization, entropy encoding, inverse quantization (dequantization), and/or inverse transform so as to calculate precise D and R. These procedures may greatly increase the complexity of the encoding apparatus.

Bitstream: A bitstream may denote a stream of bits including encoded image information.

Parsing: Parsing may be the decision on the value of a syntax element, made by performing entropy decoding on a bitstream. Alternatively, the term “parsing” may mean such entropy decoding itself.

Symbol: A symbol may be at least one of the syntax element, the coding parameter, and the transform coefficient of an encoding target unit and/or a decoding target unit. Further, a symbol may be the target of entropy encoding or the result of entropy decoding.

Reference picture: A reference picture may be an image referred to by a unit so as to perform inter prediction or motion compensation. Alternatively, a reference picture may be an image including a reference unit referred to by a target unit so as to perform inter prediction or motion compensation.

Hereinafter, the terms “reference picture” and “reference image” may be used to have the same meaning, and may be used interchangeably with each other.

Reference picture list: A reference picture list may be a list including one or more reference images used for inter prediction or motion compensation.
The types of a reference picture list may include List Combined (LC), List 0 (L0), List 1 (L1), List 2 (L2), List 3 (L3), etc.
For inter prediction, one or more reference picture lists may be used.

Inter-prediction indicator: An inter-prediction indicator may indicate the inter-prediction direction for a target unit. Inter prediction may be one of unidirectional prediction and bidirectional prediction. Alternatively, the inter-prediction indicator may denote the number of reference pictures used to generate a prediction unit of a target unit. Alternatively, the inter-prediction indicator may denote the number of prediction blocks used for inter prediction or motion compensation of a target unit.

Prediction list utilization flag: A prediction list utilization flag may indicate whether a prediction unit is generated using at least one reference picture in a specific reference picture list.
An inter-prediction indicator may be derived using the prediction list utilization flag. In contrast, the prediction list utilization flag may be derived using the inter-prediction indicator. For example, the case where the prediction list utilization flag indicates “0”, which is a first value, may indicate that, for a target unit, a prediction block is not generated using a reference picture in a reference picture list. The case where the prediction list utilization flag indicates “1”, which is a second value, may indicate that, for a target unit, a prediction unit is generated using the reference picture list.

Reference picture index: A reference picture index may be an index indicating a specific reference picture in a reference picture list.

Picture Order Count (POC): A POC value for a picture may denote an order in which the corresponding picture is displayed.

Motion vector (MV): A motion vector may be a 2D vector used for inter prediction or motion compensation. A motion vector may mean an offset between a target image and a reference image.
For example, a MV may be represented in a form such as (mvₓ, mv_{y}). mvₓ may indicate a horizontal component, and mv_{y} may indicate a vertical component.

Search range: A search range may be a 2D area in which a search for a MV is performed during inter prediction. For example, the size of the search range may be MxN. M and N may be respective positive integers.

Motion vector candidate: A motion vector candidate may be a block that is a prediction candidate or the motion vector of the block that is a prediction candidate when a motion vector is predicted.
A motion vector candidate may be included in a motion vector candidate list.

Motion vector candidate list: A motion vector candidate list may be a list configured using one or more motion vector candidates.

Motion vector candidate index: A motion vector candidate index may be an indicator for indicating a motion vector candidate in the motion vector candidate list. Alternatively, a motion vector candidate index may be the index of a motion vector predictor.

Motion information: Motion information may be information including at least one of a reference picture list, a reference image, a motion vector candidate, a motion vector candidate index, a merge candidate, and a merge index, as well as a motion vector, a reference picture index, and an inter-prediction indicator.

Merge candidate list: A merge candidate list may be a list configured using one or more merge candidates.

Merge candidate: A merge candidate may be a spatial merge candidate, a temporal merge candidate, a combined merge candidate, a combined bi-prediction merge candidate, a candidate based on a history, a candidate based on an average of two candidates, a zero-merge candidate, etc. A merge candidate may include an inter-prediction indicator, and may include motion information such as prediction type information, a reference picture index for each list, a motion vector, a prediction list utilization flag, and an inter-prediction indicator.

Merge index: A merge index may be an indicator for indicating a merge candidate in a merge candidate list.

A merge index may indicate a reconstructed unit used to derive a merge candidate between a reconstructed unit spatially adjacent to a target unit and a reconstructed unit temporally adjacent to the target unit.
A merge index may indicate at least one of pieces of motion information of a merge candidate.

Transform unit: A transform unit may be the base unit of residual signal encoding and/or residual signal decoding, such as transform, inverse transform, quantization, dequantization, transform coefficient encoding, and transform coefficient decoding. A single transform unit may be partitioned into multiple sub-transform units having a smaller size. Here, a transform may include one or more of a primary transform and a secondary transform, and an inverse transform may include one or more of a primary inverse transform and a secondary inverse transform.

Scaling: Scaling may denote a procedure for multiplying a factor by a transform coefficient level.
As a result of scaling of the transform coefficient level, a transform coefficient may be generated. Scaling may also be referred to as “dequantization”.

Quantization Parameter (QP): A quantization parameter may be a value used to generate a transform coefficient level for a transform coefficient in quantization. Alternatively, a quantization parameter may also be a value used to generate a transform coefficient by scaling the transform coefficient level in dequantization. Alternatively, a quantization parameter may be a value mapped to a quantization step size.

Delta quantization parameter: A delta quantization parameter may mean a difference value between a predicted quantization parameter and the quantization parameter of a target unit.

Scan: Scan may denote a method for aligning the order of coefficients in a unit, a block or a matrix. For example, a method for aligning a 2D array in the form of a one-dimensional (1D) array may be referred to as a “scan”. Alternatively, a method for aligning a 1D array in the form of a 2D array may also be referred to as a “scan” or an “inverse scan”.

Transform coefficient: A transform coefficient may be a coefficient value generated as an encoding apparatus performs a transform. Alternatively, the transform coefficient may be a coefficient value generated as a decoding apparatus performs at least one of entropy decoding and dequantization.

A quantized level or a quantized transform coefficient level generated by applying quantization to a transform coefficient or a residual signal may also be included in the meaning of the term “transform coefficient”.

Quantized level: A quantized level may be a value generated as the encoding apparatus performs quantization on a transform coefficient or a residual signal. Alternatively, the quantized level may be a value that is the target of dequantization as the decoding apparatus performs dequantization.

A quantized transform coefficient level, which is the result of transform and quantization, may also be included in the meaning of a quantized level.

Non-zero transform coefficient: A non-zero transform coefficient may be a transform coefficient having a value other than 0 or a transform coefficient level having a value other than 0. Alternatively, a non-zero transform coefficient may be a transform coefficient, the magnitude of the value of which is not 0, or a transform coefficient level, the magnitude of the value of which is not 0.

Quantization matrix: A quantization matrix may be a matrix used in a quantization procedure or a dequantization procedure so as to improve the subjective image quality or objective image quality of an image. A quantization matrix may also be referred to as a “scaling list”.

Quantization matrix coefficient: A quantization matrix coefficient may be each element in a quantization matrix. A quantization matrix coefficient may also be referred to as a “matrix coefficient”.

Default matrix: A default matrix may be a quantization matrix predefined by the encoding apparatus and the decoding apparatus.

Non-default matrix: A non-default matrix may be a quantization matrix that is not predefined by the encoding apparatus and the decoding apparatus. The non-default matrix may mean a quantization matrix to be signaled from the encoding apparatus to the decoding apparatus by a user.

Most Probable Mode (MPM): An MPM may denote an intra-prediction mode having a high probability of being used for intra prediction for a target block.
An encoding apparatus and a decoding apparatus may determine one or more MPMs based on coding parameters related to the target block and the attributes of entities related to the target block.
The encoding apparatus and the decoding apparatus may determine one or more MPMs based on the intra-prediction mode of a reference block. The reference block may include multiple reference blocks. The multiple reference blocks may include spatial neighbor blocks adjacent to the left of the target block and spatial neighbor blocks adjacent to the top of the target block. In other words, depending on which intra-prediction modes have been used for the reference blocks, one or more different MPMs may be determined.
The one or more MPMs may be determined in the same manner both in the encoding apparatus and in the decoding apparatus. That is, the encoding apparatus and the decoding apparatus may share the same MPM list including one or more MPMs.

MPM list: An MPM list may be a list including one or more MPMs. The number of the one or more MPMs in the MPM list may be defined in advance.

MPM indicator: An MPM indicator may indicate an MPM to be used for intra prediction for a target block among one or more MPMs in the MPM list. For example, the MPM indicator may be an index for the MPM list.
Since the MPM list is determined in the same manner both in the encoding apparatus and in the decoding apparatus, there may be no need to transmit the MPM list itself from the encoding apparatus to the decoding apparatus.
The MPM indicator may be signaled from the encoding apparatus to the decoding apparatus. As the MPM indicator is signaled, the decoding apparatus may determine the MPM to be used for intra prediction for the target block among the MPMs in the MPM list.

MPM use indicator: An MPM use indicator may indicate whether an MPM usage mode is to be used for prediction for a target block. The MPM usage mode may be a mode in which the MPM to be used for intra prediction for the target block is determined using the MPM list.
The MPM use indicator may be signaled from the encoding apparatus to the decoding apparatus.

Signaling: “signaling” may denote that information is transferred from an encoding apparatus to a decoding apparatus. Alternatively, “signaling” may mean information is included in in a bitstream or a recoding medium by an encoding apparatus. Information signaled by an encoding apparatus may be used by a decoding apparatus.
The encoding apparatus may generate encoded information by performing encoding on information to be signaled. The encoded information may be transmitted from the encoding apparatus to the decoding apparatus. The decoding apparatus may obtain information by decoding the transmitted encoded information. Here, the encoding may be entropy encoding, and the decoding may be entropy decoding.

Selective Signaling: Information may be signaled selectively. A selective signaling FOR information may mean that an encoding apparatus selectively includes information (according to a specific condition) in a bitstream or a recording medium. Selective signaling for information may mean that a decoding apparatus selectively extracts information from a bitstream (according to a specific condition).

Omission of signaling: Signaling for information may be omitted. Omission of signaling for information on information may mean that an encoding apparatus does not include information (according to a specific condition) in a bitstream or a recording medium. Omission of signaling for information may mean that a decoding apparatus does not extract information from a bitstream (according to a specific condition).

Statistic value: A variable, a coding parameter, a constant, etc. may have values that can be calculated. The statistic value may be a value generated by performing calculations (operations) on the values of specified targets. For example, the statistic value may indicate one or more of the average, weighted average, weighted sum, minimum value, maximum value, mode, median value, and interpolated value of the values of a specific variable, a specific coding parameter, a specific constant, or the like.

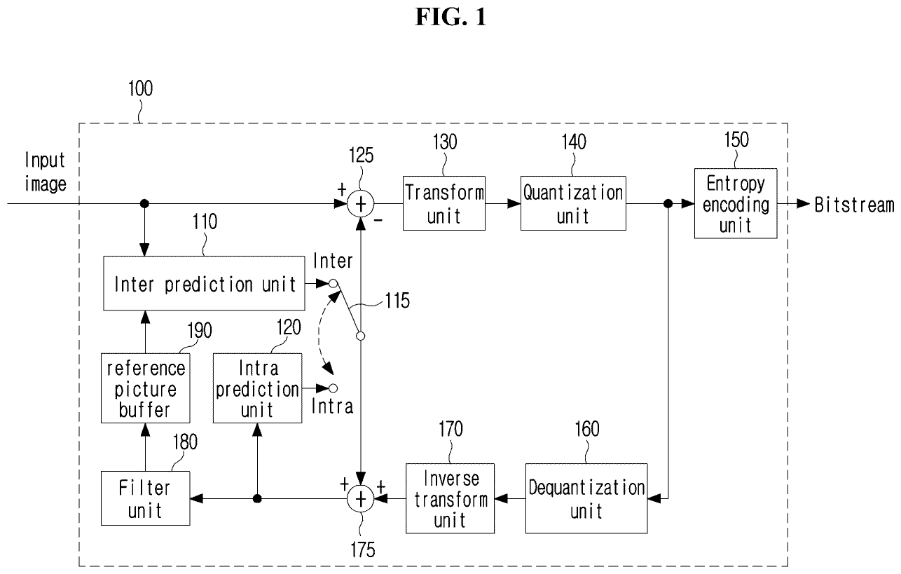

FIG. 1 is a block diagram illustrating the configuration of an embodiment of an encoding apparatus to which the present disclosure is applied.

An encoding apparatus 100 may be an encoder, a video encoding apparatus or an image encoding apparatus. A video may include one or more images. The encoding apparatus 100 may sequentially encode one or more images of the video.

Referring to FIG. 1, the encoding apparatus 100 includes an inter-prediction unit 110, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180 and a reference picture buffer 190.

The encoding apparatus 100 may perform encoding on a target image using an intra mode and/or an inter mode. In other words, a prediction mode for a target block may be one of an intra mode and an inter mode.

Hereinafter, the terms “intra mode”, “intra-prediction mode”, “intra-picture mode” and “intra-picture prediction mode” may be used to have the same meaning, and may be used interchangeably with each other.

Hereinafter, the terms “inter mode”, “inter-prediction mode”, “inter-picture mode” and “inter-picture prediction mode” may be used to have the same meaning, and may be used interchangeably with each other.

Hereinafter, the term “image” may indicate only part of an image, or may indicate a block. Also, the processing of an “image” may indicate sequential processing of multiple blocks.

Further, the encoding apparatus 100 may generate a bitstream, including encoded information, via encoding on the target image, and may output and store the generated bitstream. The generated bitstream may be stored in a computer-readable storage medium and may be streamed through a wired and/or wireless transmission medium.

When the intra mode is used as a prediction mode, the switch 115 may switch to the intra mode. When the inter mode is used as a prediction mode, the switch 115 may switch to the inter mode.

The encoding apparatus 100 may generate a prediction block of a target block. Further, after the prediction block has been generated, the encoding apparatus 100 may encode a residual block for the target block using a residual between the target block and the prediction block.

When the prediction mode is the intra mode, the intra-prediction unit 120 may use pixels of previously encoded/decoded neighbor blocks adjacent to the target block as reference samples. The intra-prediction unit 120 may perform spatial prediction on the target block using the reference samples, and may generate prediction samples for the target block via spatial prediction. The prediction samples may mean samples in the prediction block.

The inter-prediction unit 110 may include a motion prediction unit and a motion compensation unit.

When the prediction mode is an inter mode, the motion prediction unit may search a reference image for the area most closely matching the target block in a motion prediction procedure, and may derive a motion vector for the target block and the found area based on the found area. Here, the motion-prediction unit may use a search range as a target area for searching.

The reference image may be stored in the reference picture buffer 190. More specifically, an encoded and/or decoded reference image may be stored in the reference picture buffer 190 when the encoding and/or decoding of the reference image have been processed.

Since a decoded picture is stored, the reference picture buffer 190 may be a Decoded Picture Buffer (DPB).

The motion compensation unit may generate a prediction block for the target block by performing motion compensation using a motion vector. Here, the motion vector may be a two-dimensional (2D) vector used for inter-prediction. Further, the motion vector may indicate an offset between the target image and the reference image.

The motion prediction unit and the motion compensation unit may generate a prediction block by applying an interpolation filter to a partial area of a reference image when the motion vector has a value other than an integer. In order to perform inter prediction or motion compensation, it may be determined which one of a skip mode, a merge mode, an advanced motion vector prediction (AMVP) mode, and a current picture reference mode corresponds to a method for predicting the motion of a PU included in a CU, based on the CU, and compensating for the motion, and inter prediction or motion compensation may be performed depending on the mode.

The subtractor 125 may generate a residual block, which is the differential between the target block and the prediction block. A residual block may also be referred to as a “residual signal”.

The residual signal may be the difference between an original signal and a prediction signal. Alternatively, the residual signal may be a signal generated by transforming or quantizing the difference between an original signal and a prediction signal or by transforming and quantizing the difference. A residual block may be a residual signal for a block unit.

The transform unit 130 may generate a transform coefficient by transforming the residual block, and may output the generated transform coefficient. Here, the transform coefficient may be a coefficient value generated by transforming the residual block.

The transform unit 130 may use one of multiple predefined transform methods when performing a transform.

The multiple predefined transform methods may include a Discrete Cosine Transform (DCT), a Discrete Sine Transform (DST), a Karhunen-Loeve Transform (KLT), etc.

The transform method used to transform a residual block may be determined depending on at least one of coding parameters for a target block and/or a neighbor block. For example, the transform method may be determined based on at least one of an inter-prediction mode for a PU, an intra-prediction mode for a PU, the size of a TU, and the shape of a TU. Alternatively, transformation information indicating the transform method may be signaled from the encoding apparatus 100 to the decoding apparatus 200.

When a transform skip mode is used, the transform unit 130 may omit transforming the residual block.

By applying quantization to the transform coefficient, a quantized transform coefficient level or a quantized level may be generated. Hereinafter, in the embodiments, each of the quantized transform coefficient level and the quantized level may also be referred to as a ‘transform coefficient’.

The quantization unit 140 may generate a quantized transform coefficient level (i.e., a quantized level or a quantized coefficient) by quantizing the transform coefficient depending on quantization parameters. The quantization unit 140 may output the quantized transform coefficient level that is generated. In this case, the quantization unit 140 may quantize the transform coefficient using a quantization matrix.

The entropy encoding unit 150 may generate a bitstream by performing probability distribution-based entropy encoding based on values, calculated by the quantization unit 140, and/or coding parameter values, calculated in the encoding procedure. The entropy encoding unit 150 may output the generated bitstream.

The entropy encoding unit 150 may perform entropy encoding on information about the pixels of the image and information required to decode the image. For example, the information required to decode the image may include syntax elements or the like.

When entropy encoding is applied, fewer bits may be assigned to more frequently occurring symbols, and more bits may be assigned to rarely occurring symbols. As symbols are represented by means of this assignment, the size of a bit string for target symbols to be encoded may be reduced. Therefore, the compression performance of video encoding may be improved through entropy encoding.

Further, for entropy encoding, the entropy encoding unit 150 may use a coding method such as exponential Golomb, Context-Adaptive Variable Length Coding (CAVLC), or Context-Adaptive Binary Arithmetic Coding (CABAC). For example, the entropy encoding unit 150 may perform entropy encoding using a Variable Length Coding/Code (VLC) table. For example, the entropy encoding unit 150 may derive a binarization method for a target symbol. Further, the entropy encoding unit 150 may derive a probability model for a target symbol/bin. The entropy encoding unit 150 may perform arithmetic coding using the derived binarization method, a probability model, and a context model.

The entropy encoding unit 150 may transform the coefficient of the form of a 2D block into the form of a 1D vector through a transform coefficient scanning method so as to encode a quantized transform coefficient level.

The coding parameters may be information required for encoding and/or decoding. The coding parameters may include information encoded by the encoding apparatus 100 and transferred from the encoding apparatus 100 to a decoding apparatus, and may also include information that may be derived in the encoding or decoding procedure. For example, information transferred to the decoding apparatus may include syntax elements.

The coding parameters may include not only information (or a flag or an index), such as a syntax element, which is encoded by the encoding apparatus and is signaled by the encoding apparatus to the decoding apparatus, but also information derived in an encoding or decoding process. Further, the coding parameters may include information required so as to encode or decode images. For example, the coding parameters may include at least one value, combinations or statistics of a size of a unit/block, a shape/form of a unit/block, a depth of a unit/block, partition information of a unit/block, a partition structure of a unit/block, information indicating whether a unit/block is partitioned in a quad-tree structure, information indicating whether a unit/block is partitioned in a binary tree structure, a partitioning direction of a binary tree structure (horizontal direction or vertical direction), a partitioning form of a binary tree structure (symmetrical partitioning or asymmetrical partitioning), information indicating whether a unit/block is partitioned in a ternary tree structure, a partitioning direction of a ternary tree structure (horizontal direction or vertical direction), a partitioning form of a ternary tree structure (symmetrical partitioning or asymmetrical partitioning, etc.), information indicating whether a unit/block is partitioned in a multi-type tree structure, a combination and a direction (horizontal direction or vertical direction, etc.) of a partitioning of the multi-type tree structure, a partitioning form of a multi-type tree structure (symmetrical partitioning or asymmetrical partitioning, etc.), a partitioning tree (a binary tree or a ternary tree) of the multi-type tree form, a type of a prediction (intra prediction or inter prediction), an intra-prediction mode/direction, an intra luma prediction mode/direction, an intra chroma prediction mode/direction, an intra partitioning information, an inter partitioning information, a coding block partitioning flag, a prediction block partitioning flag, a transform block partitioning flag, a reference sample filtering method, a reference sample filter tap, a reference sample filter coefficient, a prediction block filtering method, a prediction block filter tap, a prediction block filter coefficient, a prediction block boundary filtering method, a prediction block boundary filter tap, a prediction block boundary filter coefficient, an inter-prediction mode, motion information, a motion vector, a motion vector difference, a reference picture index, an inter-prediction direction, an inter-prediction indicator, a prediction list utilization flag, a reference picture list, a reference image, a POC, a motion vector predictor, a motion vector prediction index, a motion vector prediction candidate, a motion vector candidate list, information indicating whether a merge mode is used, a merge index, a merge candidate, a merge candidate list, information indicating whether a skip mode is used, a type of an interpolation filter, a tap of an interpolation filter, a filter coefficient of an interpolation filter, a magnitude of a motion vector, accuracy of motion vector representation, a transform type, a transform size, information indicating whether a first transform is used, information indicating whether an additional (secondary) transform is used, first transform selection information (or a first transform index), secondary transform selection information (or a secondary transform index), information indicating a presence or absence of a residual signal, a coded block pattern, a coded block flag, a quantization parameter, a residual quantization parameter, a quantization matrix, information about an intra-loop filter, information indicating whether an intra-loop filter is applied, a coefficient of an intra-loop filter, a tap of an intra-loop filter, a shape/form of an intra-loop filter, information indicating whether a deblocking filter is applied, a coefficient of a deblocking filter, a tap of a deblocking filter, deblocking filter strength, a shape/form of a deblocking filter, information indicating whether an adaptive sample offset is applied, a value of an adaptive sample offset, a category of an adaptive sample offset, a type of an adaptive sample offset, information indicating whether an adaptive in-loop filter is applied, a coefficient of an adaptive in-loop filter, a tap of an adaptive in-loop filter, a shape/form of an adaptive in-loop filter, a binarization/inverse binarization method, a context model, a context model decision method, a context model update method, information indicating whether a regular mode is performed, information whether a bypass mode is performed, a significant coefficient flag, a last significant coefficient flag, a coding flag for a coefficient group, a position of a last significant coefficient, information indicating whether a value of a coefficient is greater than 1, information indicating whether a value of a coefficient is greater than 2, information indicating whether a value of a coefficient is greater than 3, a remaining coefficient value information, a sign information, a reconstructed luma sample, a reconstructed chroma sample, a context bin, a bypass bin, a residual luma sample, a residual chroma sample, a transform coefficient, a luma transform coefficient, a chroma transform coefficient, a quantized level, a luma quantized level, a chroma quantized level, a transform coefficient level, a transform coefficient level scanning method, a size of a motion vector search region on a side of a decoding apparatus, a shape/form of a motion vector search region on a side of a decoding apparatus, the number of a motion vector search on a side of a decoding apparatus, a size of a CTU, a minimum block size, a maximum block size, a maximum block depth, a minimum block depth, an image display/output order, slice identification information, a slice type, slice partition information, tile group identification information, a tile group type, a tile group partitioning information, tile identification information, a tile type, tile partitioning information, a picture type, bit depth, input sample bit depth, reconstructed sample bit depth, residual sample bit depth, transform coefficient bit depth, quantized level bit depth, information about a luma signal, information about a chroma signal, a color space of a target block and a color space of a residual block. Further, the above-described coding parameter-related information may also be included in the coding parameter. Information used to calculate and/or derive the above-described coding parameter may also be included in the coding parameter. Information calculated or derived using the above-described coding parameter may also be included in the coding parameter.

The first transform selection information may indicate a first transform which is applied to a target block.

The second transform selection information may indicate a second transform which is applied to a target block.

The residual signal may denote the difference between the original signal and a prediction signal. Alternatively, the residual signal may be a signal generated by transforming the difference between the original signal and the prediction signal. Alternatively, the residual signal may be a signal generated by transforming and quantizing the difference between the original signal and the prediction signal. A residual block may be the residual signal for a block.

Here, signaling information may mean that the encoding apparatus 100 includes an entropy-encoded information, generated by performing entropy encoding a flag or an index, in a bitstream, and that the decoding apparatus 200 acquires information by performing entropy decoding on the entropy-encoded information, extracted from the bitstream. Here, the information may comprise a flag, an index, etc.

A signal may mean information to be signaled. Hereinafter, information for an image and a block may be referred to as a signal. Further, hereinafter, the terms “information” and “signal” may be used to have the same meaning and may be used interchangeably with each other. For example, a specific signal may be a signal representing a specific block. An original signal may be a signal representing a target block. A prediction signal may be a signal representing a prediction block. A residual signal may be a signal representing a residual block.

A bitstream may include information based on a specific syntax. The encoding apparatus 100 may generate a bitstream including information depending on a specific syntax. The decoding apparatus 200 may acquire information from the bitstream depending on a specific syntax.

Since the encoding apparatus 100 performs encoding via inter prediction, the encoded target image may be used as a reference image for additional image(s) to be subsequently processed. Therefore, the encoding apparatus 100 may reconstruct or decode the encoded target image and store the reconstructed or decoded image as a reference image in the reference picture buffer 190. For decoding, dequantization and inverse transform on the encoded target image may be processed.

The quantized level may be inversely quantized by the dequantization unit 160, and may be inversely transformed by the inverse transform unit 170. The dequantization unit 160 may generate an inversely quantized coefficient by performing inverse transform for the quantized level. The inverse transform unit 170 may generate a inversely quantized and inversely transformed coefficient by performing inverse transform for the inversely quantized coefficient.

The inversely quantized and inversely transformed coefficient may be added to the prediction block by the adder 175. The inversely quantized and inversely transformed coefficient and the prediction block are added, and then a reconstructed block may be generated. Here, the inversely quantized and/or inversely transformed coefficient may denote a coefficient on which one or more of dequantization and inverse transform are performed, and may also denote a reconstructed residual block. Here, the reconstructed block may mean a recovered block or a decoded block.

The reconstructed block may be subjected to filtering through the filter unit 180. The filter unit 180 may apply one or more of a deblocking filter, a Sample Adaptive Offset (SAO) filter, an Adaptive Loop Filter (ALF), and a Non Local Filter (NLF) to a reconstructed sample, the reconstructed block or a reconstructed picture. The filter unit 180 may also be referred to as an “in-loop filter”.

The deblocking filter may eliminate block distortion occurring at the boundaries between blocks in a reconstructed picture. In order to determine whether to apply the deblocking filter, the number of columns or rows which are included in a block and which include pixel(s) based on which it is determined whether to apply the deblocking filter to a target block may be decided on.

When the deblocking filter is applied to the target block, the applied filter may differ depending on the strength of the required deblocking filtering. In other words, among different filters, a filter decided on in consideration of the strength of deblocking filtering may be applied to the target block. When a deblocking filter is applied to a target block, one or more filters of a long-tap filter, a strong filter, a weak filter and Gaussian filter may be applied to the target block depending on the strength of required deblocking filtering.

Also, when vertical filtering and horizontal filtering are performed on the target block, the horizontal filtering and the vertical filtering may be processed in parallel.

The SAO may add a suitable offset to the values of pixels to compensate for coding error. The SAO may perform, for the image to which deblocking is applied, correction that uses an offset in the difference between an original image and the image to which deblocking is applied, on a pixel basis. To perform an offset correction for an image, a method for dividing the pixels included in the image into a certain number of regions, determining a region to which an offset is to be applied, among the divided regions, and applying an offset to the determined region may be used, and a method for applying an offset in consideration of edge information of each pixel may also be used.

The ALF may perform filtering based on a value obtained by comparing a reconstructed image with an original image. After pixels included in an image have been divided into a predetermined number of groups, filters to be applied to each group may be determined, and filtering may be differentially performed for respective groups. information related to whether to apply an adaptive loop filter may be signaled for each CU. Such information may be signaled for a luma signal. The shapes and filter coefficients of ALFs to be applied to respective blocks may differ for respective blocks. Alternatively, regardless of the features of a block, an ALF having a fixed form may be applied to the block.

A non-local filter may perform filtering based on reconstructed blocks, similar to a target block. A region similar to the target block may be selected from a reconstructed picture, and filtering of the target block may be performed using the statistical properties of the selected similar region. Information about whether to apply a non-local filter may be signaled for a Coding Unit (CU). Also, the shapes and filter coefficients of the non-local filter to be applied to blocks may differ depending on the blocks.

The reconstructed block or the reconstructed image subjected to filtering through the filter unit 180 may be stored in the reference picture buffer 190 as a reference picture. The reconstructed block subjected to filtering through the filter unit 180 may be a part of a reference picture. In other words, the reference picture may be a reconstructed picture composed of reconstructed blocks subjected to filtering through the filter unit 180. The stored reference picture may be subsequently used for inter prediction or a motion compensation.

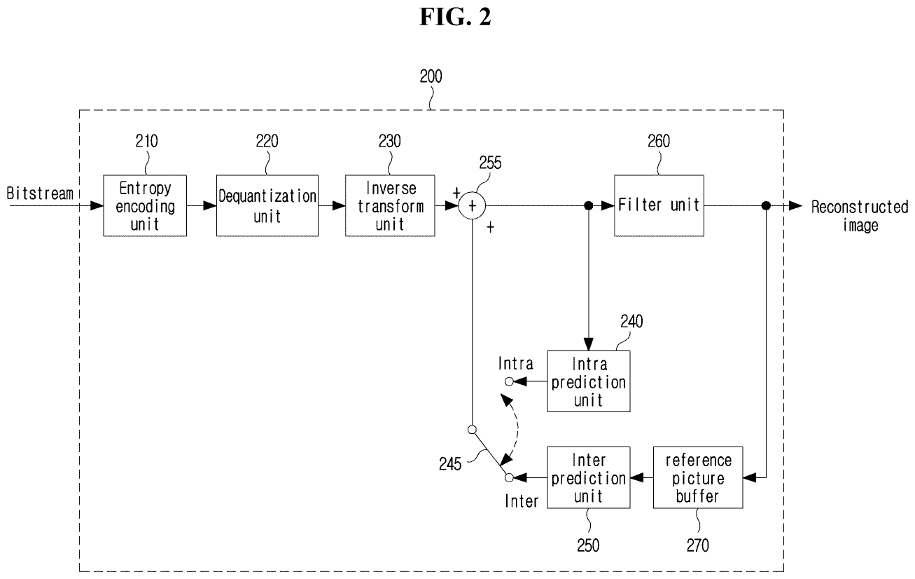

FIG. 2 is a block diagram illustrating the configuration of an embodiment of a decoding apparatus to which the present disclosure is applied.

A decoding apparatus 200 may be a decoder, a video decoding apparatus or an image decoding apparatus.

Referring to FIG. 2, the decoding apparatus 200 may include an entropy decoding unit 210, a dequantization (inverse quantization) unit 220, an inverse transform unit 230, an intra-prediction unit 240, an inter-prediction unit 250, a switch 245 an adder 255, a filter unit 260, and a reference picture buffer 270.

The decoding apparatus 200 may receive a bitstream output from the encoding apparatus 100. The decoding apparatus 200 may receive a bitstream stored in a computer-readable storage medium, and may receive a bitstream that is streamed through a wired/wireless transmission medium.

The decoding apparatus 200 may perform decoding on the bitstream in an intra mode and/or an inter mode. Further, the decoding apparatus 200 may generate a reconstructed image or a decoded image via decoding, and may output the reconstructed image or decoded image.

For example, switching to an intra mode or an inter mode based on the prediction mode used for decoding may be performed by the switch 245. When the prediction mode used for decoding is an intra mode, the switch 245 may be operated to switch to the intra mode. When the prediction mode used for decoding is an inter mode, the switch 245 may be operated to switch to the inter mode.

The decoding apparatus 200 may acquire a reconstructed residual block by decoding the input bitstream, and may generate a prediction block. When the reconstructed residual block and the prediction block are acquired, the decoding apparatus 200 may generate a reconstructed block, which is the target to be decoded, by adding the reconstructed residual block and the prediction block.

The entropy decoding unit 210 may generate symbols by performing entropy decoding on the bitstream based on the probability distribution of a bitstream. The generated symbols may include symbols in a form of a quantized transform coefficient level (i.e., a quantized level or a quantized coefficient). Here, the entropy decoding method may be similar to the above-described entropy encoding method. That is, the entropy decoding method may be the reverse procedure of the above-described entropy encoding method.

The entropy decoding unit 210 may change a coefficient having a one-dimensional (1D) vector form to a 2D block shape through a transform coefficient scanning method in order to decode a quantized transform coefficient level.

For example, the coefficients of the block may be changed to 2D block shapes by scanning the block coefficients using up-right diagonal scanning. Alternatively, which one of up-right diagonal scanning, vertical scanning, and horizontal scanning is to be used may be determined depending on the size and/or the intra-prediction mode of the corresponding block.

The quantized coefficient may be inversely quantized by the dequantization unit 220. The dequantization unit 220 may generate an inversely quantized coefficient by performing dequantization on the quantized coefficient. Further, the inversely quantized coefficient may be inversely transformed by the inverse transform unit 230. The inverse transform unit 230 may generate a reconstructed residual block by performing an inverse transform on the inversely quantized coefficient. As a result of performing dequantization and the inverse transform on the quantized coefficient, the reconstructed residual block may be generated. Here, the dequantization unit 220 may apply a quantization matrix to the quantized coefficient when generating the reconstructed residual block.

When the intra mode is used, the intra-prediction unit 240 may generate a prediction block by performing spatial prediction that uses the pixel values of previously decoded neighbor blocks adjacent to a target block for the target block.

The inter-prediction unit 250 may include a motion compensation unit. Alternatively, the inter-prediction unit 250 may be designated as a “motion compensation unit”.

When the inter mode is used, the motion compensation unit may generate a prediction block by performing motion compensation that uses a motion vector and a reference image stored in the reference picture buffer 270 for the target block.

The motion compensation unit may apply an interpolation filter to a partial area of the reference image when the motion vector has a value other than an integer, and may generate a prediction block using the reference image to which the interpolation filter is applied. In order to perform motion compensation, the motion compensation unit may determine which one of a skip mode, a merge mode, an Advanced Motion Vector Prediction (AMVP) mode, and a current picture reference mode corresponds to the motion compensation method used for a PU included in a CU, based on the CU, and may perform motion compensation depending on the determined mode.

The reconstructed residual block and the prediction block may be added to each other by the adder 255. The adder 255 may generate a reconstructed block by adding the reconstructed residual block to the prediction block.

The reconstructed block may be subjected to filtering through the filter unit 260. The filter unit 260 may apply at least one of a deblocking filter, an SAO filter, an ALF, and a NLF to the reconstructed block or the reconstructed image. The reconstructed image may be a picture including the reconstructed block.

The filter unit may output the reconstructed image.

The reconstructed image and/or the reconstructed block subjected to filtering through the filter unit 260 may be stored as a reference picture in the reference picture buffer 270. The reconstructed block subjected to filtering through the filter unit 260 may be a part of the reference picture. In other words, the reference picture may be an image composed of reconstructed blocks subjected to filtering through the filter unit 260. The stored reference picture may be subsequently used for inter prediction or a motion compensation.

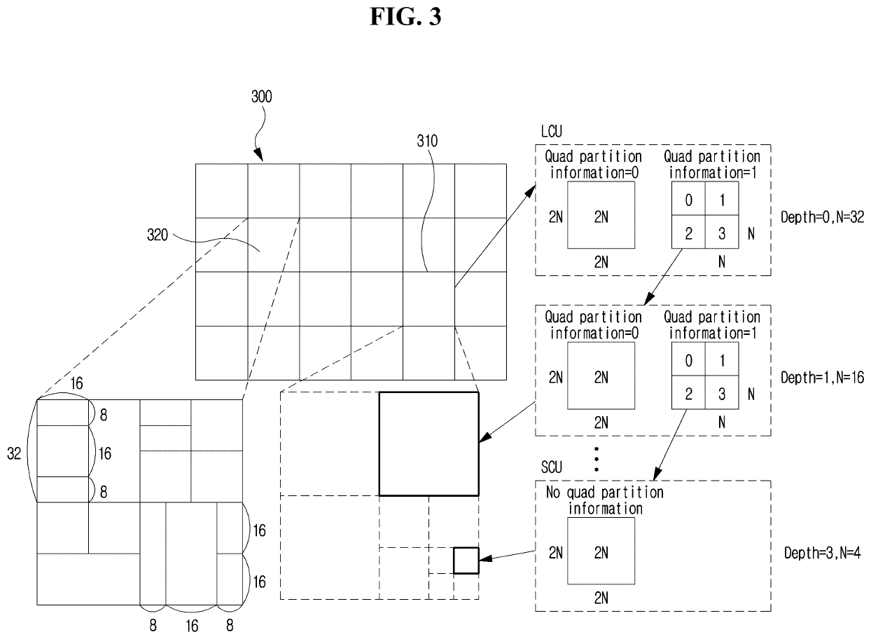

FIG. 3 is a diagram schematically illustrating the partition structure of an image when the image is encoded and decoded.

FIG. 3 may schematically illustrate an example in which a single unit is partitioned into multiple sub-units.

In order to efficiently partition the image, a Coding Unit (CU) may be used in encoding and decoding. The term “unit” may be used to collectively designate 1) a block including image samples and 2) a syntax element. For example, the “partitioning of a unit” may mean the “partitioning of a block corresponding to a unit”.

A CU may be used as a base unit for image encoding/decoding. A CU may be used as a unit to which one mode selected from an intra mode and an inter mode in image encoding/decoding is applied. In other words, in image encoding/decoding, which one of an intra mode and an inter mode is to be applied to each CU may be determined.

Further, a CU may be a base unit in prediction, transform, quantization, inverse transform, dequantization, and encoding/decoding of transform coefficients.

Referring to FIG. 3, an image 300 may be sequentially partitioned into units corresponding to a Largest Coding Unit (LCU), and a partition structure may be determined for each LCU. Here, the LCU may be used to have the same meaning as a Coding Tree Unit (CTU).

The partitioning of a unit may mean the partitioning of a block corresponding to the unit. Block partition information may include depth information about the depth of a unit. The depth information may indicate the number of times the unit is partitioned and/or the degree to which the unit is partitioned. A single unit may be hierarchically partitioned into a plurality of sub-units while having depth information based on a tree structure.

Each of partitioned sub-units may have depth information. The depth information may be information indicating the size of a CU. The depth information may be stored for each CU.

Each CU may have depth information. When the CU is partitioned, CUs resulting from partitioning may have a depth increased from the depth of the partitioned CU by 1.

The partition structure may mean the distribution of Coding Units (CUs) to efficiently encode the image in an LCU 310. Such a distribution may be determined depending on whether a single CU is to be partitioned into multiple CUs. The number of CUs generated by partitioning may be a positive integer of 2 or more, including 2, 3, 4, 8, 16, etc.

The horizontal size and the vertical size of each of CUs generated by the partitioning may be less than the horizontal size and the vertical size of a CU before being partitioned, depending on the number of CUs generated by partitioning. For example, the horizontal size and the vertical size of each of CUs generated by the partitioning may be half of the horizontal size and the vertical size of a CU before being partitioned.

Each partitioned CU may be recursively partitioned into four CUs in the same way. Via the recursive partitioning, at least one of the horizontal size and the vertical size of each partitioned CU may be reduced compared to at least one of the horizontal size and the vertical size of the CU before being partitioned.

The partitioning of a CU may be recursively performed up to a predefined depth or a predefined size.

For example, the depth of a CU may have a value ranging from 0 to 3. The size of the CU may range from a size of 64×64 to a size of 8×8 depending on the depth of the CU.

For example, the depth of an LCU 310 may be 0, and the depth of a Smallest Coding Unit (SCU) may be a predefined maximum depth. Here, as described above, the LCU may be the CU having the maximum coding unit size, and the SCU may be the CU having the minimum coding unit size.

Partitioning may start at the LCU 310, and the depth of a CU may be increased by 1 whenever the horizontal and/or vertical sizes of the CU are reduced by partitioning.

For example, for respective depths, a CU that is not partitioned may have a size of 2N×2N. Further, in the case of a CU that is partitioned, a CU having a size of 2N×2N may be partitioned into four CUs, each having a size of N×N. The value of N may be halved whenever the depth is increased by 1.

Referring to FIG. 3, an LCU having a depth of 0 may have 64×64 pixels or 64×64 blocks. 0 may be a minimum depth. An SCU having a depth of 3 may have 8×8 pixels or 8×8 blocks. 3 may be a maximum depth. Here, a CU having 64×64 blocks, which is the LCU, may be represented by a depth of 0. A CU having 32×32 blocks may be represented by a depth of 1. A CU having 16×16 blocks may be represented by a depth of 2. A CU having 8×8 blocks, which is the SCU, may be represented by a depth of 3.

Information about whether the corresponding CU is partitioned may be represented by the partition information of the CU. The partition information may be 1-bit information. All CUs except the SCU may include partition information. For example, the value of the partition information of a CU that is not partitioned may be a first value. The value of the partition information of a CU that is partitioned may be a second value. When the partition information indicates whether a CU is partitioned or not, the first value may be “0” and the second value may be “1”.

For example, when a single CU is partitioned into four CUs, the horizontal size and vertical size of each of four CUs generated by partitioning may be half the horizontal size and the vertical size of the CU before being partitioned. When a CU having a 32×32 size is partitioned into four CUs, the size of each of four partitioned CUs may be 16×16. When a single CU is partitioned into four CUs, it may be considered that the CU has been partitioned in a quad-tree structure. In other words, it may be considered that a quad-tree partition has been applied to a CU.

For example, when a single CU is partitioned into two CUs, the horizontal size or the vertical size of each of two CUs generated by partitioning may be half the horizontal size or the vertical size of the CU before being partitioned. When a CU having a 32×32 size is vertically partitioned into two CUs, the size of each of two partitioned CUs may be 16×32. When a CU having a 32×32 size is horizontally partitioned into two CUs, the size of each of two partitioned CUs may be 32×16. When a single CU is partitioned into two CUs, it may be considered that the CU has been partitioned in a binary-tree structure. In other words, it may be considered that a binary-tree partition has been applied to a CU.

For example, when a single CU is partitioned (or split) into three CUs, the original CU before being partitioned is partitioned so that the horizontal size or vertical size thereof is divided at a ratio of 1:2:1, thus enabling three sub-CUs to be generated. For example, when a CU having a 16×32 size is horizontally partitioned into three sub-CUs, the three sub-CUs resulting from the partitioning may have sizes of 16×8, 16×16, and 16×8, respectively, in a direction from the top to the bottom. For example, when a CU having a 32×32 size is vertically partitioned into three sub-CUs, the three sub-CUs resulting from the partitioning may have sizes of 8×32, 16×32, and 8×32, respectively, in a direction from the left to the right. When a single CU is partitioned into three CUs, it may be considered that the CU is partitioned in a ternary-tree form. In other words, it may be considered that a ternary-tree partition has been applied to the CU.

Both of quad-tree partitioning and binary-tree partitioning are applied to the LCU 310 of FIG. 3.

In the encoding apparatus 100, a Coding Tree Unit (CTU) having a size of 64×64 may be partitioned into multiple smaller CUs by a recursive quad-tree structure. A single CU may be partitioned into four CUs having the same size. Each CU may be recursively partitioned, and may have a quad-tree structure.

By the recursive partitioning of a CU, an optimal partitioning method that incurs a minimum rate-distortion cost may be selected.

The Coding Tree Unit (CTU) 320 in FIG. 3 is an example of a CTU to which all of a quad-tree partition, a binary-tree partition, and a ternary-tree partition are applied.

As described above, in order to partition a CTU, at least one of a quad-tree partition, a binary-tree partition, and a ternary-tree partition may be applied to the CTU. Partitions may be applied based on specific priority.

For example, a quad-tree partition may be preferentially applied to the CTU. A CU that cannot be partitioned in a quad-tree form any further may correspond to a leaf node of a quad-tree. A CU corresponding to the leaf node of the quad-tree may be a root node of a binary tree and/or a ternary tree. That is, the CU corresponding to the leaf node of the quad-tree may be partitioned in a binary-tree form or a ternary-tree form, or may not be partitioned any further. In this case, each CU, which is generated by applying a binary-tree partition or a ternary-tree partition to the CU corresponding to the leaf node of a quad-tree, is prevented from being subjected again to quad-tree partitioning, thus effectively performing partitioning of a block and/or signaling of block partition information.

The partition of a CU corresponding to each node of a quad-tree may be signaled using quad-partition information. Quad-partition information having a first value (e.g., “1”) may indicate that the corresponding CU is partitioned in a quad-tree form. Quad-partition information having a second value (e.g., “0”) may indicate that the corresponding CU is not partitioned in a quad-tree form. The quad-partition information may be a flag having a specific length (e.g., 1 bit).

Priority may not exist between a binary-tree partition and a ternary-tree partition. That is, a CU corresponding to the leaf node of a quad-tree may be partitioned in a binary-tree form or a ternary-tree form. Also, the CU generated through a binary-tree partition or a ternary-tree partition may be further partitioned in a binary-tree form or a ternary-tree form, or may not be partitioned any further.

Partitioning performed when priority does not exist between a binary-tree partition and a ternary-tree partition may be referred to as a “multi-type tree partition”. That is, a CU corresponding to the leaf node of a quad-tree may be the root node of a multi-type tree. Partitioning of a CU corresponding to each node of the multi-type tree may be signaled using at least one of information indicating whether the CU is partitioned in a multi-type tree, partition direction information, and partition tree information. For partitioning of a CU corresponding to each node of a multi-type tree, information indicating whether partitioning in the multi-type tree is performed, partition direction information, and partition tree information may be sequentially signaled.

For example, information indicating whether a CU is partitioned in a multi-type tree and having a first value (e.g., “1”) may indicate that the corresponding CU is partitioned in a multi-type tree form. Information indicating whether a CU is partitioned in a multi-type tree and having a second value (e.g., “0”) may indicate that the corresponding CU is not partitioned in a multi-type tree form.

When a CU corresponding to each node of a multi-type tree is partitioned in a multi-type tree form, the corresponding CU may further include partition direction information.

The partition direction information may indicate the partition direction of the multi-type tree partition. Partition direction information having a first value (e.g., “1”) may indicate that the corresponding CU is partitioned in a vertical direction. Partition direction information having a second value (e.g., “0”) may indicate that the corresponding CU is partitioned in a horizontal direction.

When a CU corresponding to each node of a multi-type tree is partitioned in a multi-type tree form, the corresponding CU may further include partition-tree information. The partition-tree information may indicate the tree that is used for a multi-type tree partition.

For example, partition-tree information having a first value (e.g., “1”) may indicate that the corresponding CU is partitioned in a binary-tree form. Partition-tree information having a second value (e.g., “0”) may indicate that the corresponding CU is partitioned in a ternary-tree form.

Here, each of the above-described information indicating whether partitioning in the multi-type tree is performed, partition-tree information, and partition direction information may be a flag having a specific length (e.g., 1 bit).

At least one of the above-described quad-partition information, information indicating whether partitioning in the multi-type tree is performed, partition direction information, and partition-tree information may be entropy-encoded and/or entropy-decoded. In order to perform entropy encoding/decoding of such information, information of a neighbor CU adjacent to a target CU may be used.

For example, it may be considered that there is a high probability that the partition form of a left CU and/or an above CU (i.e., partitioning/non-partitioning, a partition tree and/or a partition direction) and the partition form of a target CU will be similar to each other. Therefore, based on the information of a neighbor CU, context information for entropy encoding and/or entropy decoding of the information of the target CU may be derived. Here, the information of the neighbor CU may include at least one of 1) quad-partition information of the neighbor CU, 2) information indicating whether the neighbor CU is partitioned in a multi-type tree, 3) partition direction information of the neighbor CU, and 4) partition-tree information of the neighbor CU.

In another embodiment, of a binary-tree partition and a ternary-tree partition, the binary-tree partition may be preferentially performed. That is, the binary-tree partition may be first applied, and then a CU corresponding to the leaf node of a binary tree may be set to the root node of a ternary tree. In this case, a quad-tree partition or a binary-tree partition may not be performed on the CU corresponding to the node of the ternary tree.

A CU, which is not partitioned any further through a quad-tree partition, a binary-tree partition, and/or a ternary-tree partition, may be the unit of encoding, prediction and/or transform. That is, the CU may not be partitioned any further for prediction and/or transform. Therefore, a partition structure for partitioning the CU into Prediction Units (PUs) and/or Transform Units (TUs), partition information thereof, etc. may not be present in a bitstream.

However, when the size of a CU, which is the unit of partitioning, is greater than the size of a maximum transform block, the CU may be recursively partitioned until the size of the CU becomes less than or equal to the size of the maximum transform block. For example, when the size of a CU is 64×64 and the size of the maximum transform block is 32×32, the CU may be partitioned into four 32×32 blocks so as to perform a transform. For example, when the size of a CU is 32×64 and the size of the maximum transform block is 32×32, the CU may be partitioned into two 32×32 blocks.

In this case, information indicating whether a CU is partitioned for a transform may not be separately signaled. Without signaling, whether a CU is partitioned may be determined via a comparison between the horizontal size (and/or vertical size) of the CU and the horizontal size (and/or vertical size) of the maximum transform block. For example, when the horizontal size of the CU is greater than the horizontal size of the maximum transform block, the CU may be vertically bisected. Further, when the vertical size of the CU is greater than the vertical size of the maximum transform block, the CU may be horizontally bisected.

Information about the maximum size and/or minimum size of a CU and information about the maximum size and/or minimum size of a transform block may be signaled or determined at a level higher than that of the CU. For example, the higher level may be a sequence level, a picture level, a tile level, a tile group level or a slice level. For example, the minimum size of the CU may be set to 4×4. For example, the maximum size of the transform block may be set to 64×64. For example, the maximum size of the transform block may be set to 4×4.

Information about the minimum size of a CU corresponding to the leaf node of a quad-tree (i.e., the minimum size of the quad-tree) and/or information about the maximum depth of a path from the root node to the leaf node of a multi-type tree (i.e., the maximum depth of a multi-type tree) may be signaled or determined at a level higher than that of the CU. For example, the higher level may be a sequence level, a picture level, a slice level, a tile group level or a tile level. Information about the minimum size of a quad-tree and/or information about the maximum depth of a multi-type tree may be separately signaled or determined at each of an intra-slice level and an inter-slice level.

Information about the difference between the size of a CTU and the maximum size of a transform block may be signaled or determined at a level higher than that of a CU. For example, the higher level may be a sequence level, a picture level, a slice level, a tile group level or a tile level. Information about the maximum size of a CU corresponding to each node of a binary tree (i.e., the maximum size of the binary tree) may be determined based on the size and the difference information of a CTU. The maximum size of a CU corresponding to each node of a ternary tree (i.e., the maximum size of the ternary tree) may have different values depending on the type of slice. For example, the maximum size of the ternary tree at an intra-slice level may be 32×32. For example, the maximum size of the ternary tree at an inter-slice level may be 128×128. For example, the minimum size of a CU corresponding to each node of a binary tree (i.e., the minimum size of the binary tree) and/or the minimum size of a CU corresponding to each node of a ternary tree (i.e., the minimum size of the ternary tree) may be set to the minimum size of a CU.

In a further example, the maximum size of a binary tree and/or the maximum size of a ternary tree may be signaled or determined at a slice level. Also, the minimum size of a binary tree and/or the minimum size of a ternary tree may be signaled or determined at a slice level.

Based on the above-described various block sizes and depths, quad-partition information, information indicating whether partitioning in a multi-type tree is performed, partition tree information and/or partition direction information may or may not be present in a bitstream.

For example, when the size of a CU is not greater than the minimum size of a quad-tree, the CU may not include quad-partition information, and quad-partition information of the CU may be inferred as a second value.

For example, when the size of a CU corresponding to each node of a multi-type tree (horizontal size and vertical size) is greater than the maximum size of a binary tree (horizontal size and vertical size) and/or the maximum size of a ternary tree (horizontal size and vertical size), the CU may not be partitioned in a binary-tree form and/or a ternary-tree form. By means of this determination manner, information indicating whether partitioning in a multi-type tree is performed may not be signaled, but may be inferred as a second value.

Alternatively, when the size of a CU corresponding to each node of a multi-type tree (horizontal size and vertical size) is equal to the minimum size of a binary tree (horizontal size and vertical size), or when the size of a CU (horizontal size and vertical size) is equal to twice the minimum size of a ternary tree (horizontal size and vertical size), the CU may not be partitioned in a binary tree form and/or a ternary tree form. By means of this determination manner, information indicating whether partitioning in a multi-type tree is performed may not be signaled, but may be inferred as a second value. The reason for this is that, when a CU is partitioned in a binary tree form and/or a ternary tree form, a CU smaller than the minimum size of the binary tree and/or the minimum size of the ternary tree is generated.

Alternatively, a binary-tree partition or a ternary-tree partition may be limited based on the size of a virtual pipeline data unit (i.e., the size of a pipeline buffer). For example, when a CU is partitioned into sub-CUs unsuitable for the size of a pipeline buffer through a binary-tree partition or a ternary-tree partition, a binary-tree partition or a ternary-tree partition may be limited. The size of the pipeline buffer may be equal to the maximum size of a transform block (e.g., 64×64).

For example, when the size of the pipeline buffer is 64×64, the following partitions may be limited.
Ternary-tree partition for N×M CU (where N and/or M are 128)
Horizontal binary-tree partition for 128×N CU (where N<=64)
Vertical binary-tree partition for N×128 CU (where N<=64)

Alternatively, when the depth of a CU corresponding to each node of a multi-type tree is equal to the maximum depth of the multi-type tree, the CU may not be partitioned in a binary-tree form and/or a ternary-tree form. By means of this determination manner, information indicating whether partitioning in a multi-type tree is performed may not be signaled, but may be inferred as a second value.

Alternatively, information indicating whether partitioning in a multi-type tree is performed may be signaled only when at least one of a vertical binary-tree partition, a horizontal binary-tree partition, a vertical ternary-tree partition, and a horizontal ternary-tree partition is possible for a CU corresponding to each node of a multi-type tree. Otherwise, the CU may not be partitioned in a binary-tree form and/or a ternary-tree form. By means of this determination manner, information indicating whether partitioning in a multi-type tree is performed may not be signaled, but may be inferred as a second value.

Alternatively, partition direction information may be signaled only when both a vertical binary-tree partition and a horizontal binary-tree partition are possible or only when both a vertical ternary-tree partition and a horizontal ternary-tree partition are possible, for a CU corresponding to each node of a multi-type tree. Otherwise, the partition direction information may not be signaled, but may be inferred as a value indicating the direction in which the CU can be partitioned.

Alternatively, partition tree information may be signaled only when both a vertical binary-tree partition and a vertical ternary-tree partition are possible or only when both a horizontal binary-tree partition and a horizontal ternary-tree partition are possible, for a CU corresponding to each node of a multi-type tree. Otherwise, the partition tree information may not be signaled, but may be inferred as a value indicating a tree that can be applied to the partition of the CU.

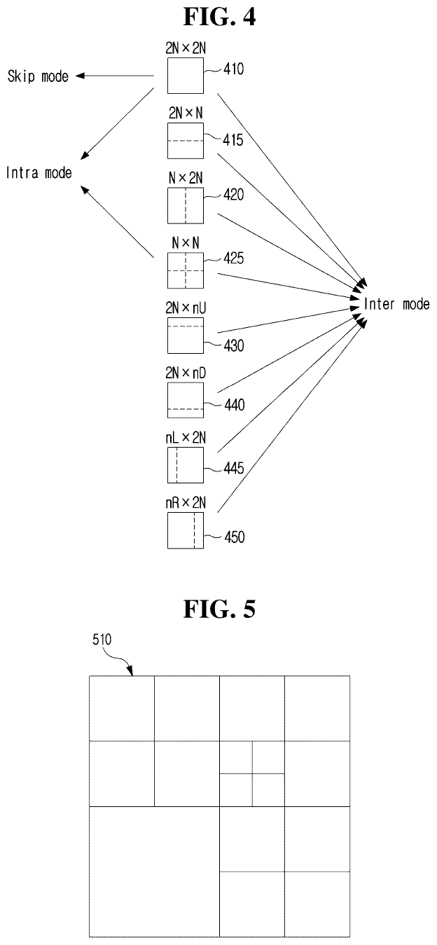

FIG. 4 is a diagram illustrating the form of a Prediction Unit that a Coding Unit can include.

Among CUs partitioned from a LCU, a CU, which is not partitioned any further, may be divided into one or more Prediction Units (PUs).

A PU may be a base unit for prediction. A PU may be encoded and decoded in any one of a skip mode, an inter mode, and an intra mode. A PU may be partitioned into various shapes depending on respective modes. For example, the target block, described above with reference to FIG. 1, and the target block, described above with reference to FIG. 2, may each be a PU.

A CU may not be split into PUs. When the CU is not split into PUs, the size of the CU and the size of a PU may be equal to each other.

In a skip mode, partitioning may not be present in a CU. In the skip mode, a 2N×2N mode 410, in which the sizes of a PU and a CU are identical to each other, may be supported without partitioning.

In an inter mode, 8 types of partition shapes may be present in a CU. For example, in the inter mode, the 2N×2N mode 410, a 2N×N mode 415, an N×2N mode 420, an N×N mode 425, a 2N×nU mode 430, a 2N×nD mode 435, an nL×2N mode 440, and an nR×2N mode 445 may be supported.

In an intra mode, the 2N×2N mode 410 and the N×N mode 425 may be supported.

In the 2N×2N mode 410, a PU having a size of 2N×2N may be encoded. The PU having a size of 2N×2N may mean a PU having a size identical to that of the CU. For example, the PU having a size of 2N×2N may have a size of 64×64, 32×32, 16×16 or 8×8.

In the N×N mode 425, a PU having a size of N×N may be encoded.

For example, in intra prediction, when the size of a PU is 8×8, four partitioned PUs may be encoded. The size of each partitioned PU may be 4×4.

When a PU is encoded in an intra mode, the PU may be encoded using any one of multiple intra-prediction modes. For example, HEVC technology may provide 35 intra-prediction modes, and the PU may be encoded in any one of the 35 intra-prediction modes.

Which one of the 2N×2N mode 410 and the N×N mode 425 is to be used to encode the PU may be determined based on rate-distortion cost.

The encoding apparatus 100 may perform an encoding operation on a PU having a size of 2N×2N. Here, the encoding operation may be the operation of encoding the PU in each of multiple intra-prediction modes that can be used by the encoding apparatus 100. Through the encoding operation, the optimal intra-prediction mode for a PU having a size of 2N×2N may be derived. The optimal intra-prediction mode may be an intra-prediction mode in which a minimum rate-distortion cost occurs upon encoding the PU having a size of 2N×2N, among multiple intra-prediction modes that can be used by the encoding apparatus 100.

Further, the encoding apparatus 100 may sequentially perform an encoding operation on respective PUs obtained from N×N partitioning. Here, the encoding operation may be the operation of encoding a PU in each of multiple intra-prediction modes that can be used by the encoding apparatus 100. By means of the encoding operation, the optimal intra-prediction mode for the PU having a size of N×N may be derived. The optimal intra-prediction mode may be an intra-prediction mode in which a minimum rate-distortion cost occurs upon encoding the PU having a size of N×N, among multiple intra-prediction modes that can be used by the encoding apparatus 100.

The encoding apparatus 100 may determine which of a PU having a size of 2N×2N and PUs having sizes of N×N to be encoded based on a comparison of a rate-distortion cost of the PU having a size of 2N×2N and a rate-distortion costs of the PUs having sizes of N×N.

A single CU may be partitioned into one or more PUs, and a PU may be partitioned into multiple PUs.

For example, when a single PU is partitioned into four PUs, the horizontal size and vertical size of each of four PUs generated by partitioning may be half the horizontal size and the vertical size of the PU before being partitioned. When a PU having a 32×32 size is partitioned into four PUs, the size of each of four partitioned PUs may be 16×16. When a single PU is partitioned into four PUs, it may be considered that the PU has been partitioned in a quad-tree structure.

For example, when a single PU is partitioned into two PUs, the horizontal size or the vertical size of each of two PUs generated by partitioning may be half the horizontal size or the vertical size of the PU before being partitioned. When a PU having a 32×32 size is vertically partitioned into two PUs, the size of each of two partitioned PUs may be 16×32. When a PU having a 32×32 size is horizontally partitioned into two PUs, the size of each of two partitioned PUs may be 32×16. When a single PU is partitioned into two PUs, it may be considered that the PU has been partitioned in a binary-tree structure.

FIG. 5 is a diagram illustrating the form of a Transform Unit that can be included in a Coding Unit.

A Transform Unit (TU) may have a base unit that is used for a procedure, such as transform, quantization, inverse transform, dequantization, entropy encoding, and entropy decoding, in a CU.

A TU may have a square shape or a rectangular shape. A shape of a TU may be determined based on a size and/or a shape of a CU.

Among CUs partitioned from the LCU, a CU which is not partitioned into CUs any further may be partitioned into one or more TUs. Here, the partition structure of a TU may be a quad-tree structure. For example, as shown in FIG. 5, a single CU 510 may be partitioned one or more times depending on the quad-tree structure. By means of this partitioning, the single CU 510 may be composed of TUs having various sizes.

It can be considered that when a single CU is split two or more times, the CU is recursively split. Through splitting, a single CU may be composed of Transform Units (TUs) having various sizes.

Alternatively, a single CU may be split into one or more TUs based on the number of vertical lines and/or horizontal lines that split the CU.

A CU may be split into symmetric TUs or asymmetric TUs. For splitting into asymmetric TUs, information about the size and/or shape of each TU may be signaled from the encoding apparatus 100 to the decoding apparatus 200. Alternatively, the size and/or shape of each TU may be derived from information about the size and/or shape of the CU.

A CU may not be split into TUs. When the CU is not split into TUs, the size of the CU and the size of a TU may be equal to each other.

A single CU may be partitioned into one or more TUs, and a TU may be partitioned into multiple TUs.

For example, when a single TU is partitioned into four TUs, the horizontal size and vertical size of each of four TUs generated by partitioning may be half the horizontal size and the vertical size of the TU before being partitioned. When a TU having a 32×32 size is partitioned into four TUs, the size of each of four partitioned TUs may be 16×16. When a single TU is partitioned into four TUs, it may be considered that the TU has been partitioned in a quad-tree structure.

For example, when a single TU is partitioned into two TUs, the horizontal size or the vertical size of each of two TUs generated by partitioning may be half the horizontal size or the vertical size of the TU before being partitioned. When a TU having a 32×32 size is vertically partitioned into two TUs, the size of each of two partitioned TUs may be 16×32. When a TU having a 32×32 size is horizontally partitioned into two TUs, the size of each of two partitioned TUs may be 32×16. When a single TU is partitioned into two TUs, it may be considered that the TU has been partitioned in a binary-tree structure.

In a way differing from that illustrated in FIG. 5, a CU may be split.

For example, a single CU may be split into three CUs. The horizontal sizes or vertical sizes of the three CUs generated from splitting may be ¼, ½, and ¼, respectively, of the horizontal size or vertical size of the original CU before being split.

For example, when a CU having a 32×32 size is vertically split into three CUs, the sizes of the three CUs generated from the splitting may be 8×32, 16×32, and 8×32, respectively. In this way, when a single CU is split into three CUs, it may be considered that the CU is split in the form of a ternary tree.

One of exemplary splitting forms, that is, quad-tree splitting, binary tree splitting, and ternary tree splitting, may be applied to the splitting of a CU, and multiple splitting schemes may be combined and used together for splitting of a CU. Here, the case where multiple splitting schemes are combined and used together may be referred to as “complex tree-format splitting”.

FIG. 6 illustrates the splitting of a block according to an example.

In a video encoding and/or decoding process, a target block may be split, as illustrated in FIG. 6. For example, the target block may be a CU.

For splitting of the target block, an indicator indicating split information may be signaled from the encoding apparatus 100 to the decoding apparatus 200. The split information may be information indicating how the target block is split.

The split information may be one or more of a split flag (hereinafter referred to as “split_flag”), a quad-binary flag (hereinafter referred to as “QB_flag”), a quad-tree flag (hereinafter referred to as “quadtree_flag”), a binary tree flag (hereinafter referred to as “binarytree_flag”), and a binary type flag (hereinafter referred to as “Btype_flag”).

“split_flag” may be a flag indicating whether a block is split. For example, a split_flag value of 1 may indicate that the corresponding block is split. A split_flag value of 0 may indicate that the corresponding block is not split.

“QB_flag” may be a flag indicating which one of a quad-tree form and a binary tree form corresponds to the shape in which the block is split. For example, a QB_flag value of 0 may indicate that the block is split in a quad-tree form. A QB_flag value of 1 may indicate that the block is split in a binary tree form. Alternatively, a QB_flag value of 0 may indicate that the block is split in a binary tree form. A QB_flag value of 1 may indicate that the block is split in a quad-tree form.

“quadtree_flag” may be a flag indicating whether a block is split in a quad-tree form. For example, a quadtree_flag value of 1 may indicate that the block is split in a quad-tree form. A quadtree_flag value of 0 may indicate that the block is not split in a quad-tree form.

“binarytree_flag” may be a flag indicating whether a block is split in a binary tree form. For example, a binarytree_flag value of 1 may indicate that the block is split in a binary tree form. A binarytree_flag value of 0 may indicate that the block is not split in a binary tree form.

“Btype_flag” may be a flag indicating which one of a vertical split and a horizontal split corresponds to a split direction when a block is split in a binary tree form. For example, a Btype_flag value of 0 may indicate that the block is split in a horizontal direction. A Btype_flag value of 1 may indicate that a block is split in a vertical direction. Alternatively, a Btype_flag value of 0 may indicate that the block is split in a vertical direction. A Btype_flag value of 1 may indicate that a block is split in a horizontal direction.

For example, the split information of the block in FIG. 6 may be derived by signaling at least one of quadtree_flag, binarytree_flag, and Btype_flag, as shown in the following Table 1.

TABLE 1

| quadtree_flag | binarytree_flag | Btype_flag |
|---|---|---|
| 1 | | |
| 0 | | |
| | 1 | |
| | | 1 |
| | 0 | |
| | 0 | |
| 1 | | |
| 0 | | |
| | 1 | |
| | | 0 |
| | 0 | |
| | 0 | |
| 0 | | |
| | 0 | |
| 0 | | |
| | 0 | |
| 0 | | |
| | 0 | |
| 0 | | |
| | 1 | |
| | | 0 |
| | 1 | |
| | | 1 |
| | 0 | |
| | 0 | |
| | 0 | |
| 0 | | |
| | 0 | |

For example, the split information of the block in FIG. 6 may be derived by signaling at least one of split_flag, QB_flag and Btype_flag, as shown in the following Table 2 . . .

TABLE 2

| split_flag | QB_flag | Btype_flag |
|---|---|---|
| 1 | | |
| | 0 | |
| 1 | | |
| | 1 | |
| | | 1 |
| 0 | | |
| 0 | | |
| 1 | | |
| | 0 | |
| 1 | | |
| | 1 | |
| | | 0 |
| 0 | | |
| 0 | | |
| 0 | | |
| 0 | | |
| 0 | | |
| 1 | | |
| | 1 | |
| | | 0 |
| 1 | | |
| | | 1 |
| 0 | | |
| 0 | | |
| 0 | | |
| 0 | | |

The splitting method may be limited only to a quad-tree or to a binary tree depending on the size and/or shape of the block. When this limitation is applied, split_flag may be a flag indicating whether a block is split in a quad-tree form or a flag indicating whether a block is split in a binary tree form. The size and shape of a block may be derived depending on the depth information of the block, and the depth information may be signaled from the encoding apparatus 100 to the decoding apparatus 200.

When the size of a block falls within a specific range, only splitting in a quad-tree form may be possible. For example, the specific range may be defined by at least one of a maximum block size and a minimum block size at which only splitting in a quad-tree form is possible.

Information indicating the maximum block size and the minimum block size at which only splitting in a quad-tree form is possible may be signaled from the encoding apparatus 100 to the decoding apparatus 200 through a bitstream. Further, this information may be signaled for at least one of units such as a video, a sequence, a picture, a parameter, a tile group, and a slice (or a segment).

Alternatively, the maximum block size and/or the minimum block size may be fixed sizes predefined by the encoding apparatus 100 and the decoding apparatus 200. For example, when the size of a block is above 64×64 and below 256×256, only splitting in a quad-tree form may be possible. In this case, split_flag may be a flag indicating whether splitting in a quad-tree form is performed.

When the size of a block is greater than the maximum size of a transform block, only partitioning in a quad-tree form may be possible. Here, a sub-block resulting from partitioning may be at least one of a CU and a TU.

In this case, split_flag may be a flag indicating whether a CU is partitioned in a quad-tree form.

When the size of a block falls within the specific range, only splitting in a binary tree form or a ternary tree form may be possible. For example, the specific range may be defined by at least one of a maximum block size and a minimum block size at which only splitting in a binary tree form or a ternary tree form is possible.

Information indicating the maximum block size and/or the minimum block size at which only splitting in a binary tree form or splitting in a ternary tree form is possible may be signaled from the encoding apparatus 100 to the decoding apparatus 200 through a bitstream. Further, this information may be signaled for at least one of units such as a sequence, a picture, and a slice (or a segment).

Alternatively, the maximum block size and/or the minimum block size may be fixed sizes predefined by the encoding apparatus 100 and the decoding apparatus 200. For example, when the size of a block is above 8×8 and below 16×16, only splitting in a binary tree form may be possible. In this case, split_flag may be a flag indicating whether splitting in a binary tree form or a ternary tree form is performed.

The above description of partitioning in a quad-tree form may be equally applied to a binary-tree form and/or a ternary-tree form.

The partition of a block may be limited by a previous partition. For example, when a block is partitioned in a specific binary-tree form and then multiple sub-blocks are generated from the partitioning, each sub-block may be additionally partitioned only in a specific tree form. Here, the specific tree form may be at least one of a binary-tree form, a ternary-tree form, and a quad-tree form.

When the horizontal size or vertical size of a partition block is a size that cannot be split further, the above-described indicator may not be signaled.

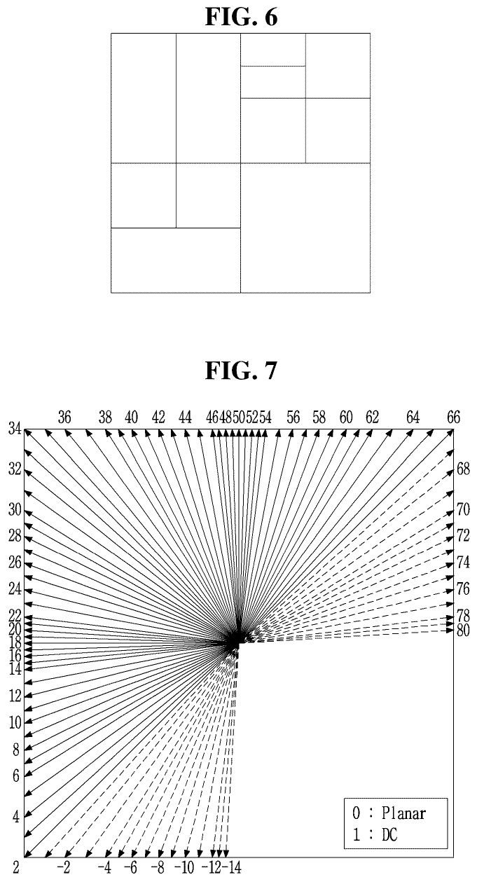

FIG. 7 is a diagram for explaining an embodiment of an intra-prediction process.

Arrows radially extending from the center of the graph in FIG. 7 indicate the prediction directions of intra-prediction modes. Further, numbers appearing near the arrows indicate examples of mode values assigned to intra-prediction modes or to the prediction directions of the intra-prediction modes.

In FIG. 7, A number 0 may represent a Planar mode which is a non-directional intra prediction mode. A number 1 may represent a DC mode which is a non-directional intra prediction mode.

Intra encoding and/or decoding may be performed using a reference sample of neighbor block of a target block. The neighbor block may be a reconstructed neighbor block. The reference sample may mean a neighbor sample.

For example, intra encoding and/or decoding may be performed using the value of a reference sample which are included in are reconstructed neighbor block or the coding parameters of the reconstructed neighbor block.

The encoding apparatus 100 and/or the decoding apparatus 200 may generate a prediction block by performing intra prediction on a target block based on information about samples in a target image. When intra prediction is performed, the encoding apparatus 100 and/or the decoding apparatus 200 may generate a prediction block for the target block by performing intra prediction based on information about samples in the target image. When intra prediction is performed, the encoding apparatus 100 and/or the decoding apparatus 200 may perform directional prediction and/or non-directional prediction based on at least one reconstructed reference sample.

A prediction block may be a block generated as a result of performing intra prediction. A prediction block may correspond to at least one of a CU, a PU, and a TU.

The unit of a prediction block may have a size corresponding to at least one of a CU, a PU, and a TU. The prediction block may have a square shape having a size of 2N×2N or N×N. The size of N×N may include sizes of 4×4, 8×8, 16×16, 32×32, 64×64, or the like.

Alternatively, a prediction block may a square block having a size of 2×2, 4×4, 8×8, 16×16, 32×32, 64×64 or the like or a rectangular block having a size of 2×8, 4×8, 2×16, 4×16, 8×16, or the like.

Intra prediction may be performed in consideration of the intra-prediction mode for the target block. The number of intra-prediction modes that the target block can have may be a predefined fixed value, and may be a value determined differently depending on the attributes of a prediction block. For example, the attributes of the prediction block may include the size of the prediction block, the type of prediction block, etc. Further, the attribute of a prediction block may indicate a coding parameter for the prediction block.

For example, the number of intra-prediction modes may be fixed at N regardless of the size of a prediction block. Alternatively, the number of intra-prediction modes may be, for example, 3, 5, 9, 17, 34, 35, 36, 65, 67 or 95.

The intra-prediction modes may be non-directional modes or directional modes.

For example, the intra-prediction modes may include two non-directional modes and 65 directional modes corresponding to numbers 0 to 66 illustrated in FIG. 7.

For example, the specified intra-prediction method is used, an intra prediction mode may include two non-directional modes and 93 directional modes corresponding to numbers −14 to 80 illustrated in FIG. 7.

The two non-directional modes may include a DC mode and a planar mode.

A directional mode may be a prediction mode having a specific direction or a specific angle. The directional mode may also be referred to as an “angular mode”.

An intra-prediction mode may be represented by at least one of a mode number, a mode value, a mode angle, and a mode direction. In other words, the terms “(mode) number of the intra-prediction mode”, “(mode) value of the intra-prediction mode”, “(mode) angle of the intra-prediction mode”, and “(mode) direction of the intra-prediction mode” may be used to have the same meaning, and may be used interchangeably with each other.

The number of intra-prediction modes may be M. The value of M may be 1 or more. In other words, the number of intra-prediction modes may be M, which includes the number of non-directional modes and the number of directional modes.

The number of intra-prediction modes may be fixed to M regardless of the size and/or the color component of a block. For example, the number of intra-prediction modes may be fixed at any one of 35 and 67 regardless of the size of a block.

Alternatively, the number of intra-prediction modes may differ depending on the shape, the size and/or the type of the color component of a block.

For example, in FIG. 7, directional prediction modes illustrated as dashed lines may be applied only for a prediction for a non-square block.

For example, the larger the size of the block, the greater the number of intra-prediction modes. Alternatively, the larger the size of the block, the smaller the number of intra-prediction modes. When the size of the block is 4×4 or 8×8, the number of intra-prediction modes may be 67. When the size of the block is 16×16, the number of intra-prediction modes may be 35. When the size of the block is 32×32, the number of intra-prediction modes may be 19. When the size of a block is 64×64, the number of intra-prediction modes may be 7.

For example, the number of intra prediction modes may differ depending on whether a color component is a luma signal or a chroma signal. Alternatively, the number of intra-prediction modes corresponding to a luma component block may be greater than the number of intra-prediction modes corresponding to a chroma component block.

For example, in a vertical mode having a mode value of 50, prediction may be performed in a vertical direction based on the pixel value of a reference sample. For example, in a horizontal mode having a mode value of 18, prediction may be performed in a horizontal direction based on the pixel value of a reference sample.

Even in directional modes other than the above-described mode, the encoding apparatus 100 and the decoding apparatus 200 may perform intra prediction on a target unit using reference samples depending on angles corresponding to the directional modes.

Intra-prediction modes located on a right side with respect to the vertical mode may be referred to as ‘vertical-right modes’. Intra-prediction modes located below the horizontal mode may be referred to as ‘horizontal-below modes’. For example, in FIG. 7, the intra-prediction modes in which a mode value is one of 51, 52, 53, 54, 55, 56, 57, 58, 59, 60, 61, 62, 63, 64, 65, and 66 may be vertical-right modes. Intra-prediction modes in which a mode value is one of 2, 3, 4, 5, 6, 7, 8, 9, 10, 11, 12, 13, 14, 15, 16, and 17 may be horizontal-below modes.

The non-directional mode may include a DC mode and a planar mode. For example, a value of the DC mode may be 1. A value of the planar mode may be 0.

The directional mode may include an angular mode. Among the plurality of the intra prediction modes, remaining modes except for the DC mode and the planar mode may be directional modes.

When the intra-prediction mode is a DC mode, a prediction block may be generated based on the average of pixel values of a plurality of reference pixels. For example, a value of a pixel of a prediction block may be determined based on the average of pixel values of a plurality of reference pixels.

The number of above-described intra-prediction modes and the mode values of respective intra-prediction modes are merely exemplary. The number of above-described intra-prediction modes and the mode values of respective intra-prediction modes may be defined differently depending on the embodiments, implementation and/or requirements.

In order to perform intra prediction on a target block, the step of checking whether samples included in a reconstructed neighbor block can be used as reference samples of a target block may be performed. When a sample that cannot be used as a reference sample of the target block is present among samples in the neighbor block, a value generated via copying and/or interpolation that uses at least one sample value, among the samples included in the reconstructed neighbor block, may replace the sample value of the sample that cannot be used as the reference sample. When the value generated via copying and/or interpolation replaces the sample value of the existing sample, the sample may be used as the reference sample of the target block.

When intra prediction is used, a filter may be applied to at least one of a reference sample and a prediction sample based on at least one of the intra-prediction mode and the size of the target block.

The type of filter to be applied to at least one of a reference sample and a prediction sample may differ depending on at least one of the intra-prediction mode of a target block, the size of the target block, and the shape of the target block. The types of filters may be classified depending on one or more of the length of filter tap, the value of a filter coefficient, and filter strength. The length of filter tap may mean the number of filter taps. Also, the number of filter tap may mean the length of the filter.

When the intra-prediction mode is a planar mode, a sample value of a prediction target block may be generated using a weighted sum of an above reference sample of the target block, a left reference sample of the target block, an above-right reference sample of the target block, and a below-left reference sample of the target block depending on the location of the prediction target sample in the prediction block when the prediction block of the target block is generated.

When the intra-prediction mode is a DC mode, the average of reference samples above the target block and the reference samples to the left of the target block may be used when the prediction block of the target block is generated. Also, filtering using the values of reference samples may be performed on specific rows or specific columns in the target block. The specific rows may be one or more upper rows adjacent to the reference sample. The specific columns may be one or more left columns adjacent to the reference sample.

When the intra-prediction mode is a directional mode, a prediction block may be generated using the above reference samples, left reference samples, above-right reference sample and/or below-left reference sample of the target block.

In order to generate the above-described prediction sample, real-number-based interpolation may be performed.

The intra-prediction mode of the target block may be predicted from intra prediction mode of a neighbor block adjacent to the target block, and the information used for prediction may be entropy-encoded/decoded.

For example, when the intra-prediction modes of the target block and the neighbor block are identical to each other, it may be signaled, using a predefined flag, that the intra-prediction modes of the target block and the neighbor block are identical.

For example, an indicator for indicating an intra-prediction mode identical to that of the target block, among intra-prediction modes of multiple neighbor blocks, may be signaled.

When the intra-prediction modes of the target block and a neighbor block are different from each other, information about the intra-prediction mode of the target block may be encoded and/or decoded using entropy encoding and/or decoding.

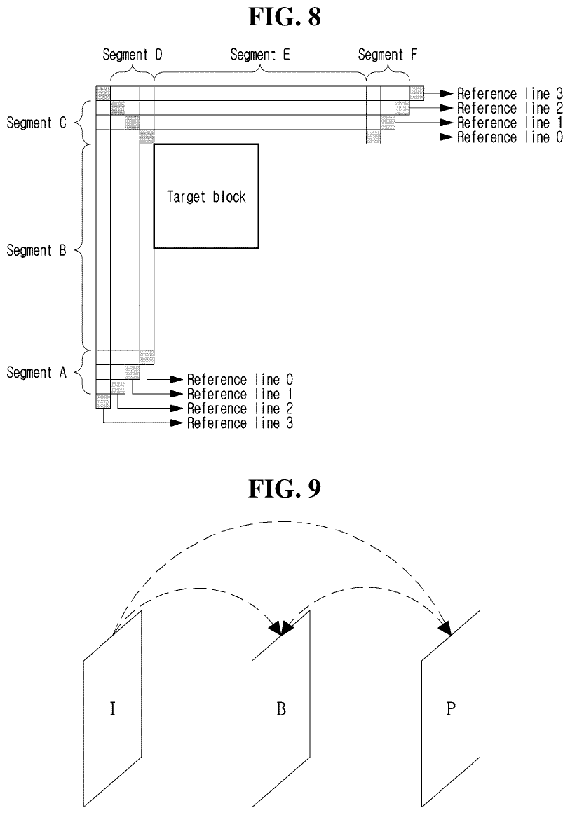

FIG. 8 is a diagram illustrating reference samples used in an intra-prediction procedure.

Reconstructed reference samples used for intra prediction of the target block may include below-left reference samples, left reference samples, an above-left corner reference sample, above reference samples, and above-right reference samples.

For example, the left reference samples may mean reconstructed reference pixels adjacent to the left side of the target block. The above reference samples may mean reconstructed reference pixels adjacent to the top of the target block. The above-left corner reference sample may mean a reconstructed reference pixel located at the above-left corner of the target block. The below-left reference samples may mean reference samples located below a left sample line composed of the left reference samples, among samples located on the same line as the left sample line. The above-right reference samples may mean reference samples located to the right of an above sample line composed of the above reference samples, among samples located on the same line as the above sample line.

When the size of a target block is N×N, the numbers of the below-left reference samples, the left reference samples, the above reference samples, and the above-right reference samples may each be N.

By performing intra prediction on the target block, a prediction block may be generated. The generation of the prediction block may include the determination of the values of pixels in the prediction block. The sizes of the target block and the prediction block may be equal.

The reference samples used for intra prediction of the target block may vary depending on the intra-prediction mode of the target block. The direction of the intra-prediction mode may represent a dependence relationship between the reference samples and the pixels of the prediction block. For example, the value of a specified reference sample may be used as the values of one or more specified pixels in the prediction block. In this case, the specified reference sample and the one or more specified pixels in the prediction block may be the sample and pixels which are positioned in a straight line in the direction of an intra-prediction mode. In other words, the value of the specified reference sample may be copied as the value of a pixel located in a direction reverse to the direction of the intra-prediction mode. Alternatively, the value of a pixel in the prediction block may be the value of a reference sample located in the direction of the intra-prediction mode with respect to the location of the pixel.

In an example, when the intra-prediction mode of a target block is a vertical mode, the above reference samples may be used for intra prediction. When the intra-prediction mode is the vertical mode, the value of a pixel in the prediction block may be the value of a reference sample vertically located above the location of the pixel. Therefore, the above reference samples adjacent to the top of the target block may be used for intra prediction. Furthermore, the values of pixels in one row of the prediction block may be identical to those of the above reference samples.

In an example, when the intra-prediction mode of a target block is a horizontal mode, the left reference samples may be used for intra prediction. When the intra-prediction mode is the horizontal mode, the value of a pixel in the prediction block may be the value of a reference sample horizontally located left to the location of the pixel. Therefore, the left reference samples adjacent to the left of the target block may be used for intra prediction. Furthermore, the values of pixels in one column of the prediction block may be identical to those of the left reference samples.

In an example, when the mode value of the intra-prediction mode of the current block is 34, at least some of the left reference samples, the above-left corner reference sample, and at least some of the above reference samples may be used for intra prediction. When the mode value of the intra-prediction mode is 34, the value of a pixel in the prediction block may be the value of a reference sample diagonally located at the above-left corner of the pixel.

Further, At least a part of the above-right reference samples may be used for intra prediction in a case that an intra prediction mode of which a mode value is a value ranging from 52 to 66.

Further, At least a part of the below-left reference samples may be used for intra prediction in a case that an intra prediction mode of which a mode value is a value ranging from 2 to 17.

Further, the above-left corner reference sample may be used for intra prediction in a case that an intra prediction mode of which a mode value is a value ranging from 19 to 49.

The number of reference samples used to determine the pixel value of one pixel in the prediction block may be either 1, or 2 or more.

As described above, the pixel value of a pixel in the prediction block may be determined depending on the location of the pixel and the location of a reference sample indicated by the direction of the intra-prediction mode. When the location of the pixel and the location of the reference sample indicated by the direction of the intra-prediction mode are integer positions, the value of one reference sample indicated by an integer position may be used to determine the pixel value of the pixel in the prediction block.

When the location of the pixel and the location of the reference sample indicated by the direction of the intra-prediction mode are not integer positions, an interpolated reference sample based on two reference samples closest to the location of the reference sample may be generated. The value of the interpolated reference sample may be used to determine the pixel value of the pixel in the prediction block. In other words, when the location of the pixel in the prediction block and the location of the reference sample indicated by the direction of the intra-prediction mode indicate the location between two reference samples, an interpolated value based on the values of the two samples may be generated.

The prediction block generated via prediction may not be identical to an original target block. In other words, there may be a prediction error which is the difference between the target block and the prediction block, and there may also be a prediction error between the pixel of the target block and the pixel of the prediction block.

Hereinafter, the terms “difference”, “error”, and “residual” may be used to have the same meaning, and may be used interchangeably with each other.

For example, in the case of directional intra prediction, the longer the distance between the pixel of the prediction block and the reference sample, the greater the prediction error that may occur. Such a prediction error may result in discontinuity between the generated prediction block and neighbor blocks.

In order to reduce the prediction error, filtering for the prediction block may be used. Filtering may be configured to adaptively apply a filter to an area, regarded as having a large prediction error, in the prediction block. For example, the area regarded as having a large prediction error may be the boundary of the prediction block. Further, an area regarded as having a large prediction error in the prediction block may differ depending on the intra-prediction mode, and the characteristics of filters may also differ depending thereon.

As illustrated in FIG. 8, for intra prediction of a target block, at least one of reference line 0 to reference line 3 may be used.

Each reference line in FIG. 8 may indicate a reference sample line comprising one or more reference samples. As the number of the reference line is lower, a line of reference samples closer to a target block may be indicated.

Samples in segment A and segment F may be acquired through padding that uses samples closest to the target block in segment B and segment E instead of being acquired from reconstructed neighbor blocks.

Index information indicating a reference sample line to be used for intra-prediction of the target block may be signaled. The index information may indicate a reference sample line to be used for intra-prediction of the target block, among multiple reference sample lines. For example, the index information may have a value corresponding to any one of 0 to 3.

When the top boundary of the target block is the boundary of a CTU, only reference sample line 0 may be available. Therefore, in this case, index information may not be signaled. When an additional reference sample line other than reference sample line 0 is used, filtering of a prediction block, which will be described later, may not be performed.

In the case of inter-color intra prediction, a prediction block for a target block of a second color component may be generated based on the corresponding reconstructed block of a first color component.

For example, the first color component may be a luma component, and the second color component may be a chroma component.

In order to perform inter-color intra prediction, parameters for a linear model between the first color component and the second color component may be derived based on a template.

The template may include reference samples above the target block (above reference samples) and/or reference samples to the left of the target block (left reference samples), and may include above reference samples and/or left reference samples of a reconstructed block of the first color component, which correspond to the reference samples.

For example, parameters for a linear model may be derived using 1) the value of the sample of a first color component having the maximum value, among the samples in the template, 2) the value of the sample of a second color component corresponding to the sample of the first color component, 3) the value of the sample of a first color component having the minimum value, among the samples in the template, and 4) the value of the sample of a second color component corresponding to the sample of the first color component.

When the parameters for the linear model are derived, a prediction block for the target block may be generated by applying the corresponding reconstructed block to the linear model.

Depending on the image format, sub-sampling may be performed on samples neighbor the reconstructed block of the first color component and the corresponding reconstructed block of the first color component. For example, when one sample of the second color component corresponds to four samples of the first color component, one corresponding sample may be calculated by performing sub-sampling on the four samples of the first color component. When sub-sampling is performed, derivation of the parameters for the linear model and inter-color intra prediction may be performed based on the sub-sampled corresponding sample.

Information about whether inter-color intra prediction is performed and/or the range of the template may be signaled in an intra-prediction mode.

The target block may be partitioned into two or four sub-blocks in a horizontal direction and/or a vertical direction.

The sub-blocks resulting from the partitioning may be sequentially reconstructed. That is, as intra-prediction is performed on each sub-block, a sub-prediction block for the sub-block may be generated. Also, as dequantization (inverse quantization) and/or an inverse transform are performed on each sub-block, a sub-residual block for the corresponding sub-block may be generated. A reconstructed sub-block may be generated by adding the sub-prediction block to the sub-residual block. The reconstructed sub-block may be used as a reference sample for intra prediction of the sub-block having the next priority.

A sub-block may be a block including a specific number (e.g., 16) of samples or more. For example, when the target block is an 8×4 block or a 4×8 block, the target block may be partitioned into two sub-blocks. Also, when the target block is a 4×4 block, the target block cannot be partitioned into sub-blocks. When the target block has another size, the target block may be partitioned into four sub-blocks.

Information about whether intra prediction based on such sub-blocks is performed and/or information about a partition direction (horizontal direction or vertical direction) may be signaled.

Such sub-block-based intra prediction may be limited such that it is performed only when reference sample line 0 is used. When sub-block-based intra-prediction is performed, filtering of a prediction block, which will be described below, may not be performed.

A final prediction block may be generated by performing filtering on the prediction block generated via intra prediction.

Filtering may be performed by applying specific weights to a filtering target sample, which is the target to be filtered, a left reference sample, an above reference sample, and/or an above-left reference sample.

The weights and/or reference samples (e.g., the range of reference samples, the locations of the reference samples, etc.) used for filtering may be determined based on at least one of a block size, an intra-prediction mode, and the location of the filtering target sample in a prediction block.

For example, filtering may be performed only in a specific intra-prediction mode (e.g., DC mode, planar mode, vertical mode, horizontal mode, diagonal mode and/or adjacent diagonal mode).

The adjacent diagonal mode may be a mode having a number obtained by adding k to the number of the diagonal mode, and may be a mode having a number obtained by subtracting k from the number of the diagonal mode. In other words, the number of the adjacent diagonal mode may be the sum of the number of the diagonal mode and k, or may be the difference between the number of the diagonal mode and k. For example, k may be a positive integer of 8 or less.

The intra-prediction mode of the target block may be derived using the intra-prediction mode of a neighbor block present near the target block, and such a derived intra-prediction mode may be entropy-encoded and/or entropy-decoded.

For example, when the intra-prediction mode of the target block is identical to the intra-prediction mode of the neighbor block, information indicating that the intra-prediction mode of the target block is identical to the intra-prediction mode of the neighbor block may be signaled using specific flag information.

Further, for example, indicator information for a neighbor block having an intra-prediction mode identical to the intra-prediction mode of the target block, among intra-prediction modes of multiple neighbor blocks, may be signaled.

For example, when the intra-prediction mode of the target block is different from the intra-prediction mode of the neighbor block, entropy encoding and/or entropy decoding may be performed on information about the intra-prediction mode of the target block by performing entropy encoding and/or entropy decoding based on the intra-prediction mode of the neighbor block.

FIG. 9 is a diagram for explaining an embodiment of an inter prediction procedure.

The rectangles shown in FIG. 9 may represent images (or pictures). Further, in FIG. 9, arrows may represent prediction directions. An arrow pointing from a first picture to a second picture means that the second picture refers to the first picture. That is, each image may be encoded and/or decoded depending on the prediction direction.

Images may be classified into an Intra Picture (I picture), a Uni-prediction Picture or Predictive Coded Picture (P picture), and a Bi-prediction Picture or Bi-predictive Coded Picture (B picture) depending on the encoding type. Each picture may be encoded and/or decoded depending on the encoding type thereof.

When a target image that is the target to be encoded is an I picture, the target image may be encoded using data contained in the image itself without inter prediction that refers to other images. For example, an I picture may be encoded only via intra prediction.

When a target image is a P picture, the target image may be encoded via inter prediction, which uses reference pictures existing in one direction. Here, the one direction may be a forward direction or a backward direction.

When a target image is a B picture, the image may be encoded via inter prediction that uses reference pictures existing in two directions, or may be encoded via inter prediction that uses reference pictures existing in one of a forward direction and a backward direction. Here, the two directions may be the forward direction and the backward direction.

A P picture and a B picture that are encoded and/or decoded using reference pictures may be regarded as images in which inter prediction is used.

Below, inter prediction in an inter mode according to an embodiment will be described in detail.

Inter prediction or a motion compensation may be performed using a reference image and motion information.

In an inter mode, the encoding apparatus 100 may perform inter prediction and/or motion compensation on a target block. The decoding apparatus 200 may perform inter prediction and/or motion compensation, corresponding to inter prediction and/or motion compensation performed by the encoding apparatus 100, on a target block.

Motion information of the target block may be individually derived by the encoding apparatus 100 and the decoding apparatus 200 during the inter prediction. The motion information may be derived using motion information of a reconstructed neighbor block, motion information of a col block, and/or motion information of a block adjacent to the col block.

For example, the encoding apparatus 100 or the decoding apparatus 200 may perform prediction and/or motion compensation by using motion information of a spatial candidate and/or a temporal candidate as motion information of the target block. The target block may mean a PU and/or a PU partition.

A spatial candidate may be a reconstructed block which is spatially adjacent to the target block.

A temporal candidate may be a reconstructed block corresponding to the target block in a previously reconstructed co-located picture (col picture).

In inter prediction, the encoding apparatus 100 and the decoding apparatus 200 may improve encoding efficiency and decoding efficiency by utilizing the motion information of a spatial candidate and/or a temporal candidate. The motion information of a spatial candidate may be referred to as ‘spatial motion information’. The motion information of a temporal candidate may be referred to as ‘temporal motion information’.

Below, the motion information of a spatial candidate may be the motion information of a PU including the spatial candidate. The motion information of a temporal candidate may be the motion information of a PU including the temporal candidate. The motion information of a candidate block may be the motion information of a PU including the candidate block.

Inter prediction may be performed using a reference picture.

The reference picture may be at least one of a picture previous to a target picture and a picture subsequent to the target picture. The reference picture may be an image used for the prediction of the target block.

In inter prediction, a region in the reference picture may be specified by utilizing a reference picture index (or refIdx) for indicating a reference picture, a motion vector, which will be described later, etc. Here, the region specified in the reference picture may indicate a reference block.

Inter prediction may select a reference picture, and may also select a reference block corresponding to the target block from the reference picture. Further, inter prediction may generate a prediction block for the target block using the selected reference block.

The motion information may be derived during inter prediction by each of the encoding apparatus 100 and the decoding apparatus 200.

A spatial candidate may be a block 1) which is present in a target picture, 2) which has been previously reconstructed via encoding and/or decoding, and 3) which is adjacent to the target block or is located at the corner of the target block. Here, the “block located at the corner of the target block” may be either a block vertically adjacent to a neighbor block that is horizontally adjacent to the target block, or a block horizontally adjacent to a neighbor block that is vertically adjacent to the target block. Further, “block located at the corner of the target block” may have the same meaning as “block adjacent to the corner of the target block”. The meaning of “block located at the corner of the target block” may be included in the meaning of “block adjacent to the target block”.

For example, a spatial candidate may be a reconstructed block located to the left of the target block, a reconstructed block located above the target block, a reconstructed block located at the below-left corner of the target block, a reconstructed block located at the above-right corner of the target block, or a reconstructed block located at the above-left corner of the target block.

Each of the encoding apparatus 100 and the decoding apparatus 200 may identify a block present at the location spatially corresponding to the target block in a col picture. The location of the target block in the target picture and the location of the identified block in the col picture may correspond to each other.

Each of the encoding apparatus 100 and the decoding apparatus 200 may determine a col block present at the predefined relative location for the identified block to be a temporal candidate. The predefined relative location may be a location present inside and/or outside the identified block.

For example, the col block may include a first col block and a second col block. When the coordinates of the identified block are (xP, yP) and the size of the identified block is represented by (nPSW, nPSH), the first col block may be a block located at coordinates (xP+nPSW, yP+nPSH). The second col block may be a block located at coordinates (xP+ (nPSW>>1), yP+ (nPSH>>1)). The second col block may be selectively used when the first col block is unavailable.

The motion vector of the target block may be determined based on the motion vector of the col block. Each of the encoding apparatus 100 and the decoding apparatus 200 may scale the motion vector of the col block. The scaled motion vector of the col block may be used as the motion vector of the target block. Further, a motion vector for the motion information of a temporal candidate stored in a list may be a scaled motion vector.

The ratio of the motion vector of the target block to the motion vector of the col block may be identical to the ratio of a first temporal distance to a second temporal distance. The first temporal distance may be the distance between the reference picture and the target picture of the target block. The second temporal distance may be the distance between the reference picture and the col picture of the col block.

The scheme for deriving motion information may change depending on the inter-prediction mode of a target block. For example, as inter-prediction modes applied for inter prediction, an Advanced Motion Vector Predictor (AMVP) mode, a merge mode, a skip mode, a merge mode with a motion vector difference, a sub block merge mode, a triangle partition mode, an inter-intra combined prediction mode, an affine inter mode, a current picture reference mode, etc. may be present. The merge mode may also be referred to as a “motion merge mode”. Individual modes will be described in detail below.

### 1) AMVP Mode

When an AMVP mode is used, the encoding apparatus 100 may search a neighbor region of a target block for a similar block. The encoding apparatus 100 may acquire a prediction block by performing prediction on the target block using motion information of the found similar block. The encoding apparatus 100 may encode a residual block, which is the difference between the target block and the prediction block.

### 1-1) Creation of List of Prediction Motion Vector Candidates

When an AMVP mode is used as the prediction mode, each of the encoding apparatus 100 and the decoding apparatus 200 may create a list of prediction motion vector candidates using the motion vector of a spatial candidate, the motion vector of a temporal candidate, and a zero vector. The prediction motion vector candidate list may include one or more prediction motion vector candidates. At least one of the motion vector of a spatial candidate, the motion vector of a temporal candidate, and a zero vector may be determined and used as a prediction motion vector candidate.

Hereinafter, the terms “prediction motion vector (candidate)” and “motion vector (candidate)” may be used to have the same meaning, and may be used interchangeably with each other.

Hereinafter, the terms “prediction motion vector candidate” and “AMVP candidate” may be used to have the same meaning, and may be used interchangeably with each other.

Hereinafter, the terms “prediction motion vector candidate list” and “AMVP candidate list” may be used to have the same meaning, and may be used interchangeably with each other.

Spatial candidates may include a reconstructed spatial neighbor block. In other words, the motion vector of the reconstructed neighbor block may be referred to as a “spatial prediction motion vector candidate”.

Temporal candidates may include a col block and a block adjacent to the col block. In other words, the motion vector of the col block or the motion vector of the block adjacent to the col block may be referred to as a “temporal prediction motion vector candidate”.

The zero vector may be a (0, 0) motion vector.

The prediction motion vector candidates may be motion vector predictors for predicting a motion vector. Also, in the encoding apparatus 100, each prediction motion vector candidate may be an initial search location for a motion vector.

1-2) Search for Motion Vectors that Use List of Prediction Motion Vector Candidates

The encoding apparatus 100 may determine the motion vector to be used to encode a target block within a search range using a list of prediction motion vector candidates. Further, the encoding apparatus 100 may determine a prediction motion vector candidate to be used as the prediction motion vector of the target block, among prediction motion vector candidates present in the prediction motion vector candidate list.

The motion vector to be used to encode the target block may be a motion vector that can be encoded at minimum cost.

Further, the encoding apparatus 100 may determine whether to use the AMVP mode to encode the target block.

### 1-3) Transmission of Inter-Prediction Information

The encoding apparatus 100 may generate a bitstream including inter-prediction information required for inter prediction. The decoding apparatus 200 may perform inter prediction on the target block using the inter-prediction information of the bitstream.

The inter-prediction information may contain 1) mode information indicating whether an AMVP mode is used, 2) a prediction motion vector index, 3) a Motion Vector Difference (MVD), 4) a reference direction, and 5) a reference picture index.

Hereinafter, the terms “prediction motion vector index” and “AMVP index” may be used to have the same meaning, and may be used interchangeably with each other.

Further, the inter-prediction information may contain a residual signal.

The decoding apparatus 200 may acquire a prediction motion vector index, an MVD, a reference direction, and a reference picture index from the bitstream through entropy decoding when mode information indicates that the AMVP mode is used.

The prediction motion vector index may indicate a prediction motion vector candidate to be used for the prediction of a target block, among prediction motion vector candidates included in the prediction motion vector candidate list.

1-4) Inter Prediction in AMVP Mode that Uses Inter-Prediction Information

The decoding apparatus 200 may derive prediction motion vector candidates using a prediction motion vector candidate list, and may determine the motion information of a target block based on the derived prediction motion vector candidates.

The decoding apparatus 200 may determine a motion vector candidate for the target block, among the prediction motion vector candidates included in the prediction motion vector candidate list, using a prediction motion vector index. The decoding apparatus 200 may select a prediction motion vector candidate, indicated by the prediction motion vector index, from among prediction motion vector candidates included in the prediction motion vector candidate list, as the prediction motion vector of the target block.

The encoding apparatus 100 may generate an entropy-encoded prediction motion vector index by applying entropy encoding to a prediction motion vector index, and may generate a bitstream including the entropy-encoded prediction motion vector index. The entropy-encoded prediction motion vector index may be signaled from the encoding apparatus 100 to the decoding apparatus 200 through a bitstream. The decoding apparatus 200 may extract the entropy-encoded prediction motion vector index from the bitstream, and may acquire the prediction motion vector index by applying entropy decoding to the entropy-encoded prediction motion vector index.

The motion vector to be actually used for inter prediction of the target block may not match the prediction motion vector. In order to indicate the difference between the motion vector to be actually used for inter prediction of the target block and the prediction motion vector, an MVD may be used. The encoding apparatus 100 may derive a prediction motion vector similar to the motion vector to be actually used for inter prediction of the target block so as to use an MVD that is as small as possible.

A Motion Vector Difference (MVD) may be the difference between the motion vector of the target block and the prediction motion vector. The encoding apparatus 100 may calculate the MVD, and may generate an entropy-encoded MVD by applying entropy encoding to the MVD. The encoding apparatus 100 may generate a bitstream including the entropy-encoded MVD.

The MVD may be transmitted from the encoding apparatus 100 to the decoding apparatus 200 through the bitstream. The decoding apparatus 200 may extract the entropy-encoded MVD from the bitstream, and may acquire the MVD by applying entropy decoding to the entropy-encoded MVD.

The decoding apparatus 200 may derive the motion vector of the target block by summing the MVD and the prediction motion vector. In other words, the motion vector of the target block derived by the decoding apparatus 200 may be the sum of the MVD and the motion vector candidate.

Also, the encoding apparatus 100 may generate entropy-encoded MVD resolution information by applying entropy encoding to calculated MVD resolution information, and may generate a bitstream including the entropy-encoded MVD resolution information. The decoding apparatus 200 may extract the entropy-encoded MVD resolution information from the bitstream, and may acquire MVD resolution information by applying entropy decoding to the entropy-encoded MVD resolution information. The decoding apparatus 200 may adjust the resolution of the MVD using the MVD resolution information.

Meanwhile, the encoding apparatus 100 may calculate an MVD based on an affine model. The decoding apparatus 200 may derive the affine control motion vector of the target block through the sum of the MVD and an affine control motion vector candidate, and may derive the motion vector of a sub-block using the affine control motion vector.

The reference direction may indicate a list of reference pictures to be used for prediction of the target block. For example, the reference direction may indicate one of a reference picture list L0 and a reference picture list L1.

The reference direction merely indicates the reference picture list to be used for prediction of the target block, and may not mean that the directions of reference pictures are limited to a forward direction or a backward direction. In other words, each of the reference picture list L0 and the reference picture list L1 may include pictures in a forward direction and/or a backward direction.

That the reference direction is unidirectional may mean that a single reference picture list is used. That the reference direction is bidirectional may mean that two reference picture lists are used. In other words, the reference direction may indicate one of the case where only the reference picture list L0 is used, the case where only the reference picture list L1 is used, and the case where two reference picture lists are used.

The reference picture index may indicate a reference picture that is used for prediction of the target block, among reference pictures present in a reference picture list. The encoding apparatus 100 may generate an entropy-encoded reference picture index by applying entropy encoding to the reference picture index, and may generate a bitstream including the entropy-encoded reference picture index. The entropy-encoded reference picture index may be signaled from the encoding apparatus 100 to the decoding apparatus 200 through the bitstream. The decoding apparatus 200 may extract the entropy-encoded reference picture index from the bitstream, and may acquire the reference picture index by applying entropy decoding to the entropy-encoded reference picture index.

When two reference picture lists are used to predict the target block, a single reference picture index and a single motion vector may be used for each of the reference picture lists. Further, when two reference picture lists are used to predict the target block, two prediction blocks may be specified for the target block. For example, the (final) prediction block of the target block may be generated using the average or weighted sum of the two prediction blocks for the target block.

The motion vector of the target block may be derived by the prediction motion vector index, the MVD, the reference direction, and the reference picture index.

The decoding apparatus 200 may generate a prediction block for the target block based on the derived motion vector and the reference picture index. For example, the prediction block may be a reference block, indicated by the derived motion vector, in the reference picture indicated by the reference picture index.

Since the prediction motion vector index and the MVD are encoded without the motion vector itself of the target block being encoded, the number of bits transmitted from the encoding apparatus 100 to the decoding apparatus 200 may be decreased, and encoding efficiency may be improved.

For the target block, the motion information of reconstructed neighbor blocks may be used. In a specific inter-prediction mode, the encoding apparatus 100 may not separately encode the actual motion information of the target block. The motion information of the target block is not encoded, and additional information that enables the motion information of the target block to be derived using the motion information of reconstructed neighbor blocks may be encoded instead. As the additional information is encoded, the number of bits transmitted to the decoding apparatus 200 may be decreased, and encoding efficiency may be improved.

For example, as inter-prediction modes in which the motion information of the target block is not directly encoded, there may be a skip mode and/or a merge mode. Here, each of the encoding apparatus 100 and the decoding apparatus 200 may use an identifier and/or an index that indicates a unit, the motion information of which is to be used as the motion information of the target unit, among reconstructed neighbor units.

### 2) Merge Mode

As a scheme for deriving the motion information of a target block, there is merging. The term “merging” may mean the merging of the motion of multiple blocks. “Merging” may mean that the motion information of one block is also applied to other blocks. In other words, a merge mode may be a mode in which the motion information of the target block is derived from the motion information of a neighbor block.

When a merge mode is used, the encoding apparatus 100 may predict the motion information of a target block using the motion information of a spatial candidate and/or the motion information of a temporal candidate. The spatial candidate may include a reconstructed spatial neighbor block that is spatially adjacent to the target block. The spatial neighbor block may include a left neighbor block and an above neighbor block. The temporal candidate may include a col block. The terms “spatial candidate” and “spatial merge candidate” may be used to have the same meaning, and may be used interchangeably with each other. The terms “temporal candidate” and “temporal merge candidate” may be used to have the same meaning, and may be used interchangeably with each other.

The encoding apparatus 100 may acquire a prediction block via prediction. The encoding apparatus 100 may encode a residual block, which is the difference between the target block and the prediction block.

### 2-1) Creation of Merge Candidate List

When the merge mode is used, each of the encoding apparatus 100 and the decoding apparatus 200 may create a merge candidate list using the motion information of a spatial candidate and/or the motion information of a temporal candidate. The motion information may include 1) a motion vector, 2) a reference picture index, and 3) a reference direction. The reference direction may be unidirectional or bidirectional. The reference direction may mean a inter prediction indicator.

The merge candidate list may include merge candidates. The merge candidates may be motion information. In other words, the merge candidate list may be a list in which pieces of motion information are stored.

The merge candidates may be pieces of motion information of temporal candidates and/or spatial candidates. In other words, the merge candidates list may comprise motion information of a temporal candidates and/or spatial candidates, etc.

Further, the merge candidate list may include new merge candidates generated by a combination of merge candidates that are already present in the merge candidate list. In other words, the merge candidate list may include new motion information generated by a combination of pieces of motion information previously present in the merge candidate list.

Also, a merge candidate list may include history-based merge candidates. The history-based merge candidates may be the motion information of a block which is encoded and/or decoded prior to a target block.

Also, a merge candidate list may include a merge candidate based on an average of two merge candidates.

The merge candidates may be specific modes deriving inter prediction information. The merge candidate may be information indicating a specific mode deriving inter prediction information. Inter prediction information of a target block may be derived according to a specific mode which the merge candidate indicates. Furthermore, the specific mode may include a process of deriving a series of inter prediction information. This specific mode may be an inter prediction information derivation mode or a motion information derivation mode.

The inter prediction information of the target block may be derived according to the mode indicated by the merge candidate selected by the merge index among the merge candidates in the merge candidate list.

For example, the motion information derivation modes in the merge candidate list may be at least one of 1) motion information derivation mode for a sub-block unit and 2) an affine motion information derivation mode.

Furthermore, the merge candidate list may include motion information of a zero vector. The zero vector may also be referred to as a “zero-merge candidate”.

In other words, pieces of motion information in the merge candidate list may be at least one of 1) motion information of a spatial candidate, 2) motion information of a temporal candidate, 3) motion information generated by a combination of pieces of motion information previously present in the merge candidate list, and 4) a zero vector.

Motion information may include 1) a motion vector, 2) a reference picture index, and 3) a reference direction. The reference direction may also be referred to as an “inter-prediction indicator”. The reference direction may be unidirectional or bidirectional. The unidirectional reference direction may indicate L0 prediction or L1 prediction.

The merge candidate list may be created before prediction in the merge mode is performed.

The number of merge candidates in the merge candidate list may be predefined. Each of the encoding apparatus 100 and the decoding apparatus 200 may add merge candidates to the merge candidate list depending on the predefined scheme and predefined priorities so that the merge candidate list has a predefined number of merge candidates. The merge candidate list of the encoding apparatus 100 and the merge candidate list of the decoding apparatus 200 may be made identical to each other using the predefined scheme and the predefined priorities.

Merging may be applied on a CU basis or a PU basis. When merging is performed on a CU basis or a PU basis, the encoding apparatus 100 may transmit a bitstream including predefined information to the decoding apparatus 200. For example, the predefined information may contain 1) information indicating whether to perform merging for individual block partitions, and 2) information about a block with which merging is to be performed, among blocks that are spatial candidates and/or temporal candidates for the target block.

2-2) Search for Motion Vector that Uses Merge Candidate List

The encoding apparatus 100 may determine merge candidates to be used to encode a target block. For example, the encoding apparatus 100 may perform prediction on the target block using merge candidates in the merge candidate list, and may generate residual blocks for the merge candidates. The encoding apparatus 100 may use a merge candidate that incurs the minimum cost in prediction and in the encoding of residual blocks to encode the target block.

Further, the encoding apparatus 100 may determine whether to use a merge mode to encode the target block.

### 2-3) Transmission of Inter-Prediction Information

The encoding apparatus 100 may generate a bitstream that includes inter-prediction information required for inter prediction. The encoding apparatus 100 may generate entropy-encoded inter-prediction information by performing entropy encoding on inter-prediction information, and may transmit a bitstream including the entropy-encoded inter-prediction information to the decoding apparatus 200. Through the bitstream, the entropy-encoded inter-prediction information may be signaled to the decoding apparatus 200 by the encoding apparatus 100. The decoding apparatus 200 may extract entropy-encoded inter-prediction information from the bitstream, and may acquire inter-prediction information by applying entropy decoding to the entropy-encoded inter-prediction information.

The decoding apparatus 200 may perform inter prediction on the target block using the inter-prediction information of the bitstream.

information indicating whether a merge mode is used, 2) a merge index and 3) correction information.

Further, the inter-prediction information may contain a residual signal.

The decoding apparatus 200 may acquire the merge index from the bitstream only when the mode information indicates that the merge mode is used.

The mode information may be a merge flag. The unit of the mode information may be a block. Information about the block may include mode information, and the mode information may indicate whether a merge mode is applied to the block.

The merge index may indicate a merge candidate to be used for the prediction of the target block, among merge candidates included in the merge candidate list. Alternatively, the merge index may indicate a block with which the target block is to be merged, among neighbor blocks spatially or temporally adjacent to the target block.

The encoding apparatus 100 may select a merge candidate having the highest encoding performance among the merge candidates included in the merge candidate list and set a value of the merge index to indicate the selected merge candidate.

Correction information may be information used to correct a motion vector. The encoding apparatus 100 may generate correction information. The decoding apparatus 200 may correct the motion vector of a merge candidate selected by a merge index based on the correction information.

The correction information may include at least one of information indicating whether correction is to be performed, correction direction information, and correction size information. A prediction mode in which the motion vector is corrected based on the signaled correction information may be referred to as a “merge mode having a motion vector difference”.

2-4) Inter Prediction of Merge Mode that Uses Inter-Prediction Information

The decoding apparatus 200 may perform prediction on the target block using the merge candidate indicated by the merge index, among merge candidates included in the merge candidate list.

The motion vector of the target block may be specified by the motion vector, reference picture index, and reference direction of the merge candidate indicated by the merge index.

### 3) Skip Mode

A skip mode may be a mode in which the motion information of a spatial candidate or the motion information of a temporal candidate is applied to the target block without change. Also, the skip mode may be a mode in which a residual signal is not used. In other words, when the skip mode is used, a reconstructed block may be the same as a prediction block.

The difference between the merge mode and the skip mode lies in whether or not a residual signal is transmitted or used. That is, the skip mode may be similar to the merge mode except that a residual signal is not transmitted or used.

When the skip mode is used, the encoding apparatus 100 may transmit information about a block, the motion information of which is to be used as the motion information of the target block, among blocks that are spatial candidates or temporal candidates, to the decoding apparatus 200 through a bitstream. The encoding apparatus 100 may generate entropy-encoded information by performing entropy encoding on the information, and may signal the entropy-encoded information to the decoding apparatus 200 through a bitstream. The decoding apparatus 200 may extract entropy-encoded information from the bitstream, and may acquire information by applying entropy decoding to the entropy-encoded information.

Further, when the skip mode is used, the encoding apparatus 100 may not transmit other syntax information, such as an MVD, to the decoding apparatus 200. For example, when the skip mode is used, the encoding apparatus 100 may not signal a syntax element related to at least one of an MVD, a coded block flag, and a transform coefficient level to the decoding apparatus 200.

### 3-1) Creation of Merge Candidate List

The skip mode may also use a merge candidate list. In other words, a merge candidate list may be used both in the merge mode and in the skip mode. In this aspect, the merge candidate list may also be referred to as a “skip candidate list” or a “merge/skip candidate list”.

Alternatively, the skip mode may use an additional candidate list different from that of the merge mode. In this case, in the following description, a merge candidate list and a merge candidate may be replaced with a skip candidate list and a skip candidate, respectively.

The merge candidate list may be created before prediction in the skip mode is performed.

3-2) Search for Motion Vector that Uses Merge Candidate List

The encoding apparatus 100 may determine the merge candidates to be used to encode a target block. For example, the encoding apparatus 100 may perform prediction on the target block using the merge candidates in a merge candidate list. The encoding apparatus 100 may use a merge candidate that incurs the minimum cost in prediction to encode the target block.

Further, the encoding apparatus 100 may determine whether to use a skip mode to encode the target block.

### 3-3) Transmission of Inter-Prediction Information

The encoding apparatus 100 may generate a bitstream that includes inter-prediction information required for inter prediction. The decoding apparatus 200 may perform inter prediction on the target block using the inter-prediction information of the bitstream.

The inter-prediction information may include 1) mode information indicating whether a skip mode is used, and 2) a skip index.

The skip index may be identical to the above-described merge index.

When the skip mode is used, the target block may be encoded without using a residual signal. The inter-prediction information may not contain a residual signal. Alternatively, the bitstream may not include a residual signal.

The decoding apparatus 200 may acquire a skip index from the bitstream only when the mode information indicates that the skip mode is used. As described above, a merge index and a skip index may be identical to each other. The decoding apparatus 200 may acquire the skip index from the bitstream only when the mode information indicates that the merge mode or the skip mode is used.

The skip index may indicate the merge candidate to be used for the prediction of the target block, among the merge candidates included in the merge candidate list.

3-4) Inter Prediction in Skip Mode that Uses Inter-Prediction Information

The decoding apparatus 200 may perform prediction on the target block using a merge candidate indicated by a skip index, among the merge candidates included in a merge candidate list. The motion vector of the target block may be specified by the motion vector, reference picture index, and reference direction of the merge candidate indicated by the skip index.

### 4) Current Picture Reference Mode

The current picture reference mode may denote a prediction mode that uses a previously reconstructed region in a target picture to which a target block belongs.

A motion vector for specifying the previously reconstructed region may be used. Whether the target block has been encoded in the current picture reference mode may be determined using the reference picture index of the target block.

A flag or index indicating whether the target block is a block encoded in the current picture reference mode may be signaled by the encoding apparatus 100 to the decoding apparatus 200. Alternatively, whether the target block is a block encoded in the current picture reference mode may be inferred through the reference picture index of the target block.

When the target block is encoded in the current picture reference mode, the target picture may exist at a fixed location or an arbitrary location in a reference picture list for the target block.

For example, the fixed location may be either a location where a value of the reference picture index is 0 or the last location.

When the target picture exists at an arbitrary location in the reference picture list, an additional reference picture index indicating such an arbitrary location may be signaled by the encoding apparatus 100 to the decoding apparatus 200.

### 5) Subblock Merge Mode

A sub-block merge mode may be a mode in which motion information is derived from the sub-block of a CU.

When the sub-block merge mode is applied, a sub-block merge candidate list may be generated using the motion information of a co-located sub-block (col-sub-block) of a target sub-block (i.e., a sub-block-based temporal merge candidate) in a reference image and/or an affine control point motion vector merge candidate.

### 6) Triangle Partition Mode

In a triangle partition mode, a target block may be partitioned in a diagonal direction, and sub-target blocks resulting from partitioning may be generated. For each sub-target block, motion information of the corresponding sub-target block may be derived, and a prediction sample for each sub-target block may be derived using the derived motion information. A prediction sample for the target block may be derived through a weighted sum of the prediction samples for the sub-target blocks resulting from the partitioning.

### 7) Combination Inter-Intra Prediction Mode

The combination inter-intra prediction mode may be a mode in which a prediction sample for a target block is derived using a weighted sum of a prediction sample generated via inter-prediction and a prediction sample generated via intra-prediction.

In the above-described modes, the decoding apparatus 200 may autonomously correct derived motion information. For example, the decoding apparatus 200 may search a specific area for motion information having the minimum sum of Absolute Differences (SAD) based on a reference block indicated by the derived motion information, and may derive the found motion information as corrected motion information.

In the above-described modes, the decoding apparatus 200 may compensate for the prediction sample derived via inter prediction using an optical flow.

In the above-described AMVP mode, merge mode, skip mode, etc., motion information to be used for prediction of the target block may be specified among pieces of motion information in a list using the index information of the list.

In order to improve encoding efficiency, the encoding apparatus 100 may signal only the index of an element that incurs the minimum cost in inter prediction of the target block, among elements in the list. The encoding apparatus 100 may encode the index, and may signal the encoded index.

Therefore, the above-described lists (i.e. the prediction motion vector candidate list and the merge candidate list) must be able to be derived by the encoding apparatus 100 and the decoding apparatus 200 using the same scheme based on the same data. Here, the same data may include a reconstructed picture and a reconstructed block. Further, in order to specify an element using an index, the order of the elements in the list must be fixed.

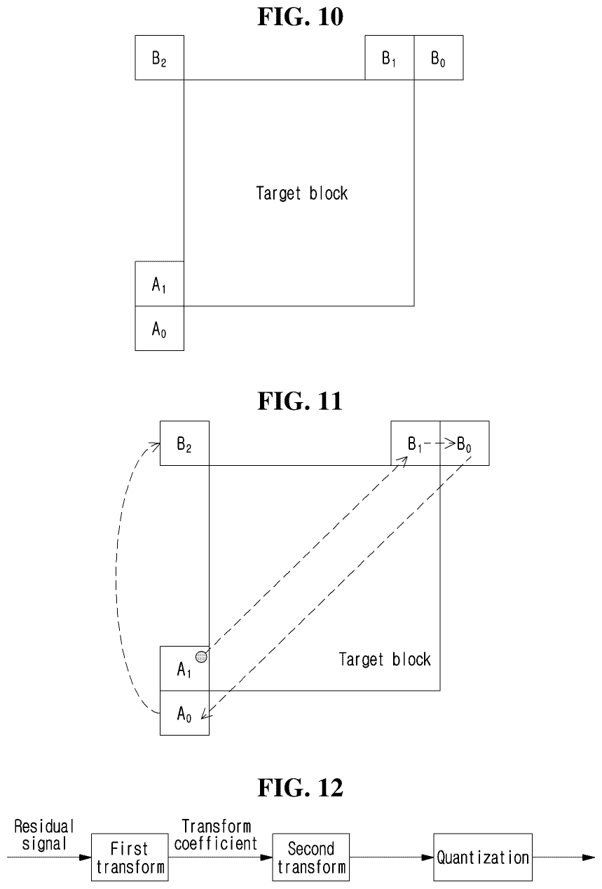

FIG. 10 illustrates spatial candidates according to an embodiment.

In FIG. 10, the locations of spatial candidates are illustrated.

The large block in the center of the drawing may denote a target block. Five small blocks may denote spatial candidates.

The coordinates of the target block may be (xP, yP), and the size of the target block may be represented by (nPSW, nPSH).

Spatial candidate A₀ may be a block adjacent to the below-left corner of the target block. A₀ may be a block that occupies pixels located at coordinates (xP−1, yP+nPSH).

Spatial candidate A₁ may be a block adjacent to the left of the target block. A₁ may be a lowermost block, among blocks adjacent to the left of the target block. Alternatively, A₁ may be a block adjacent to the top of A₀. A₁ may be a block that occupies pixels located at coordinates (xP−1, yP+nPSH−1).

Spatial candidate B₀ may be a block adjacent to the above-right corner of the target block. B₀ may be a block that occupies pixels located at coordinates (xP+nPSW, yP−1).

Spatial candidate B₁ may be a block adjacent to the top of the target block. B₁ may be a rightmost block, among blocks adjacent to the top of the target block. Alternatively, B₁ may be a block adjacent to the left of B₀. B₁ may be a block that occupies pixels located at coordinates (xP+nPSW−1, yP−1).

Spatial candidate B₂ may be a block adjacent to the above-left corner of the target block. B₂ may be a block that occupies pixels located at coordinates (xP−1, yP−1).

### Determination of Availability of Spatial Candidate and Temporal Candidate

In order to include the motion information of a spatial candidate or the motion information of a temporal candidate in a list, it must be determined whether the motion information of the spatial candidate or the motion information of the temporal candidate is available.

Hereinafter, a candidate block may include a spatial candidate and a temporal candidate.

For example, the determination may be performed by sequentially applying the following steps 1) to 4).

Step 1) When a PU including a candidate block is out of the boundary of a picture, the availability of the candidate block may be set to “false”. The expression “availability is set to false” may have the same meaning as “set to be unavailable”.

Step 2) When a PU including a candidate block is out of the boundary of a slice, the availability of the candidate block may be set to “false”. When the target block and the candidate block are located in different slices, the availability of the candidate block may be set to “false”.

Step 3) When a PU including a candidate block is out of the boundary of a tile, the availability of the candidate block may be set to “false”. When the target block and the candidate block are located in different tiles, the availability of the candidate block may be set to “false”.

Step 4) When the prediction mode of a PU including a candidate block is an intra-prediction mode, the availability of the candidate block may be set to “false”. When a PU including a candidate block does not use inter prediction, the availability of the candidate block may be set to “false”.

FIG. 11 illustrates the order of addition of motion information of spatial candidates to a merge list according to an embodiment.

As shown in FIG. 11, when pieces of motion information of spatial candidates are added to a merge list, the order of A₁, B₁, B₀, A₀, and B₂ may be used. That is, pieces of motion information of available spatial candidates may be added to the merge list in the order of A₁, B₁, B₀, A₀, and B₂.

### Method for Deriving Merge List in Merge Mode and Skip Mode

As described above, the maximum number of merge candidates in the merge list may be set. The set maximum number is indicated by “N”. The set number may be transmitted from the encoding apparatus 100 to the decoding apparatus 200. The slice header of a slice may include N. In other words, the maximum number of merge candidates in the merge list for the target block of the slice may be set by the slice header. For example, the value of N may be basically 5.

Pieces of motion information (i.e., merge candidates) may be added to the merge list in the order of the following steps 1) to 4).

Step 1) Among spatial candidates, available spatial candidates may be added to the merge list. Pieces of motion information of the available spatial candidates may be added to the merge list in the order illustrated in FIG. 11. Here, when the motion information of an available spatial candidate overlaps other motion information already present in the merge list, the motion information may not be added to the merge list. The operation of checking whether the corresponding motion information overlaps other motion information present in the list may be referred to in brief as an “overlap check”.

The maximum number of pieces of motion information that are added may be N.

Step 2) When the number of pieces of motion information in the merge list is less than N and a temporal candidate is available, the motion information of the temporal candidate may be added to the merge list. Here, when the motion information of the available temporal candidate overlaps other motion information already present in the merge list, the motion information may not be added to the merge list.

Step 3) When the number of pieces of motion information in the merge list is less than N and the type of a target slice is “B”, combined motion information generated by combined bidirectional prediction (bi-prediction) may be added to the merge list.

The target slice may be a slice including a target block.

The combined motion information may be a combination of L0 motion information and L1 motion information. L0 motion information may be motion information that refers only to a reference picture list L0. L1 motion information may be motion information that refers only to a reference picture list L1.

In the merge list, one or more pieces of L0 motion information may be present. Further, in the merge list, one or more pieces of L1 motion information may be present.

The combined motion information may include one or more pieces of combined motion information. When the combined motion information is generated, L0 motion information and L1 motion information, which are to be used for generation, among the one or more pieces of L0 motion information and the one or more pieces of L1 motion information, may be predefined. One or more pieces of combined motion information may be generated in a predefined order via combined bidirectional prediction, which uses a pair of different pieces of motion information in the merge list. One of the pair of different pieces of motion information may be L0 motion information and the other of the pair may be L1 motion information.

For example, combined motion information that is added with the highest priority may be a combination of L0 motion information having a merge index of 0 and L1 motion information having a merge index of 1. When motion information having a merge index of 0 is not L0 motion information or when motion information having a merge index of 1 is not L1 motion information, the combined motion information may be neither generated nor added. Next, the combined motion information that is added with the next priority may be a combination of L0 motion information, having a merge index of 1, and L1 motion information, having a merge index of 0. Subsequent detailed combinations may conform to other combinations of video encoding/decoding fields.

Here, when the combined motion information overlaps other motion information already present in the merge list, the combined motion information may not be added to the merge list.

Step 4) When the number of pieces of motion information in the merge list is less than N, motion information of a zero vector may be added to the merge list.

The zero-vector motion information may be motion information for which the motion vector is a zero vector.

The number of pieces of zero-vector motion information may be one or more. The reference picture indices of one or more pieces of zero-vector motion information may be different from each other. For example, the value of the reference picture index of first zero-vector motion information may be 0. The value of the reference picture index of second zero-vector motion information may be 1.

The number of pieces of zero-vector motion information may be identical to the number of reference pictures in the reference picture list.

The reference direction of zero-vector motion information may be bidirectional. Both of the motion vectors may be zero vectors. The number of pieces of zero-vector motion information may be the smaller one of the number of reference pictures in the reference picture list L0 and the number of reference pictures in the reference picture list L1. Alternatively, when the number of reference pictures in the reference picture list L0 and the number of reference pictures in the reference picture list L1 are different from each other, a reference direction that is unidirectional may be used for a reference picture index that may be applied only to a single reference picture list.

The encoding apparatus 100 and/or the decoding apparatus 200 may sequentially add the zero-vector motion information to the merge list while changing the reference picture index.

When zero-vector motion information overlaps other motion information already present in the merge list, the zero-vector motion information may not be added to the merge list.

The order of the above-described steps 1) to 4) is merely exemplary, and may be changed. Further, some of the above steps may be omitted depending on predefined conditions.

### Method for Deriving Prediction Motion Vector Candidate List in AMVP Mode

The maximum number of prediction motion vector candidates in a prediction motion vector candidate list may be predefined. The predefined maximum number is indicated by N. For example, the predefined maximum number may be 2.

Pieces of motion information (i.e. prediction motion vector candidates) may be added to the prediction motion vector candidate list in the order of the following steps 1) to 3).

Step 1) Available spatial candidates, among spatial candidates, may be added to the prediction motion vector candidate list. The spatial candidates may include a first spatial candidate and a second spatial candidate.

The first spatial candidate may be one of A₀, A₁, scaled A₀, and scaled A₁. The second spatial candidate may be one of B₀, B₁, B₂, scaled B₀, scaled B₁, and scaled B₂.

Pieces of motion information of available spatial candidates may be added to the prediction motion vector candidate list in the order of the first spatial candidate and the second spatial candidate. In this case, when the motion information of an available spatial candidate overlaps other motion information already present in the prediction motion vector candidate list, the motion information may not be added to the prediction motion vector candidate list. In other words, when the value of N is 2, if the motion information of a second spatial candidate is identical to the motion information of a first spatial candidate, the motion information of the second spatial candidate may not be added to the prediction motion vector candidate list.

The maximum number of pieces of motion information that are added may be N.

Step 2) When the number of pieces of motion information in the prediction motion vector candidate list is less than N and a temporal candidate is available, the motion information of the temporal candidate may be added to the prediction motion vector candidate list. In this case, when the motion information of the available temporal candidate overlaps other motion information already present in the prediction motion vector candidate list, the motion information may not be added to the prediction motion vector candidate list.

Step 3) When the number of pieces of motion information in the prediction motion vector candidate list is less than N, zero-vector motion information may be added to the prediction motion vector candidate list.

The zero-vector motion information may include one or more pieces of zero-vector motion information. The reference picture indices of the one or more pieces of zero-vector motion information may be different from each other.

The encoding apparatus 100 and/or the decoding apparatus 200 may sequentially add pieces of zero-vector motion information to the prediction motion vector candidate list while changing the reference picture index.

When zero-vector motion information overlaps other motion information already present in the prediction motion vector candidate list, the zero-vector motion information may not be added to the prediction motion vector candidate list.

The description of the zero-vector motion information, made above in connection with the merge list, may also be applied to zero-vector motion information. A repeated description thereof will be omitted.

The order of the above-described steps 1) to 3) is merely exemplary, and may be changed. Further, some of the steps may be omitted depending on predefined conditions.

FIG. 12 illustrates a transform and quantization process according to an example.

As illustrated in FIG. 12, quantized levels may be generated by performing a transform and/or quantization process on a residual signal.

A residual signal may be generated as the difference between an original block and a prediction block. Here, the prediction block may be a block generated via intra prediction or inter prediction.

The residual signal may be transformed into a signal in a frequency domain through a transform procedure that is a part of a quantization procedure.

A transform kernel used for a transform may include various DCT kernels, such as Discrete Cosine Transform (DCT) type 2 (DCT-II) and Discrete Sine Transform (DST) kernels.

These transform kernels may perform a separable transform or a two-dimensional (2D) non-separable transform on the residual signal. The separable transform may be a transform indicating that a one-dimensional (1D) transform is performed on the residual signal in each of a horizontal direction and a vertical direction.

The DCT type and the DST type, which are adaptively used for a 1D transform, may include DCT-V, DCT-VIII, DST-I, and DST-VII in addition to DCT-II, as shown in each of the following Table 3 and the following table 4.

TABLE 3

| Transform set | Transform candidates |
|---|---|
| 0 | DST-VII, DCT-VIII |
| 1 | DST-VII, DST-I |
| 2 | DST-VII, DCT-V |

TABLE 4

| Transform set | Transform candidates |
|---|---|
| 0 | DST-VII, DCT-VIII, DST-I |
| 1 | DST-VII, DST-I, DCT-VIII |
| 2 | DST-VII, DCT-V, DST-I |

As shown in Table 3 and Table 4, when a DCT type or a DST type to be used for a transform is derived, transform sets may be used. Each transform set may include multiple transform candidates. Each transform candidate may be a DCT type or a DST type.

The following Table 5 shows examples of a transform set to be applied to a horizontal direction and a transform set to be applied to a vertical direction depending on intra-prediction modes.

TABLE 5

| Intra | | | | | | | | | | |
|---|---|---|---|---|---|---|---|---|---|---|
| prediction | | | | | | | | | | |
| mode | 0 | 1 | 2 | 3 | 4 | 5 | 6 | 7 | 8 | 9 |
| Vertical | 2 | 1 | 0 | 1 | 0 | 1 | 0 | 1 | 0 | 1 |
| direction | | | | | | | | | | |
| transform | | | | | | | | | | |
| set | | | | | | | | | | |
| Horizontal | 2 | 1 | 0 | 1 | 0 | 1 | 0 | 1 | 0 | 1 |
| direction | | | | | | | | | | |
| transform | | | | | | | | | | |
| set | | | | | | | | | | |
| Intra | | | | | | | | | | |
| prediction | | | | | | | | | | |
| mode | 10 | 11 | 12 | 13 | 14 | 15 | 16 | 17 | 18 | 19 |
| Vertical | 0 | 1 | 0 | 1 | 0 | 0 | 0 | 0 | 0 | 0 |
| direction | | | | | | | | | | |
| transform | | | | | | | | | | |
| set | | | | | | | | | | |
| Horizontal | 0 | 1 | 0 | 1 | 2 | 2 | 2 | 2 | 2 | 2 |
| direction | | | | | | | | | | |
| transform | | | | | | | | | | |
| set | | | | | | | | | | |
| Intra | | | | | | | | | | |
| prediction | | | | | | | | | | |
| mode | 20 | 21 | 22 | 23 | 24 | 25 | 26 | 27 | 28 | 29 |
| Vertical | 0 | 0 | 0 | 1 | 0 | 1 | 0 | 1 | 0 | 1 |
| direction | | | | | | | | | | |
| transform | | | | | | | | | | |
| set | | | | | | | | | | |
| Horizontal | 2 | 2 | 2 | 1 | 0 | 1 | 0 | 1 | 0 | 1 |
| direction | | | | | | | | | | |
| transform | | | | | | | | | | |
| set | | | | | | | | | | |
| Intra | | | | | | | | | | |
| prediction | | | | | | | | | | |
| mode | 30 | 31 | 32 | 33 | 34 | 35 | 36 | 37 | 38 | 39 |
| Vertical | 0 | 1 | 0 | 1 | 0 | 1 | 0 | 1 | 0 | 1 |
| direction | | | | | | | | | | |
| transform | | | | | | | | | | |
| set | | | | | | | | | | |
| Horizontal | 0 | 1 | 0 | 1 | 0 | 1 | 0 | 1 | 0 | 1 |
| direction | | | | | | | | | | |
| transform | | | | | | | | | | |
| set | | | | | | | | | | |
| Intra | | | | | | | | | | |
| prediction | | | | | | | | | | |
| mode | 40 | 41 | 42 | 43 | 44 | 45 | 46 | 47 | 48 | 49 |
| Vertical | 0 | 1 | 0 | 1 | 0 | 1 | 2 | 2 | 2 | 2 |
| direction | | | | | | | | | | |
| transform | | | | | | | | | | |
| set | | | | | | | | | | |
| Horizontal | 0 | 1 | 0 | 1 | 0 | 1 | 0 | 0 | 0 | 0 |
| direction | | | | | | | | | | |
| transform | | | | | | | | | | |
| set | | | | | | | | | | |
| Intra | | | | | | | | | | |
| prediction | | | | | | | | | | |
| mode | 50 | 51 | 52 | 53 | 54 | 55 | 56 | 57 | 58 | 59 |
| Vertical | 2 | 2 | 2 | 2 | 2 | 1 | 0 | 1 | 0 | 1 |
| direction | | | | | | | | | | |
| transform | | | | | | | | | | |
| set | | | | | | | | | | |
| Horizontal | 0 | 0 | 0 | 0 | 0 | 1 | 0 | 1 | 0 | 1 |
| direction | | | | | | | | | | |
| transform | | | | | | | | | | |
| set | | | | | | | | | | |

| Intra | | | | | | | |
|---|---|---|---|---|---|---|---|
| prediction | | | | | | | |
| mode | 60 | 61 | 62 | 63 | 64 | 65 | 66 |
| Vertical | 0 | 1 | 0 | 1 | 0 | 1 | 0 |
| direction | | | | | | | |
| transform | | | | | | | |
| set | | | | | | | |
| Horizontal | 0 | 1 | 0 | 1 | 0 | 1 | 0 |
| direction | | | | | | | |
| transform | | | | | | | |
| set | | | | | | | |

In Table 5, numbers of vertical transform sets and horizontal transform sets that are to be applied to the horizontal direction of a residual signal depending on the intra-prediction modes of the target block are indicated.

As exemplified in Table 5, transform sets to be applied to the horizontal direction and the vertical direction may be predefined depending on the intra-prediction mode of the target block. The encoding apparatus 100 may perform a transform and an inverse transform on the residual signal using a transform included in the transform set corresponding to the intra-prediction mode of the target block. Further, the decoding apparatus 200 may perform an inverse transform on the residual signal using a transform included in the transform set corresponding to the intra-prediction mode of the target block.

In the transform and inverse transform, transform sets to be applied to the residual signal may be determined, as exemplified in Tables 3, 4, and 5, and may not be signaled. Transform indication information may be signaled from the encoding apparatus 100 to the decoding apparatus 200. The transform indication information may be information indicating which one of multiple transform candidates included in the transform set to be applied to the residual signal is used.

For example, when the size of the target block is 64×64 or less, transform sets, transform sets having three transforms may be configured depending on the intra-prediction mode, respectively. An optimal transform method may be selected from among a total of nine multiple transform methods resulting from combinations of three transforms in a horizontal direction and three transforms in a vertical direction. Through such an optimal transform method, the residual signal may be encoded and/or decoded, and thus coding efficiency may be improved.

Here, information indicating which one of transforms belonging to each transform set has been used for at least one of a vertical transform and a horizontal transform may be entropy-encoded and/or -decoded. Here, truncated unary binarization may be used to encode and/or decode such information.

As described above, methods using various transforms may be applied to a residual signal generated via intra prediction or inter prediction.

The transform may include at least one of a first transform and a secondary transform. A transform coefficient may be generated by performing the first transform on the residual signal, and a secondary transform coefficient may be generated by performing the secondary transform on the transform coefficient.

The first transform may be referred to as a “primary transform”. Further, the first transform may also be referred to as an “Adaptive Multiple Transform (AMT) scheme”. AMT may mean that, as described above, different transforms are applied to respective 1D directions (i.e. a vertical direction and a horizontal direction).

A secondary transform may be a transform for improving energy concentration on a transform coefficient generated by the first transform. Similar to the first transform, the secondary transform may be a separable transform or a non-separable transform. Such a non-separable transform may be a Non-Separable Secondary Transform (NSST).

The first transform may be performed using at least one of predefined multiple transform methods. For example, the predefined multiple transform methods may include a Discrete Cosine Transform (DCT), a Discrete Sine Transform (DST), a Karhunen-Loeve Transform (KLT), etc.

Further, a first transform may be a transform having various transform types depending on a kernel function that defines a Discrete Cosine Transform (DCT) or a Discrete Sine Transform (DST).

For example, the transform type may be determined based at least one of 1) a prediction mode of a target block (for example, one of an intra prediction and an inter prediction), 2) a size of a target block, 3) a shape of a target block, 4) an intra prediction mode of a target block, 5) a component of a target block (for example, one of a luma component an a chroma component), and 6) a partitioning type applied to a target block (for example, one of a Quad Tree, a Binary Tree and a Ternary Tree).

For example, the first transform may include transforms, such as DCT-2, DCT-5, DCT-7, DST-7, DST-1, DST-8, and DCT-8 depending on the transform kernel presented in the following Table 6. In the following Table 6, various transform types and transform kernel functions for Multiple Transform Selection (MTS) are exemplified.

MTS may refer to the selection of combinations of one or more DCT and/or DST kernels so as to transform a residual signal in a horizontal and/or vertical direction.

TABLE 6

| Transform | |
|---|---|
| type | Transform kernel function Tᵢ(j) |
| DCT-2 | ${T}_{i} ( j ) = {ω}_{0} \cdot \sqrt{\frac{2}{N}} \cdot cos ( \frac{π \cdot i \cdot ( 2 j + 1 )}{2 N} )$ $where$ ${ω}_{0} = \sqrt{\frac{2}{N}} ( i = 0 ) or 1 ( otherwise )$ |
| DST-7 | ${T}_{i} ( j ) = \sqrt{\frac{4}{2 N + 1}} \cdot sin ( \frac{π \cdot ( 2 j + 1 ) \cdot ( j + 1 )}{2 N + 1} )$ |
| DCT-5 | ${T}_{i} ( j ) = {ω}_{0} \cdot {ω}_{1} \cdot \sqrt{\frac{2}{2 N - 1}} \cdot cos ( \frac{2 π \cdot i \cdot j}{2 N + 1} )$ $where$ ${ω}_{0 / 1} = \sqrt{\frac{2}{N}} ( i or j = 0 ) or 1 ( otherwise )$ |
| DCT-8 | ${T}_{i} ( j ) = \sqrt{\frac{4}{2 N + 1}} \cdot cos ( \frac{π \cdot ( 2 j + 1 ) \cdot ( 2 j + 1 )}{4 N + 2} )$ |
| DST-1 | ${T}_{i} ( j ) = \sqrt{\frac{2}{N + 1}} \cdot sin ( \frac{π \cdot ( i + 1 ) \cdot ( j + 1 )}{N + 1} )$ |

In Table 6, i and j may be integer values that are equal to or greater than 0 and are less than or equal to N−1.

The secondary transform may be performed on the transform coefficient generated by performing the first transform.

As in the first transform, transform sets may also be defined in a secondary transform. The methods for deriving and/or determining the above-described transform sets may be applied not only to the first transform but also to the secondary transform.

The first transform and the secondary transform may be determined for a specific target.

For example, a first transform and a secondary transform may be applied to signal components corresponding to one or more of a luminance (luma) component and a chrominance (chroma) component. Whether to apply the first transform and/or the secondary transform may be determined depending on at least one of coding parameters for a target block and/or a neighbor block. For example, whether to apply the first transform and/or the secondary transform may be determined depending on the size and/or shape of the target block.

In the encoding apparatus 100 and the decoding apparatus 200, transform information indicating the transform method to be used for the target may be derived by utilizing specified information.

For example, the transform information may include a transform index to be used for a primary transform and/or a secondary transform. Alternatively, the transform information may indicate that a primary transform and/or a secondary transform are not used.

For example, when the target of a primary transform and a secondary transform is a target block, the transform method(s) to be applied to the primary transform and/or the secondary transform indicated by the transform information may be determined depending on at least one of coding parameters for the target block and/or blocks neighbor the target block.

Alternatively, transform information indicating a transform method for a specific target may be signaled from the encoding apparatus 100 to the decoding apparatus 200.

For example, for a single CU, whether to use a primary transform, an index indicating the primary transform, whether to use a secondary transform, and an index indicating the secondary transform may be derived as the transform information by the decoding apparatus 200. Alternatively, for a single CU, the transform information, which indicates whether to use a primary transform, an index indicating the primary transform, whether to use a secondary transform, and an index indicating the secondary transform, may be signaled.

The quantized transform coefficient (i.e. the quantized levels) may be generated by performing quantization on the result, generated by performing the first transform and/or the secondary transform, or on the residual signal.

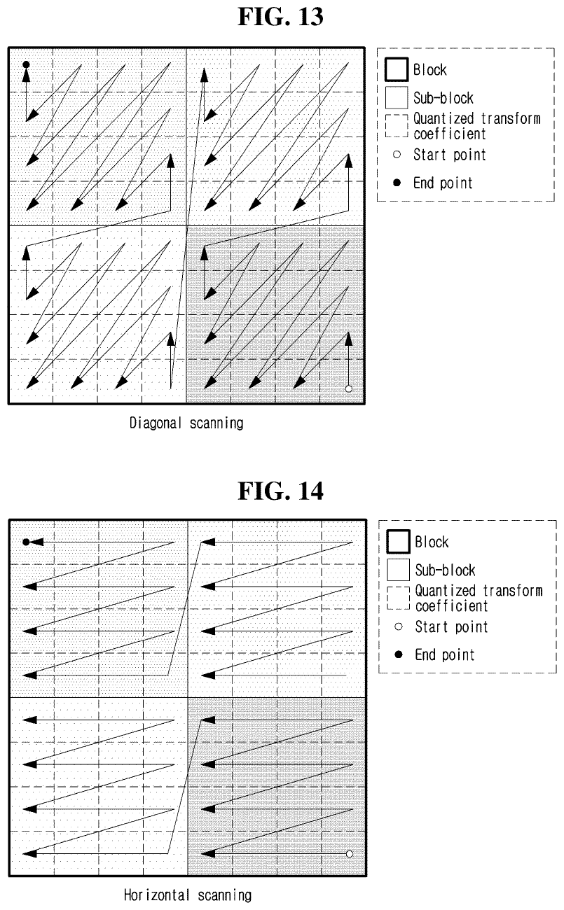

FIG. 13 illustrates diagonal scanning according to an example.

FIG. 14 illustrates horizontal scanning according to an example.

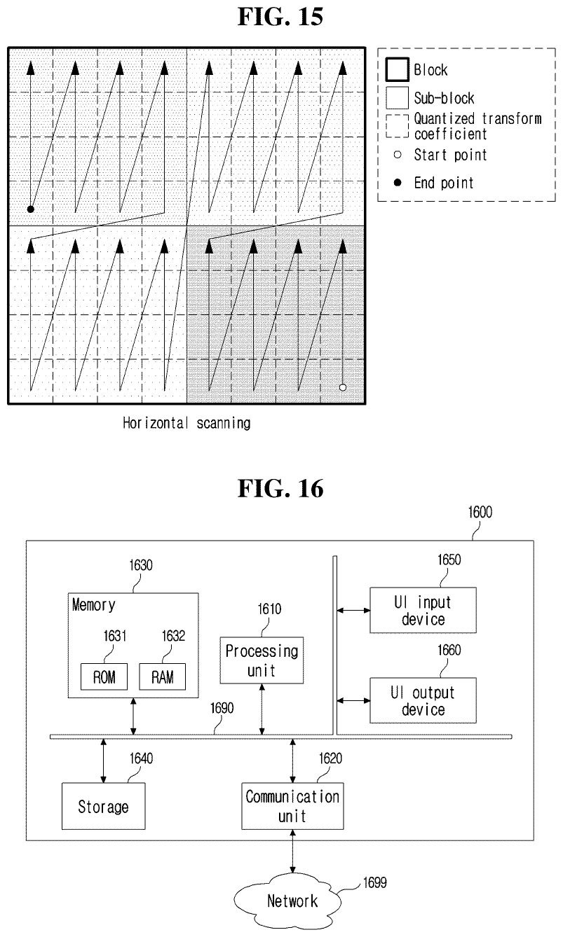

FIG. 15 illustrates vertical scanning according to an example.

Quantized transform coefficients may be scanned via at least one of (up-right) diagonal scanning, vertical scanning, and horizontal scanning depending on at least one of an intra-prediction mode, a block size, and a block shape. The block may be a Transform Unit (TU).

Each scanning may be initiated at a specific start point, and may be terminated at a specific end point.

For example, quantized transform coefficients may be changed to 1D vector forms by scanning the coefficients of a block using diagonal scanning of FIG. 13. Alternatively, horizontal scanning of FIG. 14 or vertical scanning of FIG. 15, instead of diagonal scanning, may be used depending on the size and/or intra-prediction mode of a block.

Vertical scanning may be the operation of scanning 2D block-type coefficients in a column direction. Horizontal scanning may be the operation of scanning 2D block-type coefficients in a row direction.

In other words, which one of diagonal scanning, vertical scanning, and horizontal scanning is to be used may be determined depending on the size and/or inter-prediction mode of the block.

As illustrated in FIGS. 13, 14, and 15, the quantized transform coefficients may be scanned along a diagonal direction, a horizontal direction or a vertical direction.

The quantized transform coefficients may be represented by block shapes. Each block may include multiple sub-blocks. Each sub-block may be defined depending on a minimum block size or a minimum block shape.

In scanning, a scanning sequence depending on the type or direction of scanning may be primarily applied to sub-blocks. Further, a scanning sequence depending on the direction of scanning may be applied to quantized transform coefficients in each sub-block.

For example, as illustrated in FIGS. 13, 14, and 15, when the size of a target block is 8×8, quantized transform coefficients may be generated through a first transform, a secondary transform, and quantization on the residual signal of the target block. Therefore, one of three types of scanning sequences may be applied to four 4×4 sub-blocks, and quantized transform coefficients may also be scanned for each 4×4 sub-block depending on the scanning sequence.

The encoding apparatus 100 may generate entropy-encoded quantized transform coefficients by performing entropy encoding on scanned quantized transform coefficients, and may generate a bitstream including the entropy-encoded quantized transform coefficients.

The decoding apparatus 200 may extract the entropy-encoded quantized transform coefficients from the bitstream, and may generate quantized transform coefficients by performing entropy decoding on the entropy-encoded quantized transform coefficients. The quantized transform coefficients may be aligned in the form of a 2D block via inverse scanning. Here, as the method of inverse scanning, at least one of up-right diagonal scanning, vertical scanning, and horizontal scanning may be performed.

In the decoding apparatus 200, dequantization may be performed on the quantized transform coefficients. A secondary inverse transform may be performed on the result generated by performing dequantization depending on whether to perform the secondary inverse transform. Further, a first inverse transform may be performed on the result generated by performing the secondary inverse transform depending on whether the first inverse transform is to be performed. A reconstructed residual signal may be generated by performing the first inverse transform on the result generated by performing the secondary inverse transform.

For a luma component which is reconstructed via intra prediction or inter prediction, inverse mapping having a dynamic range may be performed before in-loop filtering.

The dynamic range may be divided into 16 equal pieces, and mapping functions for respective pieces may be signaled. Such a mapping function may be signaled at a slice level or a tile group level.

An inverse mapping function for performing inverse mapping may be derived based on the mapping function.

In-loop filtering, the storage of a reference picture, and motion compensation may be performed in an inverse mapping area.

A prediction block generated via inter prediction may be changed to a mapped area through mapping using a mapping function, and the changed prediction block may be used to generate a reconstructed block. However, since intra prediction is performed in the mapped area, a prediction block generated via intra prediction may be used to generate a reconstructed block without requiring mapping and/or inverse mapping.

For example, when the target block is a residual block of a chroma component, the residual block may be changed to an inversely mapped area by scaling the chroma component of the mapped area.

Whether scaling is available may be signaled at a slice level or a tile group level.

For example, scaling may be applied only to the case where mapping is available for a luma component and where the partitioning of the luma component and the partitioning of the chroma component follow the same tree structure.

Scaling may be performed based on the average of the values of samples in a luma prediction block, which corresponds to a chroma prediction block. Here, when the target block uses inter prediction, the luma prediction block may mean a mapped luma prediction block.

A value required for scaling may be derived by referring to a look-up table using the index of a piece to which the average of sample values of the luma prediction block belongs.

The residual block may be changed to an inversely mapped area by scaling the residual block using a finally derived value. Thereafter, for the block of a chroma component, reconstruction, intra prediction, inter prediction, in-loop filtering, and the storage of a reference picture may be performed in the inversely mapped area.

For example, information indicating whether the mapping and/or inverse mapping of a luma component and a chroma component are available may be signaled through a sequence parameter set.

A prediction block for the target block may be generated based on a block vector. The block vector may indicate displacement between the target block and a reference block. The reference block may be a block in a target image.

In this way, a prediction mode in which the prediction block is generated by referring to the target image may be referred to as an “Intra-Block Copy (IBC) mode”.

An IBC mode may be applied to a CU having a specific size. For example, the IBC mode may be applied to an M×N CU. Here, M and N may be less than or equal to 64.

The IBC mode may include a skip mode, a merge mode, an AMVP mode, etc. In the case of the skip mode or the merge mode, a merge candidate list may be configured, and a merge index is signaled, and thus a single merge candidate may be specified among merge candidates present in the merge candidate list. The block vector of the specified merge candidate may be used as the block vector of the target block.

In the case of the AMVP mode, a differential block vector may be signaled. Also, a prediction block vector may be derived from the left neighbor block and the above neighbor block of the target block. Further, an index indicating which neighbor block is to be used may be signaled.

A prediction block in the IBC mode may be included in a target CTU or a left CTU, and may be limited to a block within a previously reconstructed area. For example, the value of a block vector may be limited so that a prediction block for a target block is located in a specific area. The specific area may be an area defined by three 64×64 blocks that are encoded and/or decoded prior to a 64×64 block including the target block. The value of the block vector is limited in this way, and thus memory consumption and device complexity caused by the implementation of the IBC mode may be decreased.

FIG. 16 is a configuration diagram of an encoding apparatus according to an embodiment.

An encoding apparatus 1600 may correspond to the above-described encoding apparatus 100.

The encoding apparatus 1600 may include a processing unit 1610, memory 1630, a user interface (UI) input device 1650, a UI output device 1660, and storage 1640, which communicate with each other through a bus 1690. The encoding apparatus 1600 may further include a communication unit 1620 coupled to a network 1699.

The processing unit 1610 may be a Central Processing Unit (CPU) or a semiconductor device for executing processing instructions stored in the memory 1630 or the storage 1640. The processing unit 1610 may be at least one hardware processor.

The processing unit 1610 may generate and process signals, data or information that are input to the encoding apparatus 1600, are output from the encoding apparatus 1600, or are used in the encoding apparatus 1600, and may perform examination, comparison, determination, etc. related to the signals, data or information. In other words, in embodiments, the generation and processing of data or information and examination, comparison and determination related to data or information may be performed by the processing unit 1610.

The processing unit 1610 may include an inter-prediction unit 110, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180, and a reference picture buffer 190.

At least some of the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190 may be program modules, and may communicate with an external device or system. The program modules may be included in the encoding apparatus 1600 in the form of an operating system, an application program module, or other program modules.

The program modules may be physically stored in various types of well-known storage devices. Further, at least some of the program modules may also be stored in a remote storage device that is capable of communicating with the encoding apparatus 1200.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the encoding apparatus 1600.

The processing unit 1610 may execute instructions or code in the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190.

A storage unit may denote the memory 1630 and/or the storage 1640. Each of the memory 1630 and the storage 1640 may be any of various types of volatile or nonvolatile storage media. For example, the memory 1630 may include at least one of Read-Only Memory (ROM) 1631 and Random Access Memory (RAM) 1632.

The storage unit may store data or information used for the operation of the encoding apparatus 1600. In an embodiment, the data or information of the encoding apparatus 1600 may be stored in the storage unit.

For example, the storage unit may store pictures, blocks, lists, motion information, inter-prediction information, bitstreams, etc.

The encoding apparatus 1600 may be implemented in a computer system including a computer-readable storage medium.

The storage medium may store at least one module required for the operation of the encoding apparatus 1600. The memory 1630 may store at least one module, and may be configured such that the at least one module is executed by the processing unit 1610.

Functions related to communication of the data or information of the encoding apparatus 1600 may be performed through the communication unit 1620.

For example, the communication unit 1620 may transmit a bitstream to a decoding apparatus 1600, which will be described later.

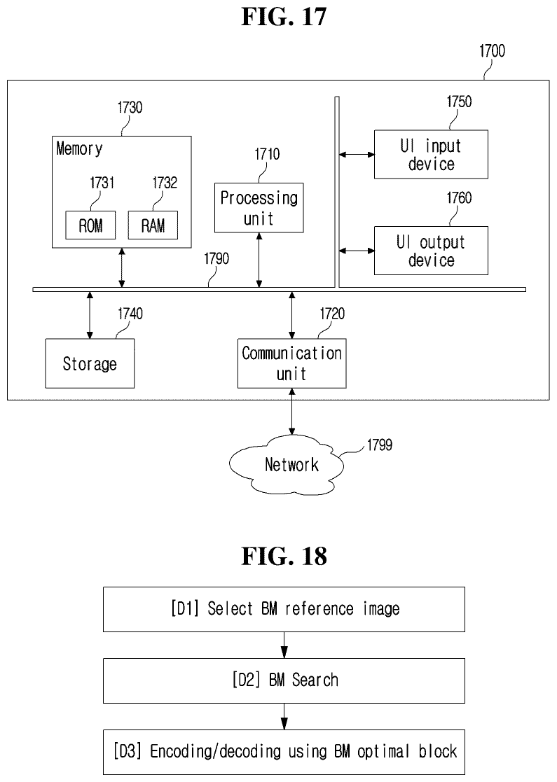

FIG. 17 is a configuration diagram of a decoding apparatus according to an embodiment.

The decoding apparatus 1700 may correspond to the above-described decoding apparatus 200.

The decoding apparatus 1700 may include a processing unit 1710, memory 1730, a user interface (UI) input device 1750, a UI output device 1760, and storage 1740, which communicate with each other through a bus 1790. The decoding apparatus 1700 may further include a communication unit 1720 coupled to a network 1799.

The processing unit 1710 may be a Central Processing Unit (CPU) or a semiconductor device for executing processing instructions stored in the memory 1730 or the storage 1740. The processing unit 1710 may be at least one hardware processor.

The processing unit 1710 may generate and process signals, data or information that are input to the decoding apparatus 1700, are output from the decoding apparatus 1700, or are used in the decoding apparatus 1700, and may perform examination, comparison, determination, etc. related to the signals, data or information. In other words, in embodiments, the generation and processing of data or information and examination, comparison and determination related to data or information may be performed by the processing unit 1710.

The processing unit 1710 may include an entropy decoding unit 210, a dequantization unit 220, an inverse transform unit 230, an intra-prediction unit 240, an inter-prediction unit 250, a switch 245, an adder 255, a filter unit 260, and a reference picture buffer 270.

At least some of the entropy decoding unit 210, the dequantization unit 220, the inverse transform unit 230, the intra-prediction unit 240, the inter-prediction unit 250, the adder 255, the switch 245, the filter unit 260, and the reference picture buffer 270 of the decoding apparatus 200 may be program modules, and may communicate with an external device or system. The program modules may be included in the decoding apparatus 1700 in the form of an operating system, an application program module, or other program modules.

The program modules may be physically stored in various types of well-known storage devices. Further, at least some of the program modules may also be stored in a remote storage device that is capable of communicating with the decoding apparatus 1700.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the decoding apparatus 1700.

The processing unit 1710 may execute instructions or code in the entropy decoding unit 210, the dequantization unit 220, the inverse transform unit 230, the intra-prediction unit 240, the inter-prediction unit 250, the switch 245, the adder 255, the filter unit 260, and the reference picture buffer 270.

A storage unit may denote the memory 1730 and/or the storage 1740. Each of the memory 1730 and the storage 1740 may be any of various types of volatile or nonvolatile storage media. For example, the memory 1730 may include at least one of ROM 1731 and RAM 1732.

The storage unit may store data or information used for the operation of the decoding apparatus 1700. In an embodiment, the data or information of the decoding apparatus 1700 may be stored in the storage unit.

For example, the storage unit may store pictures, blocks, lists, motion information, inter-prediction information, bitstreams, etc.

The decoding apparatus 1700 may be implemented in a computer system including a computer-readable storage medium.

The storage medium may store at least one module required for the operation of the decoding apparatus 1700. The memory 1730 may store at least one module, and may be configured such that the at least one module is executed by the processing unit 1710.

Functions related to communication of the data or information of the decoding apparatus 1700 may be performed through the communication unit 1720.

For example, the communication unit 1720 may receive a bitstream from the encoding apparatus 1700.

Hereinafter, a processing unit may represent the processing unit 1610 of the encoding apparatus 1600 and/or the processing unit 1710 of the decoding apparatus 1700. For example, as to functions relating to prediction, the processing unit may represent the switch 115 and/or the switch 245. As to functions relating to inter prediction, the processing unit may represent the inter-prediction unit 110, the subtractor 125 and the adder 175, and may represent the inter prediction unit 250 and the adder 255. As to functions relating to intra prediction, the processing unit may represent the intra prediction unit 120, the subtractor 125, and the adder 175, and may represent the intra prediction unit 240 and the adder 255. As to functions related to transform, the processing unit may represent the transform unit 130 and the inverse transform unit 170, and may represent the inverse transform unit 230. As to functions relating quantization, the processing unit may represent the quantization unit 140 and the inverse quantization unit 160, and may indicate the inverse quantization unit 220. As to functions relating to entropy encoding and/or entropy decoding, the processing unit may represent the entropy encoding unit 150 and/or the entropy decoding unit 210. As to functions relating filtering, the processing unit may represent the filter unit 180 and/or the filter unit 260. As to functions relating a reference picture, the processing unit may indicate the reference picture buffer 190 and/or the reference picture buffer 270.

Based on the above-described description, a prediction method based on Bilateral Matching (BM) according to the present disclosure will be described in detail. The definition of terms used in embodiments included in the present disclosure is as follows.

Target Block: A block to be currently encoded/decoded. It may be referred to as a current block.

Target Image: An image to which a block to be currently encoded/decoded belongs. It may be referred to as a current image.

BM Reference Image List: A list of reference images used in BM-based encoding/decoding

BM Reference Image List 0 (or First BM Reference Image List): A list of reference images used in prediction using BM of a P slice or a first list of two reference image lists used in prediction using BM of a B slice

BM Reference Image List 1 (or Second BM Reference Image List): A second list of two reference image lists used in prediction using BM of a B slice

BM Search Region: A region searched to find a BM reference block

BM Reference Block: A block with the highest correlation with a target block in a BM reference image. It may refer to a block in which a pair of a first BM candidate reference block and a second candidate reference block are most similar to each other.

First BM Reference Block: A BM reference block in a first BM reference image

Second BM Reference Block: A BM reference block in a second BM reference image

BM Motion Vector: A motion difference between a BM reference block and a target block

BM Optimal Block: A value calculated by the weighted combination or the weighted summation of a first BM reference block and a second BM reference block It may refer to the prediction signal of BM for a target block.

BM-based Encoding Method Information: It includes at least one of the syntax elements proposed in the present invention.

In the above-described definition, a term prefixed with ‘first’ may be information about any one direction of L0 or L1 and a term prefixed with ‘second’ may be information about the other direction. Alternatively, at least one of the terms prefixed with ‘first’ or ‘second’ may refer to a target image to which a target block belongs or information within a target image.

BM according to the present disclosure may be one of the prediction methods used to obtain the prediction block of a current block. Hereinafter, a prediction method based on BM will be described in detail.

FIG. 18 is a flowchart of a method for obtaining a prediction block based on a BM method according to an embodiment of the present disclosure.

A BM method may be performed by omitting at least one of the steps [D1] to [D3] shown in FIG. 18. Alternatively, whether to perform at least one of the steps [D1] to [D3] may be determined based on at least one of an encoding parameter, picture information, slice information, tile information, a quantization parameter (QP), an encoding block flag (CBF), a block size, a block depth, a block shape, an entropy encoding method, a block size, a block shape (square, rectangle) or a temporal layer level. In this case, a block may be at least one of an encoding tree block, an encoding block, a prediction block, a transform block or a block in a predetermined size.

A prediction method based on a BM method shown in FIG. 18 may be used to obtain the prediction block of a current block when encoding/decoding a current block.

### [D1] a Step of Selecting a BM Reference Image

In order to perform prediction based on a BM method, a BM reference image may be selected from a BM reference image list. In this case, ‘BM Reference Image’ indicates a reference image used for prediction using BM. A BM reference image may be implicitly or explicitly selected.

In addition, ‘BM Reference Image List’ represents the list of reference images used for prediction using BM. A BM reference image list may be indicate like bm_ref_pic_list′.

For each of a L0 direction and a L1 direction, a BM reference image list may be configured. In this case, one of a L0 BM reference image list and a L1 reference image list may be referred to as BM reference image list 0. In other words, a first list of the two reference image lists used in prediction using the BM of a P slice or in prediction using the BM of a B slice may be referred to as ‘BM reference image list 0 (bm_ref_pic_lists [0])’.

BM reference image list 0 may include at least one of a target image, a decoded temporal past image or a decoded temporal future image.

Furthermore, the other of a L0 BM reference image list and a L1 reference image list may be referred to as BM reference image list 1. In other words, a second list of the two reference image lists used in prediction using the BM of a B slice may be referred to as ‘BM reference image list 1 (bm_ref_pic_lists [1])’.

BM reference picture list 1 may include at least one of a target image, a decoded temporal past image or a decoded temporal future image.

Meanwhile, after determining whether to perform prediction based on a BM method on a target block, when it is determined that the prediction based on a BM method is not performed, whether to perform general inter prediction on a target block may be determined.

In this case, a BM reference image list may be generated separately from a reference image list for general inter prediction. As an example, when prediction based on a BM method is performed, a BM reference image list may be used to select a BM reference picture, whereas when general inter prediction is performed, a general reference image list may be used to select a reference image.

Alternatively, when inter prediction is applied to a target block, whether prediction based on a BM method is performed on a target block may be determined. In this case, a BM reference image list may be set to be the same as a reference picture list for performing inter prediction.

As another example,
an image used for BM prediction for a target block among the images belonging to BM reference image list 0 may be referred to as ‘a first BM reference image’. In addition, an image used for BM prediction for a target block among the images belonging to BM reference image list 1 may be referred to as ‘a second BM reference image’.

In order to perform prediction based on a BM method, at least one BM reference image may be selected. As an example, a prediction block of a target block may be derived by using one BM reference image or a prediction block of a target block may be derived by using a first BM reference image and a second BM reference image.

Meanwhile, an index identifying each reference image belonging to a BM reference image list may be referred to as a BM reference index (bm_ref_idx). In this case, the BM reference index of a first BM reference image may be referred to as bm_ref_idx_l0, and the BM reference index of a second BM reference image may be referred to as bm_ref_idx_l1.

A BM reference index for identifying a BM reference image used for prediction of a target block among the BM reference images belonging to a BM reference image list may be explicitly encoded and signaled. In other words, for a target block, at least one of bm_ref_idx_l0 and bm_ref_idx_l1 may be encoded and signaled.

A first BM reference index (i.e., bm_ref_idx_l0) for identifying a first BM reference image and a second BM reference index (i.e., bm_ref_idx_l1) for identifying a second BM reference image may be encoded and signaled, respectively.

Alternatively, only a first BM reference index for a first BM reference image may be signaled, and signaling of a second BM reference index for selecting a second BM reference image may be omitted. In this case, a BM reference image whose temporal direction is opposite to that of a first BM reference image and whose distance from a target image is the same as that of a first BM reference image may be set as a second BM reference image.

As another example, a BM reference image may be selected based on a reference index (a general reference index) used for general inter prediction. As an example, a BM reference index may be derived as the same value as a general reference index that identifies one of the reference images. In other words, bm_ref_idx_l0 may be derived as the same value as ref_idx_l0 that identifies one of the reference images included in a L0 reference image list, and bm_ref_idx_l1 may be derived as the same value as ref_idx_l1 that identifies one of the reference images included in a L1 reference image list.

When a BM reference image list is distinguished from a general reference image list, a BM reference index may be encoded/decoded. On the other hand, when a general reference image list is used as a BM reference image list, a general reference index may be encoded/decoded and a BM reference index may be derived as the same value as a general reference index.

Accordingly, a reference image for general inter prediction may be set as a BM reference image. As an example, when the first reference image of a first reference image list and the second reference image of a second reference image list are selected for performing the inter prediction of a target block, a first reference image and a second reference image may be set as a first BM reference image and a second BM reference image, respectively.

As another example, a first BM reference image may be derived as an image that is temporally earlier than a target image among the decoded images and a second BM reference image may be derived as an image that is temporally later than a target image among the decoded images. Here, a past image represents a reference image having a Picture Order Count (POC) smaller than a target image and a future image represents a reference image having a POC larger than a target image. As an example, a first BM reference image may be derived as a reference image that is temporally immediately preceding a target image or a reference image with the smallest POC difference from a target image among the reference images with a POC smaller than a target. A second BM reference image may be derived as a reference image that is temporally immediately following a target image or a reference image with the smallest POC difference from a target image among the reference images with a POC greater than a target.

As another example, a target image may be set as a BM reference image. In other words, at least one of a first BM reference image or a second BM reference image may be a target image.

Meanwhile, a BM reference image may be determined by the prediction mode of a target block. Here, a prediction mode may be at least one of intra prediction, IBC prediction or inter prediction. As an example, when the prediction mode of a target block is intra prediction, a target image may be selected as a BM reference image.

Alternatively, when the prediction mode of a target block is IBC prediction, a target image may be selected as a BM reference image.

Alternatively, when the prediction mode of a target block is inter prediction, at least one of a first BM reference image or a second BM reference image may be selected from reference images decoded before a target image.

As another example, a BM reference image may be determined by the type (slice_type) of a slice to which a target image belongs. As an example, when a slice to which a target block belongs is an I type, a target image may be set as a BM reference image.

Alternatively, when a slice to which a target block belongs is a B type, at least one of a first BM reference image or a second BM reference image may be selected from reference images decoded before a target image.

As another example, an encoder/a decoder may adaptively select/derive a BM reference image based on at least one of the coding parameters.

Let's assume that there are P(t) which is a target image at a time of t, decoded past reference images (e.g., P(t−n₁), P(t−n₂), P(t−n₃)) and decoded future reference images (e.g., P(t+n₄), P(t+n₅), P(t+n₆)). In this case, nₓ represents a POC difference from a target image, which may be a predetermined positive integer. As an example, nₓ may be as follows.

$${n}_{1} = 1 , {n}_{2} = 2 , {n}_{3} = 3 , {n}_{4} = 1 , {n}_{5} = 2 , {n}_{6} = 3$$

In the case, a BM reference image list, bm_ref_pic_list, may be configured as follows.

$$bm\_ref \_pic \_list = \{ P ( t ) , P ( t - {n}_{1} ) , P ( t + {n}_{4} ) , P ( t + {n}_{6} ) \}$$

Table 7 shows the configuration of a BM reference image list in a table.

TABLE 7

| bm_ref_idx | BM Reference Image |
|---|---|
| 0 | P(t) |
| 1 | P(t − n₁) |
| 2 | P(t + n₄) |
| 3 | P(t − n₂) |
| 4 | P(t + n₆) |

Alternatively, when there are P(t) which is a target image at a time of t, decoded past images (P(t−n₁), P(t−n₂), P(t−n₃)) and decoded future images (P(t+n₄), P(t+n₅), P(t+n₆)), a BM reference image list, bm_ref_pic_list, may be configured as follows.

$$bm\_ref \_pic \_list = \{ P ( t - {n}_{1} ) , P ( t + {n}_{4} ) , P ( t - {n}_{2} ) , P ( t + {n}_{6} ) \}$$

Table 8 shows the configuration of a BM reference image list in a table.

TABLE 8

| bm_ref_idx | BM Reference Image |
|---|---|
| 0 | P(t − n₁) |
| 1 | P(t + n₄) |
| 2 | P(t − n₂) |
| 3 | P(t + n₆) |

In examples of Table 7 and Table 8, bm_ref_idx represents an index that identifies a BM reference image included in a BM reference image list. Meanwhile, bm_ref_idx indicating the BM reference image of a target block may be encoded and signaled.

Alternatively, when there are P(t) which is a target image at a time of t, decoded past images (P(t−n₁), P(t−n₂), P(t−n₃)) and decoded future images (P(t+n₄), P(t+n₅), P(t+n₆)), BM reference image list 0 (i.e., bm_ref_pic_lists[0]) and BM reference image list 1 (i.e., bm_ref_pic_lists[1]) may be configured as follows.

$$bm\_ref \_ 10 = \{ P ( t ) , P ( t - {n}_{1} ) , P ( t - {n}_{2} ) , P ( t - {n}_{3} ) \}$$

$$bm\_ref \_ 11 = \{ P ( t + {n}_{4} ) , P ( t + {n}_{5} ) , P ( t + {n}_{6} ) , P ( t - {n}_{1} ) \}$$

Table 9 and Table 10 represent the configuration of BM reference image list 0 and BM reference image list 1 in a table.

TABLE 9

| bm_ref_idx_l0 | BM Reference Image |
|---|---|
| 0 | P(t) |
| 1 | P(t − n₁) |
| 2 | P(t − n₂) |
| 3 | P(t − n₃) |

TABLE 10

| bm_ref_idx_l1 | BM Reference Image |
|---|---|
| 0 | P(t + n₄) |
| 1 | P(t + n₅) |
| 2 | P(t + n₆) |
| 3 | P(t − n₁) |

Alternatively, when there are P(t) which is a target image at a time of t, decoded past images (P(t−n₁), P(t−n₂), P(t−n₃)) and decoded future images (P(t+n₄), P(t+n₅), P(t+n₆)), BM reference image list 0 (i.e., bm_ref_pic_lists[0]) and BM reference image list 1 (i.e., bm_ref_pic_lists[1]) may be configured as follows.

$$bm\_ref \_l0 = \{ P ( t - {n}_{1} ) , P ( t - {n}_{2} ) , P ( t - {n}_{3} ) , P ( t + {n}_{4} ) \}$$

$$bm\_ref \_l1 = \{ P ( t + {n}_{4} ) , P ( t + {n}_{5} ) , P ( t + {n}_{6} ) , P ( t - {n}_{1} ) \}$$

Table 11 and Table 12 represent the configuration of BM reference image list 0 and BM reference image list 1 in a table.

TABLE 11

| bm_ref_idx_l0 | BM Reference Image |
|---|---|
| 0 | P(t − n₁) |
| 1 | P(t − n₂) |
| 2 | P(t − n₃) |
| 3 | P(t + n₄) |

TABLE 12

| bm_ref_idx_l1 | BM Reference Image |
|---|---|
| 0 | P(t + n₄) |
| 1 | P(t + n₅) |
| 2 | P(t + n₆) |
| 3 | P(t − n₁) |

In examples of Tables 9 to 12, bm_ref_idx_l0 represents an index that identifies a BM reference picture included in BM reference picture list 0 and bm_ref_idx_l1 represents an index that identifies a BM reference picture included in BM reference picture list 1. Meanwhile, at least one of bm_ref_idx_l0 or bm_ref_idx_l1 indicating the BM reference image of a target block may be encoded and signaled.

### [D2] a Step of Searching BM

A BM reference block in a BM reference image may be searched. Specifically, a reference block having the highest correlation with a target block, i.e., a BM reference block, may be searched from a BM reference image.

Based on a pair with the highest similarity among the pairs of a first BM candidate reference block included in a first BM reference image and a second BM candidate reference block included in a second BM reference image, a first BM reference block and a second BM reference block may be derived. Here, a pair with the highest similarity may refer to a pair with the lowest matching criteria.

Meanwhile, in the search process of a BM reference block, at least one of encoding information of a target block, BM-based encoding method information, matching criteria, an initial motion vector for BM search, an initial motion vector acquisition method, BM search region information, a first BM reference image, a second BM reference image, an early termination condition for BM search or a BM search method may be used.

A BM search region may include a position indicated by an initial motion vector for BM search and a neighboring region at the position.

A reference block may be searched by symmetrically applying a MV offset to a first initial motion vector MV0 for a first BM reference image and a second initial motion vector for a second BM reference image. In other words, a correspondence relationship in the following Equation 1 may be established between MV0′, the position of a first BM candidate reference block in a first BM reference image, and MV1′, the position of a second BM candidate reference block in a second BM reference image.

$$MV {0}^{′} = MV 0 + MV\_offset \qquad [ Equation 1 ]$$

$$MV {1}^{′} = MV 1 - MV\_offset$$

In the Equation 1, MV_offset may represent a MV offset. As an example, the range of MV_offset values may be {−2, −1, 0, 1, 2}.

The maximum value of MV_offset may be predefined in an encoder and a decoder. Alternatively, information showing the maximum value of MV_offset may be encoded and signaled or the maximum value of MV_offset may be adaptively set based on the POC of a first BM reference image and a second reference image. Here, the maximum value of MV_offset may represent the size of a BM search region.

The search process of a BM reference block in a BM search region may include searching an integer sample offset and adjusting a decimal sample.

In a step of searching an integer sample offset, matching criteria between a first reference block indicated by a first initial motion vector MV0 in a first BM reference picture and a second reference block indicated by a second initial motion vector MV1 in a second BM reference picture is calculated. Here, matching criteria are a value calculated by a cost function, and as an example, it may be the Sum of Absolute Difference (SAD) between a first reference block and a second reference block.

When a matching criteria value between a first reference block and a second reference block is less than a threshold, a step of searching an integer sample offset may be terminated early. When a step of searching an integer sample offset is terminated early, a first initial motion vector MV0 and a second initial motion vector MV1 may be set as a first final motion vector and a second final motion vector, respectively.

When a matching criteria value between a first reference block and a second reference block is equal to or greater than a threshold, a first integer motion vector MV0′ and a second integer motion vector MV1′ indicating the pair of reference blocks with the smallest matching criteria are searched while changing a MV_offset value. A first integer motion vector MV0′ and a second integer motion vector MV1′ indicating the pair of reference blocks with the smallest matching criteria may be referred to as an integer motion vector pair. An integer motion vector pair may be indicated as (MV0_int, MV1_int).

Next, a step of adjusting a decimal sample may be performed.

In a step of adjusting a decimal sample, a correlation in a decimal sample unit is searched based on an integer motion vector pair derived from a step of searching an integer sample offset. In other words, an integer motion vector used to derive the minimum matching criteria in a step of searching an integer sample offset is set as a center point and matching criteria at a decimal sample position around a center point are calculated. As an example, when an integer motion vector pair used to derive the minimum matching criteria is (MV0_int, MV1_int), MV0_int is a center point in a first BM reference image and MV1_int is a center point in a second BM reference image.

Meanwhile, a decimal sample position may be calculated by using a correlation position at a center point position in a BM reference image and a matching criteria value at an integer position around the center point. As an example, a decimal sample position (xⁱₘᵢₙ, yⁱₘᵢₙ) may be calculated as in Equation 2 below.

$${x}_{min}^{i} = ( {E}_{i} ( - 1 , 0 ) - {E}_{i} ( 1 , 0 ) ) / ( 2 ( {E}_{i} ( - 1 , 0 ) + {E}_{i} ( 1 , 0 ) - 2 {E}_{i} ( 0 , 0 ) ) ) \qquad [ Equation 2 ]$$

$${y}_{min}^{i} = ( {E}_{i} ( 0 , - 1 ) - {E}_{i} ( 0 , 1 ) ) / ( 2 ( {E}_{i} ( 0 , - 1 ) + {E}_{i} ( 0 , 1 ) - 2 {E}_{i} ( 0 , 0 ) ) )$$

In Equation 2, Eᵢ(0, 0) represents a matching criteria value at the center point of a (i+1)-th BM reference image. i may have a value of 0 or 1. In other words, for each of a first BM reference picture and a second BM reference picture, a decimal sample position may be determined.

Eᵢ(−1,0) and Eᵢ(1,0) represent a matching criteria value at the left integer position and the right integer position of the center point, respectively. In addition, Eᵢ(0, −1) and Eᵢ(0,1) represent a matching criteria value at the top integer position and the bottom integer position of the center point, respectively.

As shown in Equation 2, a horizontal decimal position xⁱₘᵢₙ may be calculated by using the matching criteria of the center point and matching criteria at integer positions neighboring the left and right of the center point. In addition, a vertical decimal position yⁱₘᵢₙ may be calculated by using the matching criteria of the center point and matching criteria at integer positions neighboring the bottom and top of the center point.

When a decimal sample position (xⁱₘᵢₙ, yⁱₘᵢₙ) is derived, a final motion vector may be calculated by adding a decimal sample position to an integer sample position. As an example, a first final motion vector may be derived by adding a first decimal motion vector (x⁰ₘᵢₙ, y⁰ₘᵢₙ) to a first integer motion vector MV0_int and a second final motion vector may be derived by adding a second decimal motion vector (x¹ₘᵢₙ, y¹ₘᵢₙ) to a second integer motion vector MV1_int. Meanwhile, a derived final motion vector may be referred to as a BM motion vector. A block indicated by a BM motion vector may be set as a BM reference block.

Meanwhile, a step of adjusting a decimal sample may be selectively performed. As an example, when the minimum matching criteria derived from a step of searching an integer sample offset is smaller than a threshold value, a step of adjusting a decimal sample may not be performed. In this case, an integer motion vector used to derive the smallest matching criteria in a step of searching an integer sample offset may be set as a BM motion vector.

Meanwhile, a first BM reference image and a second BM reference image may be selected from a first BM reference image list and a second BM reference image list, respectively.

In this case, a first BM reference image and a second BM reference image may be identical to each other. In other words, one reference image may be used as a first BM reference image and a second BM reference image.

Alternatively, at least one of a first BM reference image or a second BM reference image may be a target image.

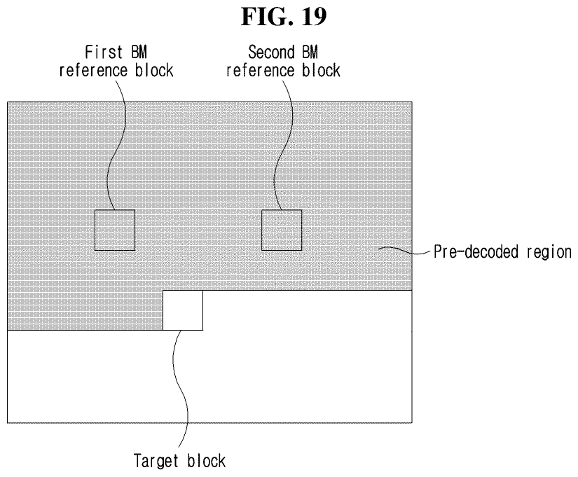

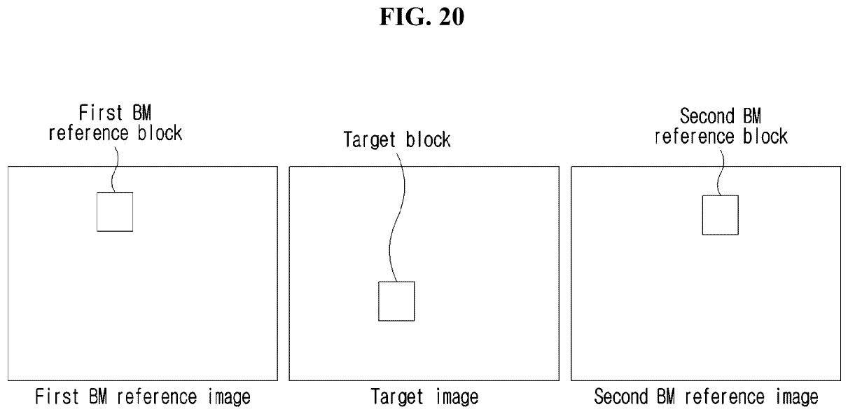

FIGS. 19 and 20 show an example in which a BM reference block is determined by using a BM reference image.

FIG. 19 shows an example in which a first BM reference image and a second BM reference image are the same as a target image.

When a target image is set as a BM reference image, as in an example shown in FIG. 19, when a BM reference image is a target image, a first BM reference block and a second BM reference block having the best correlation with a target block may be searched within a target image.

FIG. 20 shows an example in which a first BM reference image and a second BM reference image have a POC different from a target image, respectively.

When each of a first BM reference image and a second BM reference image are different from a target image, as in an example shown in FIG. 20, a first BM reference block may be derived from a first BM reference image and a second BM reference block may be derived from a second BM reference image.

As described above, a first BM reference image may be a target image, a decoded temporal past image or a decoded temporal future image. In addition, a second BM reference image may be a target image, a decoded temporal past image or a decoded temporal future image.

A BM motion vector represents a position difference between a target block and a BM reference block.

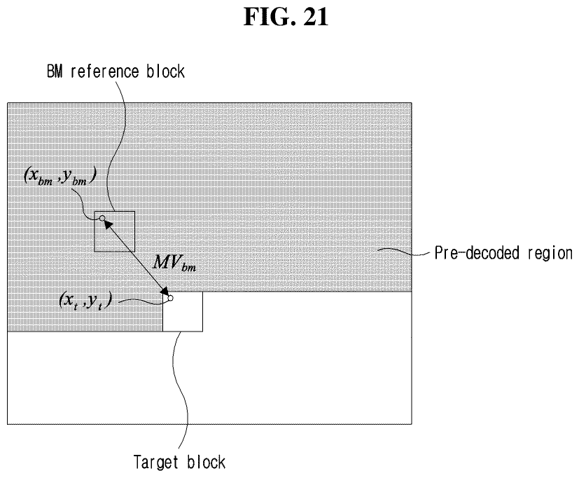

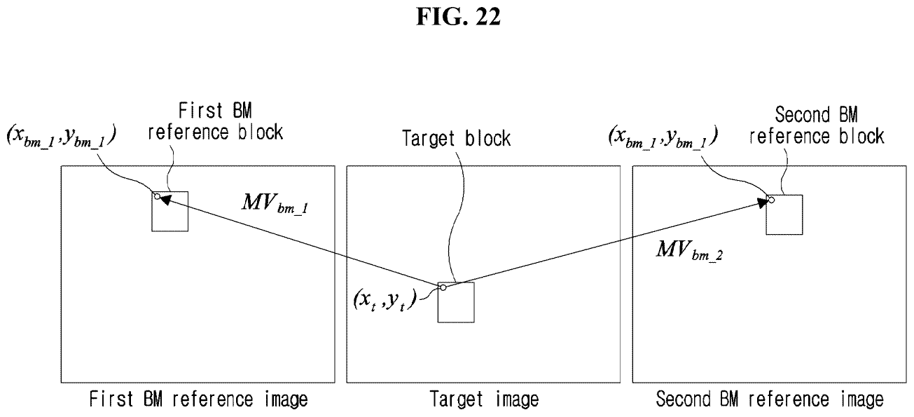

FIGS. 21 and 22 show a BM motion vector derived through BM search.

FIG. 21 illustrates a case where a BM reference image is a target image. When the top-left pixel position of a target block is (xₜ, yₜ) and the top-left pixel position of a BM reference block is (x_{bm}, y_{bm}), a BM motion vector MV_{bm} may be (x_{bm}−xₜ, y_{bm}−yₜ).

FIG. 22 is an example of a case where a first BM reference image and a second BM reference image are different from a target image.

When the top-left pixel position of a target block is (xₜ, yₜ) and the top-left pixel position of a first BM reference block is (x_{bm_1}, y_{bm_1}), a first BM motion vector MV_{bm_1} may be (x_{bm_1}−xₜ, y_{bm_1}−yₜ).

In addition, when the top-left pixel position of a second BM reference block is (x_{bm_2}, y_{bm_2}), a second BM motion vector MV_{bm_2} may be (x_{bm_2}−xₜ, y_{bm_2}−yₜ).

The BM optimal block of a target block may be obtained by using at least one of a first BM reference block indicated by a first BM motion vector or a second BM reference block indicated by a second BM motion vector.

As an example, a BM optimal block may be obtained by the weighted combination operation or weighted summation operation of a first BM reference block and a second BM reference block.

As an example, as in Equation 3 below, a pixel P_{BM}(x, y) at a position of (x, y) within a target block may be obtained based on the average or weighted summation operation of a pixel within a first BM reference block indicated by a first BM motion vector within a first BM reference image and a pixel within a second BM reference block indicated by a second BM motion vector within a second BM reference image.

$${P}_{BM} ( x , y ) = ( P 0 ( x + {x}_{BM}^{0} , y + {y}_{BM}^{0} ) + P 1 ( x + {x}_{BM}^{1} , y + {y}_{BM}^{1} ) + offset ) ≫ shift \qquad [ Equation 3 ]$$

In Equation 3 above, P_{BM}(x, y) represents a pixel value at position of (x, y) within a BM optimal block. P0(a,b) represents a pixel value at a position of (a, b) within a first BM reference block and P₁(a,b) represents a value at a position of (a, b) within a second BM reference block. xⁱ_{BM} represents the horizontal component of a (i+1)-th BM motion vector and yiBM represents the vertical component of a (i+1)-th BM motion vector. Here, i may be 0 or 1.

shift represents a shifting parameter for calculating an average.

shift may have a value predefined in an encoder and a decoder. As an example, shift may be 1.

Alternatively, shift may be determined based on at least one of Internal Bit Depth (IBD) or Sample Bit Depth (bitDepth).

Alternatively, shift may be determined as in Max(3, (1+IBD)−bitDepth). Here, a function MAX(a, b) is a function that returns a larger value of a and b. When IBD is 14 and bitDepth is 10, shift may be set as 5. Alternatively, when IBD is 14 and bitDepth is 8, shift may be set as 7.

In Equation 3, offset represents an offset parameter for rounding. Offset may be determined based on at least one of Internal Bit Depth (IBD) or Sample Bit Depth (bitDepth).

As an example, offset may be set as the median value of a N-bit image. In other words, for a 10-bit image, it may be set as 512 and for a 8-bit image, offset may be set as 128.

As another example, offset may be derived as in (1<< (shift−1)).

It is also possible to derive a pixel within a BM optimal block without performing a rounding operation. When a rounding operation is set not to be performed, an offset parameter offset may have a value of 0 in Equation 3 above.

Meanwhile, a BM optimal block (or, a BM optimal signal) may refer to a prediction block (or a prediction signal) for a target block. In other words, a sample at a position of (x, y) within a BM optimal block may represent a prediction sample at a position of (x, y) within a target block.

Meanwhile, a BM reference block may be searched only within a BM search region within a BM reference image. Here, a BM search region may represent the entire or partial region of a BM reference image. As an example, a BM search region may include a position indicated by an initial motion vector and a neighboring region thereof.

The start position of search, i.e., a BM search start position, may be a position indicated by an initial motion vector. In other words, after calculating matching criteria for a position indicated by an initial motion vector, matching criteria may be calculated for a modified position while changing MV_offset.

Alternatively, the position of a target block within a BM reference image may be set as a BM search start position.

The size of a BM search region may be adaptively determined according to the size of a target block. As an example, a BM search region may be a region corresponding to N times the size of a target block. In this case, the maximum size of a BM search region may be predefined in an encoder and a decoder. As an example, the maximum value of a distance from a position indicated by an initial motion vector to one boundary of a BM search region may have a value of 2, 4, 8 or 16.

Alternatively, a BM search region may be set as a region corresponding to a predetermined number of blocks. In other words, the remaining regions excluding a region corresponding to a predetermined number of blocks within a BM reference region may not be included in a BM search region. A predetermined number may be a natural number greater than or equal to 1.

As an example, a BM search region may be a region corresponding to a predetermined number of blocks existing around a target block. A block existing around a target block may include at least one of a block adjacent to a target block or a block not adjacent to a target block but having a distance from a target block less than or equal to a threshold value.

Here, a block unit configuring a BM search region may be at least one of an encoding tree block, an encoding block, a prediction block, a transform block, a virtual pipeline data unit (VPDU) or a block in a predetermined size.

As an example, a BM search region may be composed of a plurality of spatially continuous blocks.

Alternatively, a BM search region may be composed of a plurality of blocks existing at a spatially separated position.

Meanwhile, the size and/or shape of a plurality of blocks configuring a BM search region may be the same. Alternatively, a plurality of blocks configuring a BM search region may have a different size and/or shape.

As another example, the smallest square region including a plurality of blocks may be set as a BM search region.

Alternatively, a BM search region may be set by considering the size of a VPDU. As an example, a BM search region may be composed of N VPDU regions around a target block within a BM reference image. Alternatively, a BM search region may be composed of N VPDU regions around a position indicated by an initial motion vector within a BM reference image. Alternatively, a BM search region may be composed of a target VPDU region to which a target block belongs and (N−1) encoding tree regions around a target VPDU region.

In other words, the remaining regions excluding N VPDU regions within a BM reference image may not be a BM search region. Accordingly, a BM reference block may not be searched in the remaining regions excluding N VPDU regions. Meanwhile, N may be a natural number such as 1, 2, 3 or 4.

Alternatively, a BM search region may be set by considering the size of an encoding tree block. As an example, a BM search region may be composed of N encoding tree block regions around a target block within a BM reference image. Alternatively, a BM search region may be composed of N encoding tree block regions around a position indicated by an initial motion vector within a BM reference image. Alternatively, a BM search region may be composed of a target encoding tree block to which a target block belongs and (N−1) encoding tree regions around a target encoding tree block.

In other words, the remaining regions excluding N encoding tree block regions within a BM reference image may not be a BM research region. Accordingly, a BM reference block may not be searched in the remaining regions excluding N encoding tree block regions. Meanwhile, N may be a natural number such as 1, 2, 3 or 4.

A BM search region may be a square region, e.g., a rectangle or a rhombus. In this case, the size of a BM search region in a rectangular shape may be defined by horizontal and vertical sizes. In addition, the size of a BM search region in a rhombus shape may be defined by the size of two diagonals.

The size of a BM search region may also be defined by horizontal and vertical distances from a BM search start position. Here, a BM search start position may be the initial motion vector of BM search.

Meanwhile, a non-decoded region in a BM reference image may be set not to be included in a BM search region. As an example, when at least a part of a target block is included in the smallest square region including a plurality of blocks, a region excluding a region occupied by a target block in the square region may be set as a BM search region.

When at least a part of a region to be set as a BM search region is beyond an image boundary, the remaining regions excluding a region beyond an image boundary may be set as a BM search region. Alternatively, when at least a part of a region to be set as a BM search region is beyond an image boundary, a region beyond an image boundary may be replaced with a region corresponding to a region beyond an image boundary on the opposite boundary of the image boundary.

At least one of the shape or size of a BM search region may be encoded and signaled through a high level syntax such as an encoding parameter, a sequence parameter, an image parameter or a slice header, etc. or may be encoded and signaled through a coding tree unit or a predetermined block unit. Here, a predetermined block unit may be a coding block, a transform block or a prediction block.

Alternatively, the size and/or shape of a BM search region may be adaptively determined based on at least one of whether a BM reference image is a target image, a distance between a target block and a position indicated by an initial motion vector or the size/shape of a target block.

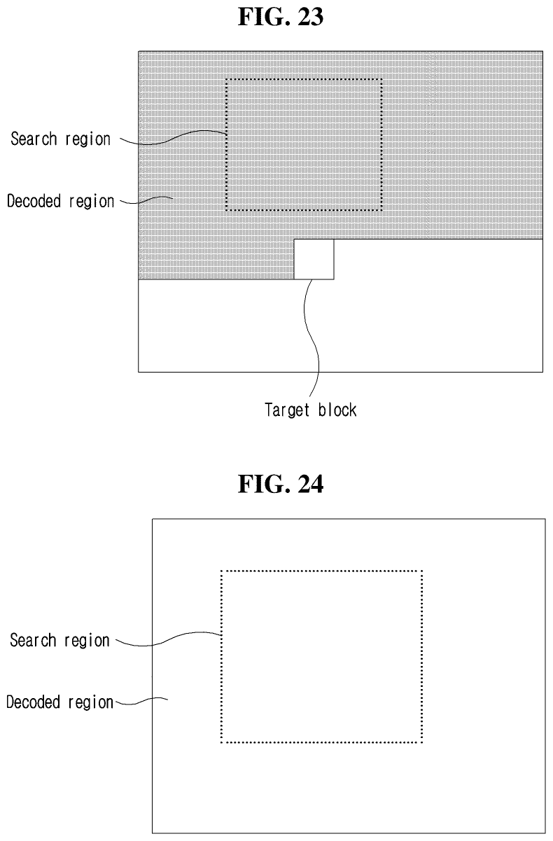

FIGS. 23 to 34 shows an example related to a BM search region.

FIGS. 23 to 28 represents an example in which a BM search region is a rectangle.

In FIG. 23, it is illustrated that a target image is set as a BM reference image. In this case, a BM search region may be a rectangle.

In FIG. 23, a BM search region may be all or part of a decoded region in a target image.

In FIG. 24, it is illustrated that a reference image different from a target image, i.e., a reference image with a different POC from a target image, is set as a BM reference image. As in an example shown in FIG. 24, when a BM reference image is a decoded past image or future image, a BM search region may be a rectangle.

In FIG. 24, a BM search region may be all or part of an image in a BM reference image.

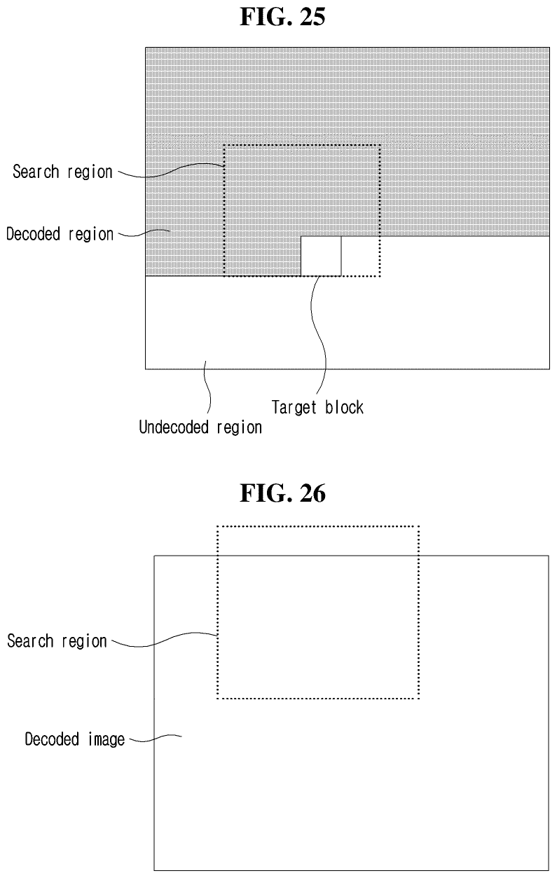

In FIG. 25, it is illustrated that a target image is set as a BM reference image. As in an example shown in FIG. 25, when a region to be set as a BM search region includes a non-decoded region such as a target block, the remaining regions excluding a non-decoded region may be set as a BM search region.

In FIG. 26, it is illustrated that a reference image different from a target image, i.e., a reference image with a different POC from a target image, is set as a BM reference image. As in an example shown in FIG. 26, when a region to be set as a BM search region exists outside an image boundary, the remaining regions excluding a region outside an image boundary may be set as a BM search region.

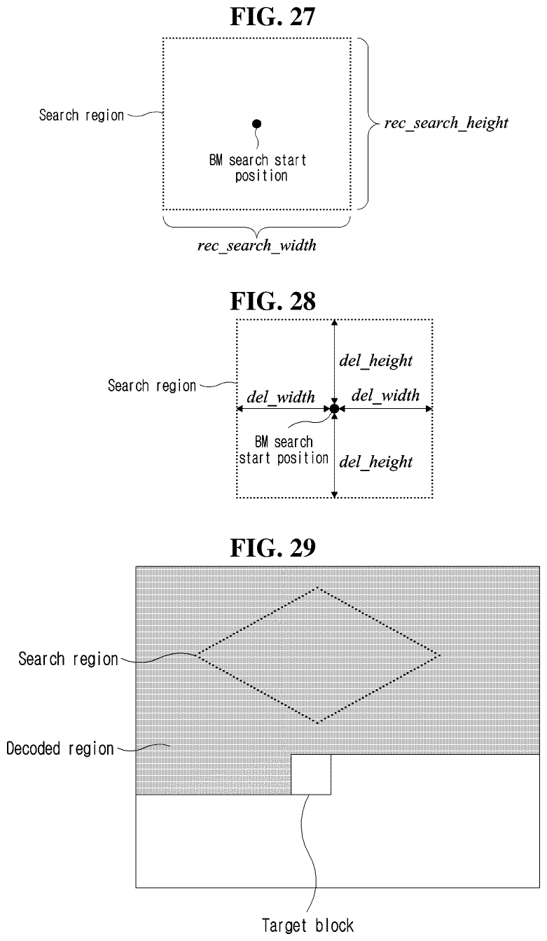

FIGS. 27 and 28 show information elements for determining a rectangular BM search region.

As in an example shown in FIG. 27, the size of a rectangular BM search region may be defined by a width (rec_search_width) and a height (rec_search_height). At least one of a variable rec_search_width representing a horizontal value and a variable rec_search_height representing a vertical value may be encoded and signaled through a high level syntax such as an encoding parameter, a sequence parameter, an image parameter or a slice header, etc. or may be encoded and signaled in at least one of a coding tree unit or a predetermined block unit. Here, a predetermined block unit may be a coding block, a transform block or a prediction block.

Meanwhile, a BM search region may have a square shape whose width is the same as a height. In this case, only a width rec_search_width may be encoded and signaled or only a height rec_search_height may be encoded and signaled.

Alternatively, the ratio of the width and height of a BM search region may be fixed in an encoder and a decoder. As an example, a width may be twice a height. In this case, only a height rec_search_height may be encoded and signaled and a width may be derived based on a height. Alternatively, only a width rec_search_width may be encoded and signaled and a height may be derived based on a width.

As in an example shown in FIG. 28, the size of a rectangular BM search region may be defined by a horizontal size (del_width) and a vertical size (del_height) from a BM search start position. Here, a horizontal size del_width may represent a distance from a BM search start position to the left or right boundary of a BM search region, and a vertical size del_height may represent a distance from a BM search start position to the top or bottom boundary of a BM search region. A BM search region size may be (1+2*del_width)×(1+2*del_height). At least one of a horizontal size del_width or a vertical size del_height may be encoded and signaled through a high level syntax such as an encoding parameter, a sequence parameter, an image parameter or a slice header, etc. or may be encoded and signaled in at least one of a coding tree unit or a predetermined block unit.

A BM search region may have a square shape whose width is the same as a height. In this case, only a horizontal length del_width or a vertical length del_height may be encoded and signaled.

Alternatively, the ratio of the width and height of a BM search region may be fixed in an encoder and a decoder. As an example, a width may be twice a height. In this case, only a vertical length del_height may be encoded and signaled and a horizontal length may be derived based on a vertical length. Alternatively, only a horizontal length del_width may be encoded and signaled and a vertical length may be derived based on a horizontal length.

FIGS. 29 to 34 show an example of a case where a BM search region is a rhombus.

In FIG. 29, it is illustrated that a target image is set as a BM reference image. In this case, a BM search region may be a rhombus.

In FIG. 29, a BM search region may be all or part of a decoded region in a target image.

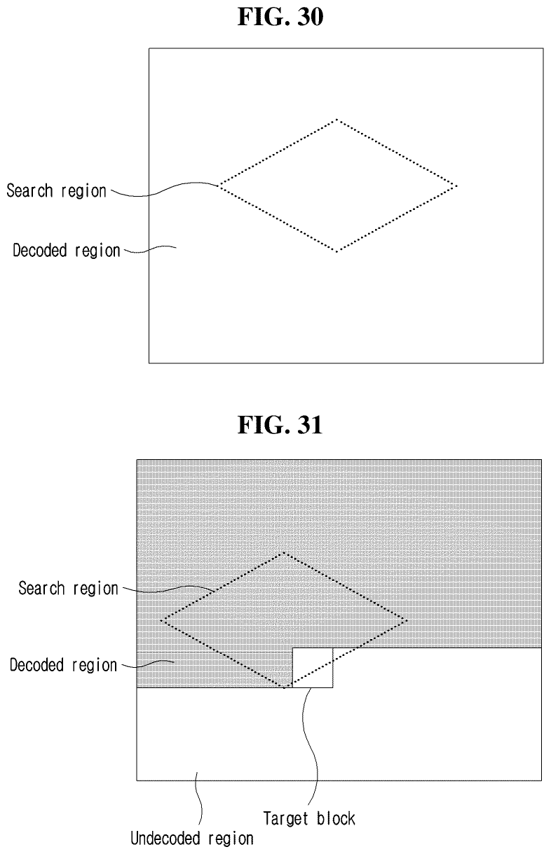

In FIG. 30, it is illustrated that a reference image different from a target image, i.e., a reference image with a different POC from a target image, is set as a BM reference image. As in an example shown in FIG. 30, when a BM reference image is a decoded past image or future image, a BM research region may be a rhombus.

In FIG. 30, a BM research region may be a partial image in a BM reference image.

In FIG. 31, it is illustrated that a target image is set as a BM reference image. As in an example shown in FIG. 31, when a region to be set as a BM search region includes a non-decoded region such as a target block, the remaining regions excluding a non-decoded region may be set as a BM search region.

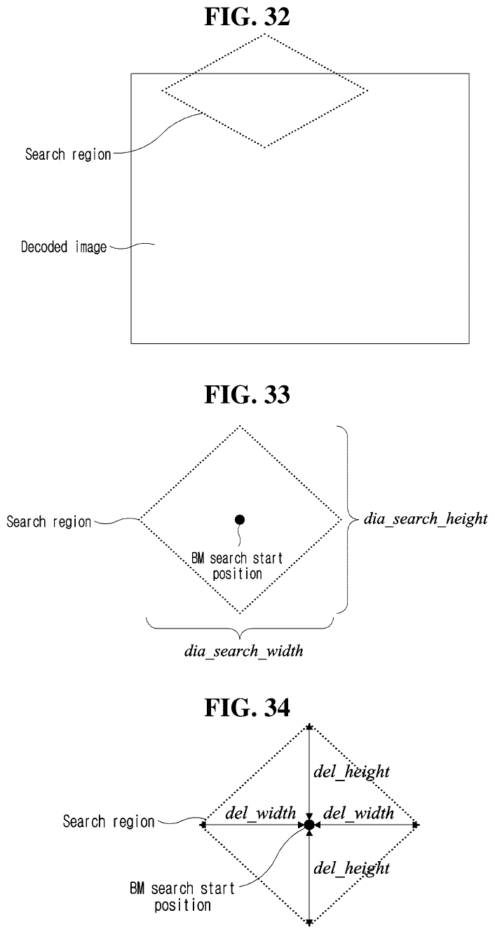

In FIG. 32, it is illustrated that a reference image different from a target image, i.e., a reference image with a different POC from a target image, is set as a BM reference image. As in an example shown in FIG. 32, when a region to be set as a BM search region exists outside an image boundary, the remaining regions excluding a region outside an image boundary may be set as a BM search region.

FIGS. 33 and 34 show information elements for determining a rhombic BM search region.

As in an example shown in FIG. 33, the size of a rhombic BM search region may be defined by a width (dia_search_width) and a height (dia_search_height). At least one of a variable dia_search_width showing a horizontal value and a variable dia_search_height showing a vertical value may be encoded and signaled through a high level syntax such as an encoding parameter, a sequence parameter, an image parameter or a slice header, etc. or may be encoded and signaled in at least one of a coding tree unit or a predetermined block unit. Here, a predetermined block unit may be a coding block, a transform block or a prediction block.

As in an example shown in FIG. 34, the size of a rhombic BM search region may be defined by a horizontal size (del_width) and a vertical size (del_height) from a BM search start position. Here, a horizontal size del_width represents a diagonal length from a BM search start position to a vertex that lies on a horizontal line from a search start position among the vertexes configuring a rhombus. A vertical size del_height represents a diagonal length from a BM search start position to a vertex that lies on a vertical line from a search start position among the vertexes configuring a rhombus. A BM search region is a rhombus that the length of two diagonal lines is (2*del_width) and (2*del_height), respectively, and the size of a BM search region may be 1/2*(1+2*del_width)×(1+2*del_height). At least one of a horizontal size del_width or a vertical size del_height may be encoded and signaled through a high level syntax such as an encoding parameter, a sequence parameter, an image parameter or a slice header, etc. or may be encoded and signaled in at least one of a coding tree unit or a predetermined block unit. As in the above-described example, a BM search region may be rectangular or rhombic. In this case, information specifying the shape of a BM search region may be encoded and signaled. As an example, the information may be an index (e.g., bm_shape_idx) indicating one of a plurality of shape candidates. As an example, when the value of bm_shape_idx has a first value, it may represent that a BM search region is rectangular and when the value of bm_shape_idx has a second value, it may represent that a BM search region is rhombic.

The information may be encoded and signaled through a high level syntax such as an encoding parameter, a sequence parameter, an image parameter or a slice header, etc. or may be encoded and signaled in at least one of a coding tree unit or a predetermined block unit. Here, a predetermined block unit may be a coding block, a transform block or a prediction block.

Alternatively, the shape of a BM search region may be adaptively determined based on at least one of whether a BM reference image is a target image, a distance between a target block and a BM search start position, whether a region to be set as a BM search region includes a target block or a non-decoded region or whether a region to be set as a BM search region is beyond a picture boundary.

Meanwhile, search for a BM reference block in a BM reference image may start at a BM search start position. In this case, a BM search start position may be specified by the initial motion vector of a target block.

As an example, a BM search start position may be set as a position indicated by an initial motion vector, an integer position closest to a position indicated by an initial motion vector or a position obtained by adding/subtracting an offset to/from the position.

Meanwhile, an initial motion vector may be determined based on the coordinate information of a target block.

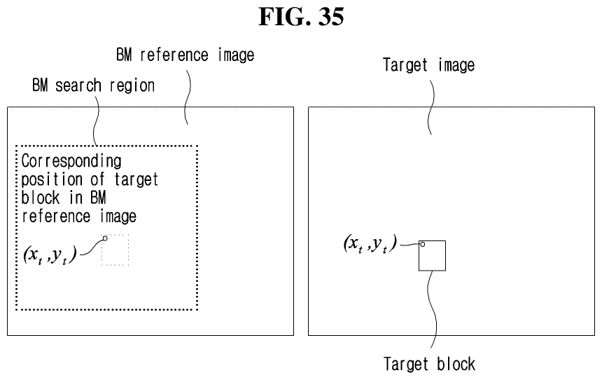

FIG. 35 shows an example in which a position of a target block is configured as a BM search start position.

As in an example shown in FIG. 35, when the top-left coordinate of a target block is (xₜ, yₜ), (xₜ, yₜ), the corresponding position of a target block in a BM reference image, may be set as a BM search start position. In other words, when the position of a target block in a BM reference image is a BM search position, it may be the same as a case where an initial motion vector is (0, 0).

When there is a block encoded/decoded by using BM among the blocks adjacent to a target block, an initial motion vector for BM search may be obtained based on the BM motion vector of an adjacent block.

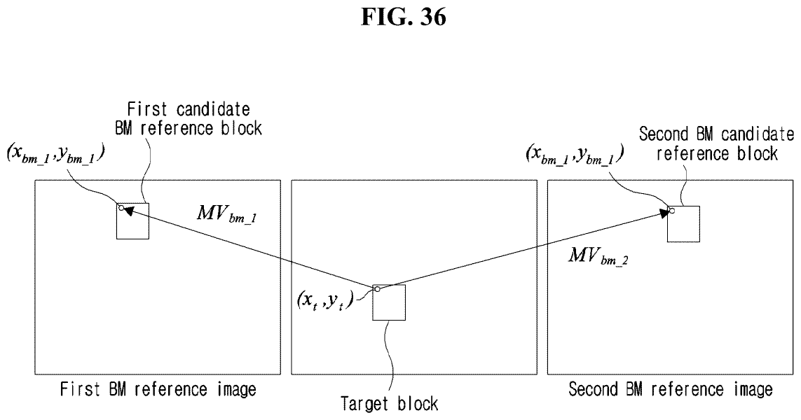

FIG. 36 shows an example in which an initial motion vector is derived from a block adjacent to a target block.

Let's assume that there is a block encoded/decoded by using BM among the blocks adjacent to a target block and the BM motion vector of a block encoded/decoded by using BM is (MV_{bm_x}, MV_{bm_y}). In this case, the initial motion vector of a target block may be set as (MV_{bm_x}, MV_{bm_y}), which is the same as the BM motion vector of an adjacent block.

When the position of a target block is (xₜ, yₜ) and an initial motion vector is (MV_{bm_x}, MV_{bm_y}), a BM search start position in a BM reference image may be set as (xₜ+MV_{bm_x}, yₜ+MV_{bm_y}).

When there are a plurality of adjacent blocks encoded/decoded by BM, the initial motion vector of a target block may be derived from a block that is found first when searching a plurality of adjacent blocks in predetermined order. Alternatively, information specifying one of a plurality of adjacent blocks may be encoded and signaled.

As another example, the initial motion vector of a target block may be obtained based on at least one of merge encoding information. Here, merge encoding information may include at least one of merge_idx, merge_subblock_flag, merge_subblock_idx, regular_merge_flag, mmvd_merge_flag, mmvd_cand_flag, mmvd_distance_idx, mmvd_direction_idx, merge_gpm_partition_idx, merge_gpm_idx0 or merge_gpm_idx1.

As an example, after configuring a merge candidate list for a target block, the motion vector of one of the merge candidates included in a merge candidate list may be set as the initial motion vector of a target block.

In this case, the motion vector of a first merge candidate (i.e., a merge candidate with the index of 0) among the merge candidates included in the merge candidate list of a target block may be set as the initial motion vector of a target block.

Alternatively, the motion vector of a merge candidate selected by a merge index (merge_idx) decoded from a bitstream among the merge candidates included in a merge candidate list may be set as the initial motion vector of a target block.

As an example, let's assume that the position of a target block is (xₜ, yₜ) and the motion vector of a first merge candidate in a merge candidate list or a merge candidate selected by a merge index (merge_idx) is (xₘ, yₘ). In this case, a BM search start position in a BM reference image may be set as (xₜ+xₘ, yₜ+yₘ).

Alternatively, MMVD may be used to modify the motion vector of a merge candidate by using an offset vector, and a modified motion vector may be set as the initial motion vector of a target block. In this case, a merge candidate may be selected by merge_cand_flag, and the size and direction of an offset vector may be determined by mmvd_distance_idx and mmvd_direction_idx, respectively.

Meanwhile, in order to perform BM prediction, two motion vectors are required. Accordingly, when a merge candidate that wants to derive an initial motion vector (e.g., a first merge candidate or a merge candidate selected by a merge index) has only unidirectional motion information, a motion vector in another direction may be derived based on the unidirectional information of a corresponding merge candidate. Then, a first motion vector for the unidirectional information of a corresponding merge candidate and a second motion vector in another direction derived from the unidirectional information may be set as an initial motion vectors for a first direction and a second direction, respectively.

As an example, when a first merge candidate in a merge candidate list has only L0 motion information, a reference picture that has an opposite direction to the L0 reference picture of a first merge candidate and has the same distance between a L0 reference picture and a target picture among the L1 reference pictures is set as a L1 reference picture. Then, a motion vector whose size is the same as the L0 motion vector of a first merge candidate and whose direction is opposite to the L0 motion vector of a first merge candidate may be set as a L1 motion vector. Afterwards, the L0 motion vector of a first merge candidate may be set as an initial motion vector for a L0 direction, and a L1 motion vector may be set as an initial motion vector for a L1 direction.

As another example, the initial motion vector of a target block may also be derived from a merge candidate having bidirectional motion information in a merge candidate list. As an example, the motion vector of a first merge candidate having available bidirectional motion information in the merge candidate list of a target block may be set as the initial motion vector of a target block. In other words, the initial motion vector of a target block may be derived from a merge candidate with the smallest index among the merge candidates having bidirectional motion information in a merge candidate list.

Alternatively, a merge candidate list may be reconfigured only with merge candidates having bidirectional motion information in a merge candidate list, and one of the merge candidates included in a reconstructed merge candidate list may be selected by a merge index (merge_idx). The motion vector of a merge candidate selected by a merge index may be set as the initial motion vector of a target block.

As another example, the initial motion vector of a target block may be derived based on the AMVP mode of inter prediction. Specifically, the initial motion vector of a target block may be obtained based on AMVP encoding information. Here, AMVP encoding information may include at least one of mvp_l0_flag, mvp_l1_flag, abs_mvd_greater0_flag, abs_mvd_greater1_flag, abs_mvd_minus2 or mvd_sign_flag.

A motion vector (x_{AMVP}, y_{AMVP}) obtained based on AMVP encoding information may be set as the initial motion vector of a target block. Here, a motion vector (x_{AMVP}, y_{AMVP}) obtained based on AMVP encoding information may be obtained by adding a motion vector prediction value or a motion vector difference value to the motion vector prediction value. Here, a motion vector prediction value may be obtained by a motion vector predictor (mvp_l0_flag/mvp_l1_flag), and a motion vector difference value may be obtained by information related to a motion vector difference value (at least one of abs_mvd_greater0_flag, abs_mvd_greater1_flag, abs_mvd_minus2 or mvd_sign_flag).

It may be derived by adding a motion vector difference value to a motion vector prediction value.

As an example, when the position of a target block is (xₜ, yₜ) and a motion vector obtained based on AMVP encoding information is (x_{AMVP}, y_{AMVP}), the position of (xₜ+x_{AMVP}, yₜ+y_{AMVP}) indicated by an initial motion vector at the position of a target block in a BM reference image may be set as a BM search start position.

Information for determining an initial motion vector for BM search (e.g., merge encoding information or AMVP encoding information) may be encoded and signaled through a high syntax element such as a sequence parameter, an image parameter or a slice header, etc. or may be encoded and signaled in a coding tree unit or a predetermined block unit.

As in the above-described example, the initial motion vector of a target block may be set to be the same as the coordinate of a target block or may be derived based on at least one of a merge mode or an AMVP mode. In this case, information showing which of the coordinate of a target block, a merge mode or an AMVP mode is used to derive the motion vector of a target block may be encoded and signaled. The information may be encoded and signaled through a high syntax element such as a sequence parameter, an image parameter or a slice header, etc. or may be encoded and signaled in a coding tree unit or a predetermined block unit.

Table 13 shows an example in which a different index is allocated to each method for deriving the initial motion vector of a target block. In order to specify a method for deriving the initial motion vector of a target block, bm_init_idx shown in Table 13 may be encoded and signaled.

TABLE 13

| bm_init_idx | BM Search Initial Motion Vector |
|---|---|
| 0 | (0, 0) |
| 1 | Use of Merge Encoding Information |
| 2 | Use of AMVP Encoding Information |

In an example shown in Table 13, when bm_init_idx is 0, it shows that the initial motion vector of a target block is (0, 0). In this case, the position of a target block in a BM reference image may be set as a BM search start position.

When bm_init_idx is 1, it shows that the initial motion vector of a target block is obtained based on merge encoding information. In this case, merge encoding information may exist in a bitstream.

When bm_init_idx is 2, it shows that the initial motion vector of a target block is obtained based on AMVP encoding information. In this case, AMVP encoding information may exist in a bitstream.

Alternatively, a method for determining the initial motion vector of a target block may be adaptively determined based on at least one of the size/shape of a target block, the prediction mode of a target block, whether a neighboring block adjacent to a target block is encoded by BM and the position of a target block in a target image.

As an example, when the prediction mode of a target block is intra prediction or IBC prediction, an initial motion vector may be set as (0, 0). On the other hand, when the prediction mode of a target block is inter prediction, an initial motion vector may be derived based on one of a merge mode or an AMVP mode.

A method for searching a BM reference block within a BM search region may include at least one of a full search, a 2D logarithmic search, a N-step search, a diamond search, a hexagonal search or a test zone search. Here, a full search refers to searching all pixels of a BM search region. Meanwhile, in the present disclosure, a detailed description of a 2D logarithmic search, a N-step search, a diamond search, a hexagonal search and a test zone search is omitted.

A search method within a BM search region may be predefined in an encoder and a decoder.

Alternatively, a search method within a BM search region may be adaptively determined based on at least one of the size/shape of a target block, motion vector precision, whether a BM reference image is a target image, the position of a current block within a target image, the position of a BM search region within a BM reference image, the size/shape of a BM search region or the POC of a L0 BM reference image and a L1 BM reference image.

Alternatively, a syntax element (e.g., bm_search_idx) specifying a search method within a BM search region may be encoded and signaled.

As an example, according to the value of bm_search_idx, a search method within a BM search region may be determined as follows.
A first value: full search
A second value: 2D logarithmic search
A third value: N-step search
A fourth value: diamond search
A fifth value: hexagonal search
A sixth value: test zone search

Meanwhile, a correlation for searching a BM reference block may be calculated based on a cost function. Here, a cost function may be one of Sum of Absolute Differences (SAD), Sum of Absolute Transformed Differences (SATD), Mean-Removed Sum of Absolute Differences (MR-SAD), Mean Squared Error (MSE) or Sum of Squared Error (SSE). However, types of cost functions are not limited to the listed examples.

Meanwhile, a value calculated by a cost function may be called a matching criteria.

According to a cost function, a block pair with the best correlation (i.e., a pair of a first BM candidate reference block and a second BM candidate reference block) may be a block pair with the highest matching criteria value (i.e., a block pair with the highest cost function) or a block pair with the lowest matching criteria value (i.e., a block pair with the lowest cost function).

However, in the present disclosure, it is assumed that one with the smallest value of a cost function (i.e., one with the lowest matching criteria value) has the best correlation. In other words, in BM search, it may be determined that a candidate block pair with the lowest matching criteria value has the best correlation with a target block.

In addition, instead of selecting one with the lowest matching criteria value, when matching criteria values are ordered in ascending order, all of the preceding N candidates may be selected or one of the N candidates may be selected to derive a BM reference block. When a plurality of candidates are selected, the BM reference block of a target block may be derived through the weighted summation operation or average operation of a plurality of candidate blocks. Here, N is a natural number and may have a value such as 2 or 3, etc.

In BM search, information for specifying the type of a cost function (or matching criteria) used to calculate a correlation may be encoded and signaled. As an example, the information may be an index (e.g., bm_criteria_idx) indicating one of a plurality of cost function candidates, and a cost function candidate indicated by the index may include at least one of SAD, SSD, SATD, MR_SAD or SSE.

As an example, a cost function candidate indicated by the value of bm_criteria_idx may be set as follows.
A first value: SAD
A second value: SSD
A third value: SATD
A fourth value: MR_SAD
A fifth value: SSE

In calculating at least one of a correlation or a cost function (i.e., a matching criteria) described above, instead of a pixel, a coding parameter such as a motion vector or an intra prediction mode (direction) may be used. For example, it may be determined that the smaller a motion vector difference between a first BM candidate reference block and a second BM candidate reference block is, the higher a correlation is or that the smaller an intra prediction mode difference between a first candidate BM reference block and a second BM candidate reference block is, the higher a correlation is. As described above, a correlation or a cost function (i.e., a matching criteria) may be calculated by using a coding parameter such as motion vector or intra prediction mode (direction) of a candidate block.

Alternatively, the sum of a first cost function calculated based on a pixel value and a second cost function calculated based on a coding parameter may be set as matching criteria. As an example, a first cost function may represent the SAD between a first BM candidate block and a second BM candidate block, and a second cost function may be the sum of a distance between first BM candidate blocks at a first initial motion vector position and a distance between second BM candidate blocks at a second initial motion vector position.

Meanwhile, a method for deriving matching criteria may be adaptively determined according to the size of a target block. As an example, when the size of a target block is larger than a threshold value, the sum of a first cost function and a second cost function may be derived as a matching criteria value. On the other hand, when the size of a target block is smaller than a threshold value, a first cost function may be derived as a matching criteria value.

In determining the coding parameter of a target block, a coding parameter with the highest correlation (i.e., a coding parameter with the lowest matching criteria (cost function)) may be used as the candidate coding parameter of a target block. As an example, an intra prediction mode with the highest correlation (i.e., an intra prediction mode with the lowest matching criteria (i.e., cost function)) may be set as the MPM candidate of a Most Probable Mode (MPM) list for entropy encoding/decoding the intra prediction mode of a target block. Here, an intra prediction mode with the highest correlation may represent the intra prediction mode of a pair of candidate blocks with the highest correlation (i.e., at least one of a first BM candidate reference block or a second BM candidate reference block).

Alternatively, motion information with the highest correlation (i.e., motion information with the lowest matching criteria (i.e., cost function)) may be set as a candidate for a merge candidate list or an AMVP list for entropy encoding/decoding the motion information of a target block. Here, motion information with the highest correlation may represent the motion information of a pair of candidate blocks with the highest correlation (i.e., at least one of a first BM candidate reference block or a second BM candidate reference block).

In order to reduce the computational complexity of matching criteria, matching criteria may be calculated by using only pixels at a sub-sampled position within a BM candidate reference block.

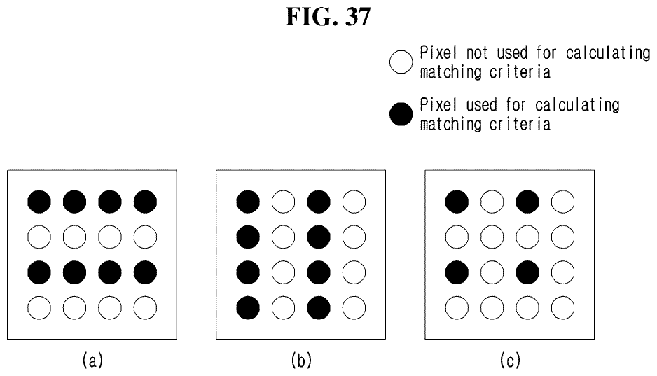

FIG. 37 shows an example in which matching criteria are calculated by using pixels at a sub-sampled position.

As in an example shown in FIG. 37, when calculating matching criteria between a first BM candidate reference block in a first BM reference image and a first BM candidate reference block in a second BM reference image, instead of calculating matching criteria by using all pixels belonging to first/second BM candidate reference blocks, matching criteria may be calculated by using only pixels at a sub-sampled position. In other words, matching criteria may be calculated by using only some pixels, not all pixels in a BM candidate reference block, and here, some pixels may represent at least one pixel in a BM candidate reference block.

Meanwhile, as in an example shown in FIG. 37(a), sub-sampling may be performed only in a vertical direction. As an example, when it is assumed that the top-left position of a block is (0, 0), matching criteria may be calculated by using only pixels at the position of (n₁, 2×n₂) in a block whose width and height are W and H, respectively. Here, n₁ may be an integer of {0, 1, 2, . . . , W−1}, and n₂ may be an integer of {0, 1, 2, . . . , H/2−1}.

Alternatively, as in an example shown in FIG. 37(b), sub-sampling may be performed only in a horizontal direction. As an example, when it is assumed that the top-left position of a block is (0, 0), matching criteria may be calculated by using only pixels at the position of (2×n₁, n₂) within a block whose width and height are W and H, respectively.

Alternatively, as in an example shown in FIG. 37(c), sub-sampling may be performed for both a horizontal direction and a vertical direction. As an example, when it is assumed that the top-left position of a block is (0, 0), matching criteria may be calculated by using only pixels at the position of (2×n₁, 2×n₂) within a block whose width and height are W and H, respectively.

When performing sub-sampling, a bi-linear filter may be applied to each pair of adjacent pixels. As an example, as in an example shown in FIG. 37, when performing sub-sampling ½ times in a horizontal direction or a vertical direction, a pixel value at a sub-sampled position may be set as a value obtained by applying a bi-linear filter to two pixel pairs. As an example, when performing sub-sampling in a horizontal direction, a pixel value at a sub-sampled position may be derived by applying a bi-linear filter to s target pixel and the right or left adjacent pixel of a target pixel. In addition, when performing sub-sampling for a vertical direction, a pixel value at a sub-sampled position may be derived by applying a bi-linear filter to a target pixel and the top or bottom adjacent pixel of a target pixel.

As an example, in an example shown in FIG. 37(a), a pixel at the position of (n₁, 2×n₂) may be obtained by applying a bi-linear filter to a pair of a pixel at the position of (n₁, 2×n₂) and a pixel at the position of (n₁, 2×n₂₊₁).

As an example, in an example shown in FIG. 37(a), a pixel at the position of (2×n₁, n₂) may be obtained by applying a bi-linear filter to a pair of a pixel at the position of (2×n₁, n₂) and a pixel at the position of (2×n₁₊₁, n₂).

A sub-sampling rate or a sub-sampling method may be predefined in an encoder and a decoder. Alternatively, a sub-sampling method may be adaptively determined based on at least one of the size/shape of a target block, motion vector precision or the size of a BM search region.

As an example, when the size of a target block is 4×4 or smaller, sub-sampling may not be performed. In this case, matching criteria may be calculated by using all pixels in a BM reference block.

Alternatively, when at least one of a width or height of a target block is 8 or greater than 8, sub-sampling may be performed. In this case, matching criteria may be calculated only with pixels at some positions within a block.

Meanwhile, whether to perform sub-sampling in a vertical direction, whether to perform sub-sampling in a horizontal direction or whether to perform sub-sampling in both a vertical direction and a horizontal direction may be variably determined by the size/shape of a target block.

As an example, when a target block is square, sub-sampling may be performed in both a vertical direction and a horizontal direction.

Alternatively, when a target block has a non-square shape that a width is greater than a height, sub-sampling may be performed only in one of a vertical direction and a horizontal direction. On the other hand, when a target block has a non-square shape that a height is greater than a width, sub-sampling may be performed only in the other of a vertical direction and a horizontal direction.

In order to search a BM optimal block, a syntax element showing whether only some pixels are used may be encoded and signaled.

As an example, bm_cal_sumsampling_flag showing whether to perform sub-sampling may be encoded and signaled. When the value of bm_cal_sumsampling_flag is a first value, it shows that all pixels belonging to a BM candidate block are used to calculate matching criteria. When the value of bm_cal_sumsampling_flag is a second value, it shows that only some pixels belonging to a BM candidate block are used to calculate matching criteria.

Meanwhile, when the value of bm_cal_subsampling_flag is a second value, information showing a sub-sampling type may be additionally encoded/decoded. A sub-sampling type may be an index indicating one of a first type in which sub-sampling is performed in a horizontal direction, a second type in which sub-sampling is performed in a vertical direction and a third type in which sub-sampling is performed in both a horizontal direction and a vertical direction.

In calculating matching criteria, a first weight may be applied to a first BM candidate block in a first BM reference image, and a second weight may be applied to a second BM candidate block belonging to a second BM reference image. Here, a first weight and a second weight may be determined based on predefined weight set candidates.

A weight set candidate represents a combination of a first weight and a second weight. When one of the weight set candidates is selected, a first weight and a second weight may be derived based on a selected weight set candidate.

According to a selected weight set candidate, a first weight and a second weight may be set as the same value or may be set as a different value.

For a pair of a first BM candidate block and a second BM candidate block, each of a plurality of weight set candidates may be applied. Afterwards, one that is used to derive a combination of a first BM candidate block and a second BM candidate block having the lowest matching criteria among a plurality of weight set candidates may be determined as an optimal weight set. In this case, a BM optimal block may be obtained by applying an optimal weight set to a first BM reference block and a second BM reference block.

In searching a BM reference block, when a predetermined condition is satisfied even when a BM search region is not fully investigated, a search for a BM reference block may be terminated early. It is called ‘BM search early termination’.

The specific condition may be at least one of the value of matching criteria being lower than a predetermined threshold or a difference between a matching criteria value in a current step and a matching criteria value in a previous step being lower than a predetermined threshold in a repeated search.

A syntax element (e.g., bm_early_termination_flag) showing whether to allow BM search early termination may be encoded and signaled.

As an example, when the value of bm_early_termination_flag is a first value, it shows that BM search early termination is not allowed. In this case, matching criteria for all positions in a BM search region (e.g., all integer positions) may be calculated. On the other hand, when the value of bm_early_termination_flag is a second value, it shows that BM search early termination is allowed.

Meanwhile, a threshold for determining BM search early termination may be predefined in an encoder and a decoder. Alternatively, threshold information showing the threshold (e.g., bm_early_termination_threshold) may be encoded and signaled. As an example, at least one of bm_early_termination_threshold1 showing a first threshold related to BM search early termination or bm_early_termination_threshold2 showing a second threshold may be encoded and signaled.

As an example, let's assume that a threshold where bm_early_termination_threshold1 is shown is Th1ₜₘ. In this case, when a pair of a first BM candidate block and a second BM candidate block having a matching criteria value smaller than Th1ₜₘ is searched, BM search may be early terminated. And, a first BM candidate block and a second candidate block where a matching criteria value is smaller than Th1ₜₘ may be set as a first BM reference block and a second BM reference block, respectively.

As an example, let's assume that a threshold where bm_early_termination_threshold2 is shown is Th2ₜₘ. In this case, when a difference between the value of matching criteria in a current step and the value of matching criteria in a previous step is lower than Th2ₜₘ, BM search may be terminated early. And, a first BM candidate block and a second candidate block searched in a current step may be set as a first BM reference block and a second BM reference block, respectively. Here, the value of matching criteria in a previous step may represent the value of matching criteria calculated in a step immediately before a current step or the minimum value among the matching criteria values calculated before a current step.

[D3] a Step of Encoding/Decoding a Target Block with a BM Optimal Block

Through a BM search step, at least one of a BM reference block, a BM optimal block or a BM motion vector may be obtained. A target block may be encoded/decoded by using at least one of a BM reference block, a BM optimal block or a BM motion vector. Hereinafter, a method for encoding/decoding (reconstructing) a target block by using the information will be described in detail.

### [D3-1] BM-Based Prediction

A BM optimal block (or a BM optimal signal) may be set as a prediction block (or a prediction signal) for a target block. In other words, a sample at a position of (x, y) within a BM optimal block may represent a prediction sample at a position of (x, y) within a target block.

Accordingly, a residual block (or a residual signal) for a BM optimal block may be derived by subtracting a BM optimal block (or a BM optimal signal) from the original block (or original signal) of a target block.

In a decoder, a target block may be reconstructed by combining the BM optimal block and the residual block of a target block.

### [D3-2] BM-Based Intra Residual Signal Prediction

A BM optimal block may be used to predict the intra prediction error signal (i.e., residual signal) of a target block. Here, a residual signal represents a difference between an original sample (or, a reconstructed sample) within a target block and a prediction sample obtained through intra prediction. In other words, a BM optimal block may be used to predict the residual signal of a target block, and accordingly, only a difference value between the residual signal of a target block and a prediction residual signal predicted based on a BM optimal block may be encoded. Hereinafter, a difference between a residual signal and a prediction residual signal will be referred to as a BM residual signal.

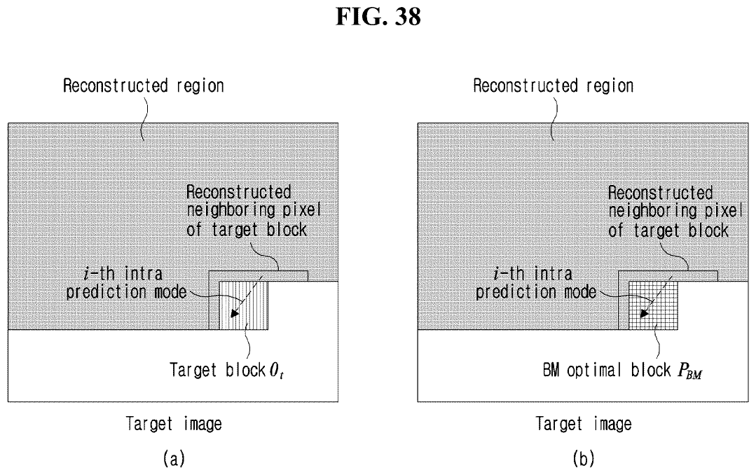

FIG. 38 shows an example in which a BM residual signal is derived based on a BM optimal block.

As in an example shown in FIG. 38(a), a prediction signal may be obtained based on an intra prediction mode for a target block, and a prediction signal may be subtracted from an original signal to obtain a residual signal for a target block. Meanwhile, as in an example shown in FIG. 38(b), for a BM optimal block, a residual signal may be obtained by performing intra prediction with the same reference samples as a target block.

In other words, the prediction signal of a target block may be subtracted from a BM optimal block to obtain a residual signal for a BM optimal block.

In this case, the residual signal of a BM optimal block may be set as the prediction value of a residual signal of a target block. Accordingly, a BM residual signal may be derived by subtracting the residual signal (i.e., prediction residual signal) of a BM optimal block from the residual signal of a target block, and a BM residual signal may be encoded/decoded for a target block. As such, encoding/decoding a BM residual signal may be called ‘a BM-based intra residual signal prediction technique’.

A method for obtaining a BM residual signal may be expressed as in Equations 4 to 6 below. First, Equation 4 shows an example in which the residual signal of a target block is derived.

$${P}_{t , {m}_{i}} ( x , y ) = {O}_{t} - {P}_{t , {m}_{i}} ( x , y ) \qquad [ Equation 4 ]$$

Oₜ(x, y) represents an original signal at the position of (x, y) in a target block. mi represents an intra prediction mode whose index is i, and P_{t,mi}(x, y) represents a prediction signal at the position (x, y) when an intra prediction mode whose index is i is applied. R_{t,mi}(x, y) represents a residual signal at the position of (x, y) within a target block. As in an example shown in Equation 4, R_{t,mi}(x, y), a residual signal at the position of (x, y) within a target block, may be derived by subtracting a prediction signal P_{t,mi}(x, y) obtained by intra prediction from Oₜ(x,y).

Equation 5 shows an example in which a residual signal for a BM optimal block is derived.

$${R}_{BF , {m}_{i}} ( x , y ) = {P}_{BM} ( x , y ) - {{P}_{t , m}}_{i} ( x , y ) \qquad [ Equation 5 ]$$

P_{BM}(x,y) represents a signal at the position of (x, y) in a BM optimal block. R_{BM,mi}(x, y) represents a residual signal at the position of (x, y) in a BM optimal block. As in an example shown in Equation 5, R_{BM,mi}(x, y), a residual signal at the position of (x, y) within a BM optimal block, may be derived by subtracting a prediction signal P_{t,mi}(x, y) obtained by intra prediction from P_{BM}(x,y)

Equation 6 shows an example in which a BM residual signal is derived.

$${D}_{BMRP} ( x , y ) = {R}_{t , {m}_{i}} ( x , y ) - {R}_{BM , {m}_{i}} ( x , y ) \qquad [ Equation 6 ]$$

As in an example shown in Equation 6 above, a BM residual signal D_{BMRP}(x, y) may be derived by subtracting the residual signal R_{BM,mi}(x, y) of a BM optimal block from the residual signal R_{t,mi}(x, y) of a target block.

A BM residual signal may be encoded through at least one of transform or quantization. In a decoder, a BM residual signal may be derived by decoding a transform coefficient and applying at least one of dequantization or inverse transform to a decoded transform coefficient. In addition, a BM residual signal may be entropy encoded/decoded.

Meanwhile, a signal for the position of (x, y) within a target block may be reconstructed based on a BM residual signal, a prediction residual signal and a prediction signal obtained by intra prediction. Equation 7 shows an example in which a signal at the position of (x, y) within a target block is reconstructed.

$$\begin{matrix}Re {c}_{t} ( x , y ) = {P}_{t , {m}_{i}} ( x , y ) + {R}_{t , {m}_{i}} ( x , y ) \\ = {P}_{t , {m}_{i}} ( x , y ) + {D}_{BMRP} ( x , y ) + {R}_{BM , {m}_{i}} ( x , y ) \\ = {P}_{t , {m}_{i}} ( x , y ) + {D}_{BMRP} ( x , y ) + {P}_{BM} ( x , y ) - {P}_{t , {m}_{i}} ( x , y ) \\ = {D}_{BMRP} ( x , y ) + {P}_{B M} ( x , y )\end{matrix} \qquad [ Equation 7 ]$$

For the arbitrary position of (x, y), when a BM residual signal D_{BMRP}(x, y) is obtained, a reconstructed sample may be obtained by using a prediction residual signal and a prediction signal P_{t,mi}(x, y) obtained by an intra prediction mode whose index is i. In this case, a prediction residual signal R_{BM,mi}(x, y) may be derived by subtracting a prediction signal P_{t,mi}(x, y) from a signal P_{BM}(x, y) at the position of (x, y) within a BM optimal block.

Meanwhile, when BM-based intra residual signal prediction is applied, the intra prediction mode of a target block may be set as an intra prediction mode predefined in an encoder and a decoder. As an example, a predefined intra prediction mode may be at least one of a DC mode, a planar mode, a vertical mode, a horizontal mode or a diagonal mode (e.g., a top-right diagonal direction, a top-left diagonal direction or a bottom-left diagonal direction). As an example, when the intra prediction mode of a target block is a planar mode, in Equations 4 to 7, a prediction signal P_{t,mi}(x, y) generated by intra prediction may be replaced with a prediction signal P_{t,planar}(x, y) predicted based on a planar mode.

Alternatively, when BM-based intra residual signal prediction is applied, the intra prediction mode of a target block may be set as one of the MPM candidates included in a MPM list. In this case, an index specifying one of the MPM candidates included in a MPM list may be encoded and signaled.

Alternatively, when BM-based intra residual signal prediction is applied, an intra prediction mode applied to a BM reference block may be set as the intra prediction mode of a target block. As an example, when intra prediction modes of a first BM reference block and a second BM reference block are the same, the intra prediction mode may be set as the intra prediction mode of a target block.

Alternatively, when intra prediction modes of a first BM reference block and a second BM reference block are different from each other, one of the intra prediction mode of a first BM reference block and the intra prediction mode of a second BM reference block may be selected, and a selected intra prediction mode may be set as the intra prediction mode of a target block.

Alternatively, when intra prediction modes of a first BM reference block and a second BM reference block are different from each other, a first prediction signal for a target block may be obtained based on the intra prediction mode of a first BM reference block and a second prediction signal for a target block may be obtained based on the intra prediction mode of a second BM reference block. Afterwards, what is derived through the averaging or weighted summation of a first prediction signal and a second prediction signal may be set as the prediction signal of a target block.

Alternatively, when only any one of a first BM reference block and a second BM reference block is encoded/decoded by intra prediction, the intra prediction mode of a block encoded/decoded by intra prediction may be set as the intra prediction mode of a target block.

Alternatively, when both a first BM reference block and a second BM reference block are not encoded/decoded by intra prediction, a predefined intra prediction mode may be applied to a target block or the intra prediction mode of a target block may be selected from a MPM list.

A syntax element (e.g., bm_intra_residual_pred) showing whether a target block is encoded/decoded by BM-based intra residual signal prediction may be encoded and signaled.

As an example, when the value of bm_intra_residual_pred is a first value, it shows that a BM-based intra residual signal prediction method is applied to a target block. In this case, a BM residual signal which is a difference between the residual signal of a target block and the residual signal of a BM optimal block may be encoded and signaled.

On the other hand, when the value of bm_intra_residual_pred is a second value, it may show that a target block is not encoded by a BM-based intra residual signal prediction method. In this case, the residual signal of a target block, not a BM residual signal, may be encoded and signaled.

### [D3-3] Restricted BM-Based Intra Residual Signal Prediction

The residual signal of a BM optimal block may be set as the prediction value of at least a part of a residual signal of a target block. In other words, instead of applying BM-based intra residual signal prediction to the entire region of a target block, BM-based intra residual signal prediction may be applied to the partial region of a target block. As such, setting the prediction value of a residual signal only for the partial region of a target block may be called ‘restricted BM-based intra residual signal prediction’.

When restricted BM-based intra residual signal prediction is applied, in a region where residual signal prediction within a target block is applied, a BM residual signal may be derived according to the example of Equation 6 described above. In addition, in a region where residual signal prediction within a target block is applied, a reconstructed signal within a target block may be derived according to the example of Equation 7 described above.

On the other hand, for a region where restricted BM-based intra residual signal prediction is not applied, the residual signal of a target block derived by Equation 4 may be encoded/decoded.

Some regions where residual signal prediction within a target block is applied may be composed of samples in which at least one of a vertical distance and/or a horizontal distance from a reference sample (or the boundary of a target block) is greater than or equal to a threshold value. Specifically, at least one of a horizontal distance from a left reference sample on the same horizontal line as a target sample in a target block or a vertical distance from a top reference sample on the same vertical line as a target sample in a target block may be compared with a threshold value to determine whether to apply residual signal prediction to a target sample.

Meanwhile, the size and/or shape of some regions may be adaptively determined based on at least one of the size and/or shape of a target block or an intra prediction mode.

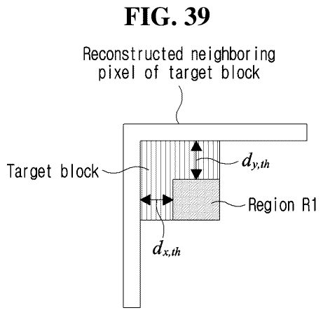

FIG. 39 to FIG. 42 illustrate a region to which residual signal prediction in a target block is applied.

In an example shown in FIG. 39, it was illustrated that a residual signal prediction region is composed of target samples where a horizontal distance from a left reference sample (i.e., a x-axis coordinate difference value between a target sample and a left reference sample) is greater than or equal to a horizontal threshold value d_{x,th} and a vertical distance from a top reference sample (i.e., a y-axis coordinate difference value between a target sample and a top reference sample) is greater than or equal to a vertical threshold value d_{y,th}.

In other words, R1, a region where a horizontal distance from the left of a target block in a x-axis direction is greater than or equal to a horizontal threshold value d_{x,th} and a vertical distance from the top of a target block in a y-axis direction is greater than or equal to a vertical threshold value d_{y,th}, may be set as a residual signal prediction region.

For a target sample at the position of (x, y) within a residual signal prediction region, a BM residual signal D_{BMRP}(x, y) may be encoded/decoded. Equation 8 shows an example in which a BM residual signal D_{BMRP}(x, y) is obtained for the position of (x, y) within a residual signal prediction region.

$${D}_{B M R P} ( x , y ) = {R}_{t , {m}_{i}} ( x , y ) - {R}_{BM , {m}_{i}} ( x , y ) , \qquad [ Equation 8 ]$$

$$where$$

$$( x , y ) ∈ R 1$$

In Equation 8, R1 represents a residual signal prediction region.

Accordingly, a reconstructed signal at the position of (x, y) within a residual signal prediction region may be derived by combining a BM residual signal D_{BMRP}(x, y), the prediction signal of a target block P_{t,mi}(x, y) and the residual signal of a BM optimal block R_{BM,mi}(x, y). Equation 9 shows an example in which a reconstructed signal within a residual signal prediction region is obtained.

$$\begin{matrix}Re {c}_{t} ( x , y ) = {P}_{t , {m}_{i}} ( x , y ) + {R}_{t , {m}_{i}} ( x , y ) \\ = {P}_{t , {m}_{i}} ( x , y ) + {D}_{BMRP} ( x , y ) + {R}_{BM , {m}_{i}} ( x , y ) \\ = {P}_{t , {m}_{i}} ( x , y ) + {D}_{BMRP} ( x , y ) + {P}_{BM} ( x , y ) - {P}_{t , {m}_{i}} ( x , y ) \\ = {D}_{BMRP} ( x , y ) + {P}_{B M} ( x , y ) , where ( x , y ) ∈ R 1\end{matrix} \qquad [ Equation 9 ]$$

On the other hand, for a target sample at the position of (x, y) outside a residual signal prediction region, a residual signal R_{t,mi}(x, y) may be encoded/decoded. Accordingly, a reconstructed signal at the position of (x, y) outside a residual signal prediction region may be derived by combining the prediction signal of a target block P_{t,mi}(x, y) and the residual signal of a target block R_{t,mi}(x, y).

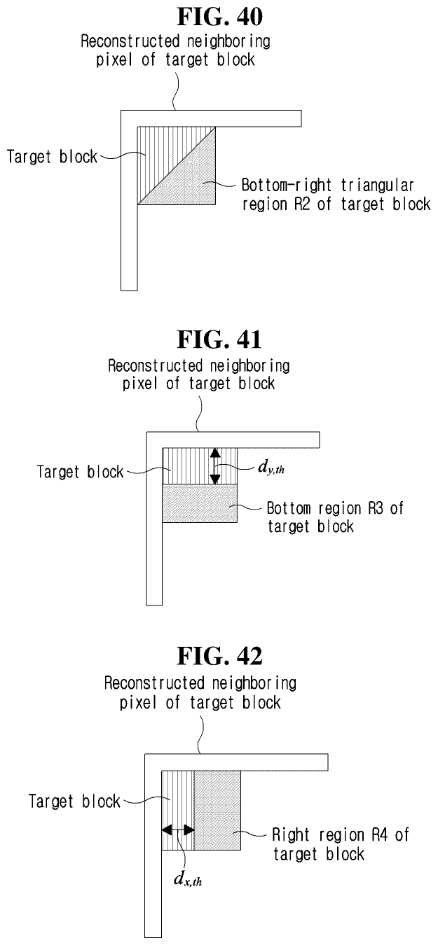

Alternatively, as in an example shown in FIG. 40, R2, the bottom-right triangular region within a target block, may be set as a residual signal prediction region. In other words, a region where the sum of a horizontal distance between a target block and a left reference sample and a vertical distance between a target block and a top reference sample is greater than a threshold value may be set as a residual signal prediction region. Equation 10 shows an example in which a BM residual signal is derived in a residual signal prediction region.

$${D}_{BMRP} ( x , y ) = {R}_{t , {m}_{i}} ( x , y ) - {{R}_{BM , m}}_{i} ( x , y ) , \qquad [ Equation 10 ]$$

$$where$$

$$( x , y ) ∈ R 2$$

In Equation 10 above, R2 represents a residual signal prediction region.

Equation 11 shows an example in which a target sample within a residual signal prediction region is reconstructed.

$$\begin{matrix}Re {c}_{t} ( x , y ) = {P}_{t , {m}_{i}} ( x , y ) + {R}_{t , {m}_{i}} ( x , y ) \\ = {P}_{t , {m}_{i}} ( x , y ) + {D}_{BMRP} ( x , y ) + {R}_{BM , {m}_{i}} ( x , y ) \\ = {P}_{t , {m}_{i}} ( x , y ) + {D}_{BMRP} ( x , y ) + {P}_{BM} ( x , y ) - {P}_{t , {m}_{i}} ( x , y ) \\ = {D}_{BMRP} ( x , y ) + {P}_{B M} ( x , y ) , where ( x , y ) ∈ R 2\end{matrix} \qquad [ Equation 11 ]$$

In FIGS. 39 and 40, it was illustrated that a residual sample prediction region is set by considering both a horizontal distance and a vertical distance for a target sample. Unlike an example shown in FIGS. 39 and 40, a residual signal prediction region may be set by considering only a horizontal distance or a residual signal prediction region may be set by considering only a vertical distance.

As an example, as in an example shown in FIG. 41, a region R3 composed of target samples where a distance in a y-axis direction from the top of a target block (i.e., a vertical distance between a top reference sample and a target sample) is greater than a vertical threshold value d_{y,th} may be set as a residual signal prediction region.

Equation 12 shows an example in which a BM residual signal is derived in a residual signal prediction region.

$${D}_{BMRP} ( x , y ) = {R}_{t , {m}_{i}} ( x , y ) - {R}_{BM , {m}_{i}} ( x , y ) , \qquad [ Equation 12 ]$$

$$where$$

$$( x , y ) ∈ R 3$$

In Equation 12 above, R3 represents a residual signal prediction region.

Equation 13 shows an example in which a target sample within a residual signal prediction region is reconstructed.

$$\begin{matrix}Re {c}_{t} ( x , y ) = {P}_{t , {m}_{i}} ( x , y ) + {R}_{t , {m}_{i}} ( x , y ) \\ = {P}_{t , {m}_{i}} ( x , y ) + {D}_{BMRP} ( x , y ) + {R}_{BM , {m}_{i}} ( x , y ) \\ = {P}_{t , {m}_{i}} ( x , y ) + {D}_{BMRP} ( x , y ) + {P}_{BM} ( x , y ) - {P}_{t , {m}_{i}} ( x , y ) \\ = {D}_{BMRP} ( x , y ) + {P}_{B M} ( x , y ) , where ( x , y ) ∈ R 3\end{matrix} \qquad [ Equation 13 ]$$

As an example, as in an example shown in FIG. 42, a region R4 composed of target samples where a distance in a x-axis direction from the left of a target block (i.e., a horizontal distance between a left reference sample and a target sample) is greater than a horizontal threshold value d_{x,th} may be set as a residual signal prediction region.

Equation 14 shows an example in which a BM residual signal is derived in a residual signal prediction region.

$${D}_{BMRP} ( x , y ) = {R}_{t , {m}_{i}} ( x , y ) - {R}_{B M , {m}_{i}} ( x , y ) , \qquad [ Equation 14 ]$$

$$where$$

$$( x , y ) ∈ R 4$$

In Equation 14 above, R4 represents a residual signal prediction region.

Equation 15 shows an example in which a target sample within a residual signal prediction region is reconstructed.

$$\begin{matrix}Re {c}_{t} ( x , y ) = {P}_{t , {m}_{i}} ( x , y ) + {R}_{t , {m}_{i}} ( x , y ) \\ = {P}_{t , {m}_{i}} ( x , y ) + {D}_{BMRP} ( x , y ) + {R}_{BM , {m}_{i}} ( x , y ) \\ = {P}_{t , {m}_{i}} ( x , y ) + {D}_{BMRP} ( x , y ) + {P}_{BM} ( x , y ) - {P}_{t , {m}_{i}} ( x , y ) \\ = {D}_{BMRP} ( x , y ) + {P}_{B M} ( x , y ) , where ( x , y ) ∈ R 4\end{matrix} \qquad [ Equation 15 ]$$

Meanwhile, at least one of a horizontal threshold value d_{x,th} or a vertical threshold value d_{y,th} may be predefined in an encoder and a decoder.

Alternatively, according to the size of a target block, at least one of a horizontal threshold value d_{x,th} or a vertical threshold value d_{y,th} may be adaptively determined. As an example, a horizontal threshold value d_{x,th} may be set as ½ of the width W of a current block and a vertical threshold value d_{y,th} may be set as ½ of the height H of a current block.

In this case, in an example shown in FIG. 39, a region where a x-axis coordinate is greater than W/2 and a y-axis coordinate is greater than H/2 may be set as a residual signal prediction region.

Alternatively, in an example shown in FIG. 40, a region where a y-axis coordinate is greater than H/2 may be set as a residual signal prediction region.

Alternatively, in an example shown in FIG. 41, a region where a x-axis coordinate is greater than W/2 may be set as a residual signal prediction region.

Meanwhile, at least one of the size and/or shape of a residual signal prediction region may be adaptively determined according to the intra prediction mode of a target block. As an example, when the intra prediction mode of a target block is a nondirectional mode (e.g., a DC mode or a planar mode), as in an example shown in FIG. 39, a region where a x-axis coordinate is greater than a horizontal threshold value and a y-axis coordinate is greater than a vertical threshold value may be set as a residual signal prediction region. Alternatively, when an intra prediction mode is a nondirectional mode, as in an example shown in FIG. 40, the bottom-right triangular region of a target block may be set as a residual signal region.

On the other hand, when the intra prediction mode of a target block is a vertical mode or a mode similar to a vertical direction, as in an example shown in FIG. 41, a region where a y-axis coordinate within a target block is greater than a vertical threshold value may be set as a residual signal prediction region. Here, a mode similar to a vertical mode represents an intra prediction mode in which an index difference from a vertical direction is less than or equal to a predefined offset.

On the other hand, when the intra prediction mode of a target block is a horizontal mode or a mode similar to a horizontal direction, as in an example shown in FIG. 42, a region where a x-axis coordinate within a target block is greater than a horizontal threshold value may be set as a residual signal prediction region. Here, a mode similar to a vertical mode represents an intra prediction mode in which an index difference from a vertical direction is less than or equal to a predefined offset.

Alternatively, when restricted BM-based intra residual signal prediction is applied, a BM residual signal for a residual signal prediction region may be obtained based on a predefined intra prediction mode. Here, a predefined intra prediction mode may include at least one of a DC mode, a planar mode, a vertical mode, a horizontal mode or a diagonal mode.

As an example, in an example shown in FIGS. 39 to 42, a BM residual signal R_{BM}(x, y) at the position of (x, y) within a residual signal prediction region (one of R1 to R4) may be derived by subtracting a prediction signal P_{t,planar}(x, y) at the position of (x, y) obtained based on a planar mode from a signal at the position of (x, y) within a BM optimal block.

A syntax element (e.g., restrict_bm_intra_residual_pred) showing whether restricted BM-based intra residual signal prediction is applied to a target block may be encoded and signaled.

As an example, when the value of restrict_bm_intra_residual pred is a first value, it shows that a target block is encoded by a restricted BM-based intra residual signal prediction method. On the other hand, when the value of restrict_bm_intra_residual pred is a second value, it may show that a target block is not encoded by a restricted BM-based intra residual signal prediction method.

Based on the value of a syntax restric_bm_intra_residual_pred, whether a BM residual signal is encoded/decoded for the partial region of a target block may be determined. As an example, when the value of restrict_bm_intra_residual pred is a first value, a BM residual signal which is a difference value between the residual signal of a target block and the residual signal of a BM optimal block may be encoded and signaled for the partial region of a target block. On the other hand, when the value of restrict_bm_intra_residual pred is a second value, the residual signal of a target block may be encoded and signaled for the entire region of a target block.

As another example, restricted BM-based intra residual signal prediction may be used in a restricted manner only when BM-based intra residual signal prediction is applied.

As an example, when BM-based intra residual signal prediction is applied to a target block, i.e., when the value of bm_intra_residual_pred is a first value, a syntax element restrict_bm_intra_residual_flag showing whether restricted BM-based intra residual signal prediction is applied to a target block may be encoded and signaled.

In other words, only when the value of a syntax bm_intra_residual_pred showing whether BM-based intra residual signal prediction is applied to a target block is a first value, a syntax restrict_bm_intra_residual_flag showing whether restricted BM-based intra residual signal prediction is applied may be encoded and signaled. In other words, when the value of a syntax bm_intra_residual_pred is not a first value, encoding/decoding of a syntax restrict_bm_intra_residual_flag may be omitted.

In this case, when the value of restrict_bm_intra_residual_flag is a first value, it shows that a BM-based intra residual signal prediction method is applied only to the partial region of a target block. In other words, in this case, in the partial region of a target block (i.e., a residual signal prediction region), a BM residual signal may be encoded/decoded, and in the remaining regions of a target block, the residual signal of a target block may be encoded/decoded.

On the other hand, when the value of restrict_bm_intra_residual flag is a second value, it shows that a BM-based intra residual signal prediction method is applied to all regions of a target block. In other words, in this case, a BM residual signal may be encoded/decoded for the entire region of a target block.

When the value of bm_intra_residual_pred is a second value, a BM-based intra residual signal prediction method may not be applied to a target block. In other words, in this case, the residual signal of a target block may be encoded/decoded for the entire region of a target block and the encoding/decoding of a BM residual signal may be omitted.

Meanwhile, BM-based intra residual signal prediction may be used only when the prediction mode of a target block indicates intra prediction.

Alternatively, BM-based intra residual signal prediction may be applied only when a predefined intra prediction mode is applied to a target block. Here, a predefined intra prediction mode may be a nondirectional mode (e.g., a DC mode or a planar mode) or a directional mode having a predefined direction (e.g., a vertical mode, a horizontal mode or a diagonal mode).

Alternatively, whether BM-based intra residual signal prediction may be applied to a target block may be determined based on at least one of the size/shape of a target block or whether ISP is applied to a target block.

Under the condition, only when it is determined that BM-based intra residual signal prediction is applied to a target block, a syntax element (e.g., at least one of bm_intra_residual_pred or restrict_bm_intra_residual_flag) showing whether BM-based intra residual signal prediction is applied to a target block may be encoded and signaled.

Meanwhile, when BM-based intra residual signal prediction is applied, LFNST may be set not to be applied.

Alternatively, when BM-based intra residual signal prediction is applied, transform may be performed by using a predefined transform type. A predefined transform type may be one of DCT2, DCT8 or DST7. As an example, when BM-based intra residual signal prediction is applied to a target block, the transform type of a target block may be set as DCT2.

### [D3-4] LIC (Local Illumination Compensation)-Based BM Prediction

When a i-th BM reference block indicated by a i-th BM motion vector is derived from a i-th BM reference image (here, i is 1 or 2), a BM optimal block may be derived by using at least one derived BM reference block. In this case, a BM optimal block may be corrected by using at least one of the neighboring pixel of a BM reference block or the neighboring pixel of a target block. A corrected BM optimal block may be set as the prediction block of a target block.

In this case, the correction of a BM optimal block may be performed based on Local illumination Compensation (LIC). The above-described method for correcting a BM optimal block may be called ‘LIC-based BM prediction’.

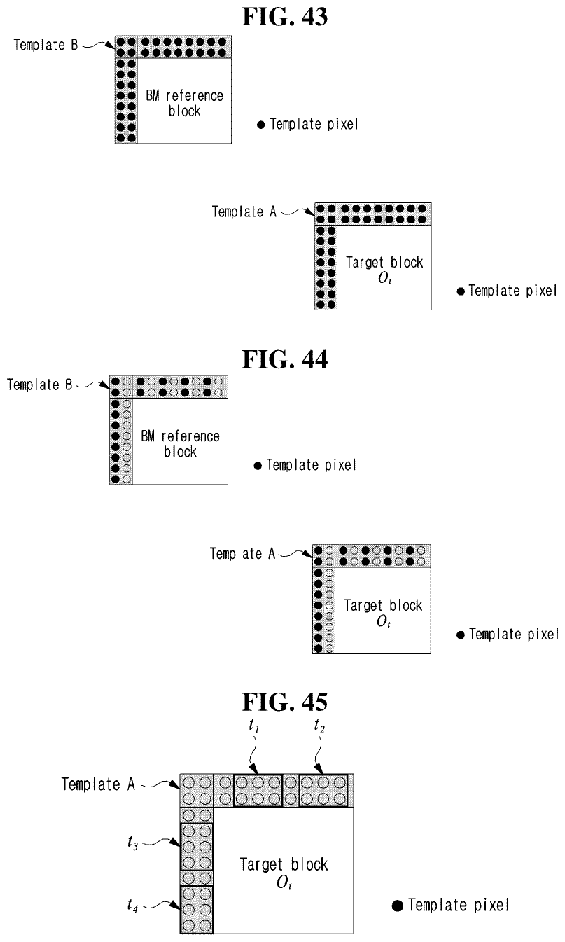

FIG. 43 is a drawing for describing an example of correcting a BM optimal block.

As in FIG. 43, let's assume that a signal at the position of (x, y) within a target block is Oₜ(x, y). The position of (x, y) within a target block may be predicted by using at least one of template A adjacent to a target block, template B adjacent to a BM reference block or a signal P_{BM}(x, y) at the position of (x, y) within a BM optimal block. Specifically, as in Equation 16 below, the position of (x, y) of a target block may be pre-predicted based on a signal P_{BM}(x, y) at the position of (x, y) within a BM optimal block.

$${RES}_{LIC \_ BM} ( x , y ) = {O}_{t} ( x , y ) - ( α \cdot {P}_{BM} ( x , y ) + β ) \qquad [ Equation 16 ]$$

In Equation 16 above, Res_{LIC_BM}(x, y) represents a residual signal (i.e., a prediction error) at the position of (x, y) within a target block. A prediction signal at the position of (x, y) within a target block may be set as (α*P_{BM}(x, y)+β), and α and β may represent coefficients of a linear model.

A reconstructed pixel at the position of (x, y) within a target block, as in an example shown in Equation 17 below, may be derived by combining a residual signal Res_{LIC_BM}(x, y) at the position of (x, y) within a target block and a prediction signal (α*P_{BM}(x, y)+β).

$$R e {c}_{t} ( x , y ) = ( α \cdot {P}_{B M} ( x , y ) + β ) + {Res}_{LIC \_ BM} ( x , y ) \qquad [ Equation 17 ]$$

Meanwhile, information about the coefficient of a linear model (i.e., α and β) may be explicitly encoded and signaled.

Alternatively, the coefficient of a linear model may be obtained based on the template of a BM optimal block and the template of a target block. In other words, the coefficient of a linear model may be derived in the same manner in an encoder and a decoder.

In an example shown in FIG. 43, template A represents a pre-reconstructed region around a target block. Template B may be one of the neighboring pixel of a first BM reference block, the neighboring pixel of a second BM reference block or the average value of the neighboring pixel of a first BM reference block and the neighboring pixel of a second BM reference block.

Let's assume that the brightness or chroma value of pixel p belonging to template A is Y_{A}(p) and the brightness or chroma value of pixel p belonging to template B is Y_{B}(p). Here, p represents a value indicating one of the pixels included in a template. For example, when N pixels are included in template A and template B, respectively, p may be one of 1 to N.

Linear model coefficients α and β for LIC-based BM prediction may be derived as in Equation 18 below.

$$α = \frac{N \cdot {\sum }_{p = 1}^{N} ( {Y}_{A} ( p ) \cdot {Y}_{B} ( p ) ) - {\sum }_{p = 1}^{N} {Y}_{A} ( p ) \cdot {\sum }_{p = 1}^{N} {Y}_{B} ( p )}{N \cdot {\sum }_{p = 1}^{N} ( {Y}_{A} ( p ) \cdot {Y}_{B} ( p ) ) - {\sum }_{p = 1}^{N} {Y}_{A} ( p ) \cdot {\sum }_{p = 1}^{N} {Y}_{A} ( p )} \qquad [ Equation 18 ]$$

$$β = \frac{{\sum }_{p = 1}^{N} {Y}_{B} ( p ) - α \cdot {\sum }_{p = 1}^{N} {Y}_{A} ( p )}{N}$$

Alternatively, only some position pixels within a template may be used to derive a linear model coefficient.

FIG. 44 shows an example in which a linear model coefficient is derived by using only some position pixels within a template.

In FIG. 44, let's assume that the value of pixel j belonging to template A is Y_{A}(j) and the value of pixel j belonging to template B is YB(j). Here, j represents a value indicating one of the pixels included in a template. For example, when N pixels are included in template A and template B, respectively, j may be one of 1 to N.

Linear model coefficients α and β for LIC-based BM prediction may be derived based on some pixels belonging to template A and pixels belonging to template B corresponding to the some pixels, as in an example of Equation 19 below.

$$α = \frac{M \cdot {\sum }_{j = 1}^{M} ( {Y}_{A} ( j ) \cdot {Y}_{B} ( j ) ) - {\sum }_{j = 1}^{M} {Y}_{A} ( j ) \cdot {\sum }_{j = 1}^{M} {Y}_{B} ( j )}{N \cdot {\sum }_{j = 1}^{M} ( {Y}_{A} ( j ) \cdot {Y}_{B} ( j ) ) - {\sum }_{j = 1}^{M} {Y}_{A} ( j ) \cdot {\sum }_{j = 1}^{M} {Y}_{A} ( j )} \qquad [ Equation 19 ]$$

$$β = \frac{{\sum }_{j = 1}^{M} {Y}_{B} ( j ) - α \cdot {\sum }_{j = 1}^{M} {Y}_{A} ( j )}{M}$$

In Equation 19 above, M may be a value less than or equal to N.

Meanwhile, in FIG. 44, it was illustrated that pixels used to derive the coefficient of a linear model within template A are located by skipping a pixel one by one in a horizontal direction. In other words, it was illustrated that template A is sub-sampled only in a horizontal direction. Accordingly, in template B, pixels used to derive the coefficient of a linear model may also be located by skipping a pixel one by one in a horizontal direction. In this case, in Equation 19, M may have a value of N/2.

Instead of performing sub-sampling only in a horizontal direction, sub-sampling may be performed only in a vertical direction or sub-sampling may be performed in both a vertical direction and a horizontal direction to determine some pixels used to derive the coefficient of a linear model.

As another example, a downsampling filter may be applied to a template to derive the coefficient of a linear model only with downsampled pixels.

FIG. 45 shows an example in which a downsampling filter is applied to a template.

Let's assume that the value of pixel i belonging to template A is Y_{A}(i) and the value of pixel i belonging to template B is Y_{B}(i). Here, i represents a value indicating one of the pixels included in a template. For example, when N pixels are included in template A and template B, respectively, i may be one of 1 to N.

Downsampling may be performed on a template to derive N_{sub} downsampled pixels (i.e., a representative value). Here, N_{sub} may be equal to or less than N, the number of pixels included in a template. In this case, a position to which a downsampling filter is applied may be determined based on at least one of the width W and the height H of a target block.

As an example, let's assume that the top-left coordinate of a target block is (x₀, y₀). As in an example shown in FIG. 45, when a 6-tap downsampling filter is applied, representative values t₁ to t₄ within template A may be derived as in Equations 20 to 23 below.

$${t}_{1} = avg ( ( {x}_{0} - \frac{W}{4} - 1 , {y}_{0} - 1 ) , ( {x}_{0} + \frac{W}{4} - 1 , {y}_{0} - 2 ) , ( {x}_{0} + \frac{W}{4} , {y}_{0} - 1 ) , ( {x}_{0} + \frac{W}{4} , {y}_{0} - 2 ) , ( {x}_{0} - \frac{W}{4} + 1 , {y}_{0} - 1 ) , ( {x}_{0} - \frac{W}{4} + 1 , {y}_{0} - 2 ) \qquad [ Equation 20 ]$$

$${t}_{2} = avg ( ( {x}_{0} - \frac{3 W}{4} - 1 , {y}_{0} - 1 ) , ( {x}_{0} + \frac{3 W}{4} - 1 , {y}_{0} - 2 ) , ( {x}_{0} + \frac{3 W}{4} , {y}_{0} - 1 ) , ( {x}_{0} + \frac{3 W}{4} , {y}_{0} - 2 ) , ( {x}_{0} - \frac{3 W}{4} + 1 , {y}_{0} - 1 ) , ( {x}_{0} - \frac{3 W}{4} + 1 , {y}_{0} - 2 ) \qquad [ Equation 21 ]$$

$${t}_{3} = avg ( ( {x}_{0} - 1 , {y}_{0} + \frac{H}{4} - 1 ) , ( {x}_{0} - 2 , {y}_{0} + \frac{H}{4} - 1 ) , ( {x}_{0} - 1 , {y}_{0} + \frac{H}{4} ) , ( {x}_{0} - 2 , {y}_{0} + \frac{H}{4} ) , avg ( ( {x}_{0} - 1 , {y}_{0} + \frac{H}{4} + 1 ) , avg ( ( {x}_{0} - 2 , {y}_{0} + \frac{H}{4} + 1 ) \qquad [ Equation 22 ]$$

$${t}_{4} = avg ( ( {x}_{0} - 1 , {y}_{0} + \frac{3 H}{4} - 1 ) , ( {x}_{0} - 2 , {y}_{0} + \frac{3 H}{4} - 1 ) , ( {x}_{0} - 1 , {y}_{0} + \frac{3 H}{4} ) , ( {x}_{0} - 2 , {y}_{0} + \frac{3 H}{4} ) , avg ( ( {x}_{0} - 1 , {y}_{0} + \frac{3 H}{4} + 1 ) , avg ( ( {x}_{0} - 2 , {y}_{0} + \frac{3 H}{4} - 1 ) \qquad [ Equation 23 ]$$

In the example of Equations 20 to 23, an avg (a, b) function represents a function that returns the average of a pixel value at the position of a and a pixel value at the position of b.

When N_{sub} representative values are calculated, they are classified into a first representative value group and a second representative value group according to the size of representative values. A first representative value group may include N_{sub}/2 large representative values among N_{sub} representative values and a second representative value group may include N_{sub}/2 small representative values among N_{sub} representative values. As an example, let's assume that when representative values t₁ to t₄ are ordered in descending order, they are ordered like {t₁≥t₃≥t₂≥t₄}. In this case, two large representative values tᵢ and t₃ may be classified into a first representative value group and two small representative values t₂ and t₄ may be classified into a second representative value group.

Afterwards, the first average value T₁^{A} of representative values included in a first representative value group and the second average value T₂^{A} of representative values included in a second representative value group may be obtained. In other words, an average value T₁^{A} may be derived by averaging representative values t₁ and t₃ included in a first representative value group and an average value T₂^{A} may be derived by averaging representative values t₂ and t₄ included in a second representative value group.

In the same manner as described above, a first average value T₁^{B} for a first representative value group and a second average value T₂^{B} for a second representative value group may be obtained in template B as well.

Afterwards, two average values obtained from template A and two average values obtained from template B may be used to derive a coefficient for a linear model, as in Equation 24 below.

$$α = \frac{{T}_{1}^{A} - {T}_{2}^{A}}{{T}_{1}^{B} - {T}_{2}^{B}} \qquad [ Equation 24 ]$$

$$β = {T}_{2}^{A} - α \cdot {T}_{2}^{B}$$

Meanwhile, a syntax element (e.g., lic_bm_mode) showing whether LIC-based BM prediction is applied to a target block may be encoded and signaled.

As an example, when the value of lic_bm_mode is a first value, it shows that LIC-based BM prediction is applied to a target block. In this case, a modified BM optimal block may be set as the prediction signal of a target block. On the other hand, when the value of lic_bm_mode is a second value, it shows that LIC-based BM prediction is not applied to a target block. In this case, an unmodified BM optimal block may be set as the prediction signal of a target block or the prediction signal of a target block may be set through intra prediction, inter prediction or IBC prediction.

### [D3-5] Intra and BM Blending Prediction

A target block may be encoded/decoded by using a BM optimal block and a prediction signal obtained through intra prediction (hereinafter, referred to as an intra prediction signal (or an intra prediction block)). It may be called ‘intra and BM blending prediction’.

When intra and BM blending prediction is applied, the prediction block of a target block may be calculated by the average, weighted combination or weighted summation of an intra prediction block and a BM optimal block.

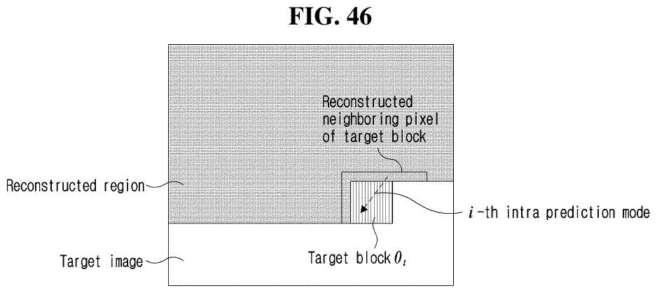

FIG. 46 is a drawing for describing an application aspect of intra and BM blending prediction.

When intra and BM blending prediction is applied, the final prediction block of a target block may be obtained based on the intra prediction block and the BM optimal block of a target block.

As an example, a residual signal Res_{BM_Intra}(x, y) for the position of (x, y) within a target block may be derived as in Equation 25 below.

$${Res}_{BM\_intra} ( x , y ) = {O}_{t} ( x , y ) - ( {w}_{1} \cdot {P}_{BM} ( x , y ) + {w}_{2} \cdot {p}_{t , {m}_{i}} ( x , y ) ) \qquad [ Equation 25 ]$$

In Equation 25 above, Oₜ(x, y) represents an original signal at the position of (x, y) within a target block. P_{BM} (x, y) represents a signal at the position of (x, y) within a BM optimal block. P_{t,mi} (x, y) represents a prediction signal obtained based on an intra prediction mode whose index is i at the position of (x, y) within a target block. As in an example shown in Equation 22, a final prediction signal at the position of (x, y) within a target block may be obtained through the weighted prediction of a signal P_{BM}(x, y) within a BM optimal block and an intra prediction signal P_{t,mi}(x, y).

Meanwhile, in Equation 25, w₁ represents a weight applied to a BM optimal block and w₂ represents a weight applied to an intra prediction signal.

A weight set including w₁ and w₂ may be adaptively determined based on at least one of the size/shape of a target block, an intra prediction mode, the intra prediction mode of a neighboring block, whether BM is applied to a neighboring block or whether the cost of a BM optimal block is less than a threshold value.

As an example, as the cost of a BM optimal block is smaller, a weight wᵢ applied to a BM optimal block may have a larger value and a weight w₂ applied to an intra prediction signal may have a smaller value. On the other hand, as the cost of a BM optimal block is larger, a weight w₁ applied to a BM optimal block may have a smaller value and a weight w₂ applied to an intra prediction signal may have a larger value.

Alternatively, information for determining a weight set may be explicitly encoded and signaled. As an example, an index indicating one of a plurality of weight set candidates may be encoded and signaled.

The residual signal Res_{BM_Intra}(x, y) of a target block may be derived by subtracting a final prediction signal from the original signal of a target block. The residual signal of a target block may be encoded and signaled. In a decoder, the residual signal of a target block may be decoded and a final prediction signal may be added to a residual signal to derive a reconstructed signal. As an example, a reconstructed signal at the position of (x, y) within a target block may be derived as in the example of Equation 26 below.

$$R e {c}_{t} ( x , y ) = ( {w}_{1} \cdot {P}_{BM} ( x , y ) + {w}_{2} \cdot {P}_{t , {m}_{i}} ( x , y ) ) + {Res}_{BM\_Intra} ( x , y ) \qquad [ Equation 26 ]$$

Let's assume that the intra prediction mode of a target block is a planar mode. When the value of a weight w₁ applied to a BM optimal block is the same as the value of a weight w₂ applied to an intra prediction signal (e.g., ½), Equation 25 may be modified and indicated as in Equation 27 below.

$${Res}_{BM\_Intra} ( x , y ) = {O}_{t} ( x , y ) - ( {P}_{B M} ( x , y ) + {P}_{t , Planar} ( x , y ) + offset ) ≫ shift \qquad [ Equation 27 ]$$

In addition, Equation 26 may be modified and indicated as in Equation 28 below.

$$R e {c}_{t} ( x , y ) = ( {P}_{BM} ( x , y ) + {{P}_{t , m}}_{i} ( x , y ) + offset ) ≫ shift + {Res}_{BM\_Intra} ( x , y ) \qquad [ Equation 28 ]$$

In Equation 27, P_{t,Planar}(x, y) represents a prediction signal obtained based on a planar mode at the position of (x, y) within a target block. As in the example of Equations 27 and 28, the final prediction signal of a target block may be expressed as ((P_{BM}(x, y)+P_{t,Planar}(x, y)+offset)>>shift).

In this case, shift represents a shifting parameter for calculating an average. The shifting parameter may be determined based on at least one of Internal Bit Depth (IBD) and Sample Bit Depth (bitDepth). shift may have a value predefined in an encoder and a decoder. As an example, shift may be 1.

Alternatively, shift may be determined based on at least one of Internal Bit Depth (IBD) or Sample Bit Depth (bitDepth).

Alternatively, shift may be determined as in Max (3, (1+IBD)-bitDepth). Here, a function MAX (a, b) is a function that returns a larger value of a and b. When IBD is 14 and bitDepth is 10, shift may be set as 5. Alternatively, when IBD is 14 and bitDepth is 8, shift may be set as 7.

offset represents an offset parameter for rounding off. Offset may be determined based on at least one of Internal Bit Depth (IBD) or Sample Bit Depth (bitDepth).

As an example, offset may be set as the median value of a N-bit image. In other words, for a 10-bit image, it may be set as 512 and for a 8-bit image, offset may be set as 128.

As another example, offset may be derived as in (1<< (shift−1)).

When intra and BM blending prediction is applied to a target block, the intra prediction mode of a target block may be set as an intra prediction mode predefined in an encoder and a decoder. As an example, a predefined intra prediction mode may be at least one of a DC mode, a planar mode, a vertical mode, a horizontal mode or a diagonal mode (e.g., a top-right diagonal direction, a top-left diagonal direction or a bottom-left diagonal direction).

Alternatively, when intra and BM blending prediction is applied, the intra prediction mode of a target block may be set as one of the MPM candidates included in a MPM list. In this case, an index specifying one of the MPM candidates included in a MPM list may be encoded and signaled.

Alternatively, when intra and BM blending prediction is applied, an intra prediction mode applied to a BM reference block may be set as the intra prediction mode of a target block. As an example, when intra prediction modes of a first BM reference block and a second BM reference block are the same, the intra prediction mode may be set as the intra prediction mode of a target block.

Alternatively, when intra prediction modes of a first BM reference block and a second BM reference block are different from each other, one of the intra prediction mode of a first BM reference block and the intra prediction mode of a second BM reference block may be selected, and a selected intra prediction mode may be set as the intra prediction mode of a target block.

Alternatively, when intra prediction modes of a first BM reference block and a second BM reference block are different from each other, a first prediction signal for a target block may be obtained based on the intra prediction mode of a first BM reference block and a second prediction signal for a target block may be obtained based on the intra prediction mode of a second BM reference block. Afterwards, what is derived through the averaging or weighted summation of a first prediction signal and a second prediction signal may be set as the intra prediction signal of a target block.

Alternatively, when only any one of a first BM reference block and a second BM reference block is encoded/decoded by intra prediction, the intra prediction mode of a block encoded/decoded by intra prediction may be set as the intra prediction mode of a target block.

Alternatively, when both a first BM reference block and a second BM reference block are not encoded/decoded by intra prediction, a predefined intra prediction mode may be applied to a target block or the intra prediction mode of a target block may be selected from a MPM list.

A syntax element (e.g., intra_bm_blending_mode) showing whether intra and BM blending prediction is applied to a target block may be encoded and signaled.

As an example, when the value of intra_bm_blending_mode is a first value, intra and BM blending prediction may be applied to a target block. In this case, the prediction block of a target block may be obtained by blending an intra prediction block and a BM optimal block. On the other hand, when the value of intra_bm_blending_mode is a second value, intra and BM blending prediction may not be applied to a target block. In this case, the prediction block of a target block may be set as an intra prediction block or a BM optimal block.

Whether intra and BM blending prediction is allowed may be adaptively determined based on at least one of the size/shape of a target block, an intra prediction mode or whether ISP is applied.

As an example, it may be allowed to apply intra and BM blending prediction only when at least one of a case in which the intra prediction mode of a target block is one of the predefined candidates or a case in which ISP is not applied to a target block is satisfied.

### [D3-6] Inter and BM Blending Prediction

A target block may be encoded/decoded by using a BM optimal block and a prediction signal obtained through inter prediction (hereinafter, referred to as an inter prediction signal (or an inter prediction block)) together. It may be called ‘inter and BM blending prediction’.

When inter and BM blending prediction is applied, the prediction block of a target block may be calculated through the average, weighted combination or weighted summation of an inter prediction block and a BM optimal block.

Meanwhile, inter and BM blending prediction may be classified as follows.
P inter and BM blending prediction
B inter and BM blending prediction

P inter and BM blending prediction refers to encoding/decoding a target block by using a BM optimal block and a prediction signal obtained through the inter prediction (i.e., unidirectional prediction) of a P slice together.

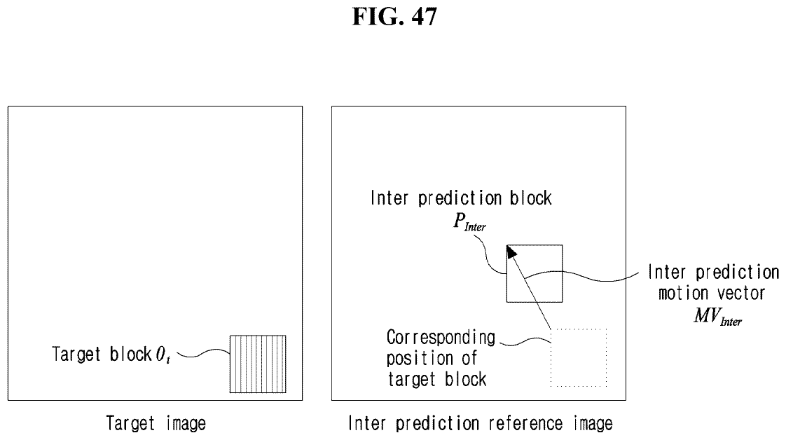

FIG. 47 is a drawing for describing an application aspect of inter and BM blending prediction.

When inter and BM blending prediction is applied, the final prediction block of a target block may be obtained based on the BM optimal block and inter prediction block of a target block.

As an example, when the motion vector MV_{Inter} of a target block is (x_{Inter}, y_{Inter}), a residual signal Res_{BM_Inter}(x, y) for the position of (x, y) within a target block may be derived as in Equation 29 below.

$${Res}_{BM\_Inter} ( x , y ) = {O}_{t} ( x , y ) - ( {w}_{1} \cdot {P}_{BM} ( x , y ) + {w}_{2} \cdot {P}_{Inter} ( x + {x}_{inter} , y + {y}_{inter} ) ) \qquad [ Equation 29 ]$$

In Equation 29 above, Oₜ(x, y) represents an original signal at the position of (x, y) within a target block. P_{BM} (x, y) represents a signal at the position of (x, y) within a BM optimal block. Pᵢₙₜₑᵣ (x+xᵢₙₜₑᵣ, y+yᵢₙₜₑᵣ) represents a prediction signal obtained by the motion vector of a target block. Specifically, the prediction signal may be obtained based on a sample at a position separated by the motion vector (xᵢₙₜₑᵣ, yᵢₙₜₑᵣ) of a target block from the position (x, y) of a target block within the reference image of a target block.

As in an example shown in Equation 29, a final prediction signal at the position of (x, y) within a target block may be obtained through the weighted prediction of a signal P_{BM}(x, y) within a BM optimal block and an inter prediction signal Pᵢₙₜₑᵣ(x+xᵢₙₜₑᵣ, y+yᵢₙₜₑᵣ).

Meanwhile, in Equation 29, w₁ represents a weight applied to a BM optimal block and w₂ represents a weight applied to an inter prediction signal.

A weight set including w₁ and w₂ may be adaptively determined based on at least one of the size/shape of a target block, whether BM is applied to a neighboring block or whether the cost of a BM optimal block is less than a threshold value.

As an example, as the cost of a BM optimal block is smaller, a weight w₁ applied to a BM optimal block may have a larger value and a weight w₂ applied to an inter prediction signal may have a smaller value. On the other hand, as the cost of a BM optimal block is greater, a weight w₁ applied to a BM optimal block may have a smaller value and a weight w₂ applied to an inter prediction signal may have a greater value.

Alternatively, information for determining a weight set may be explicitly encoded and signaled. As an example, an index indicating one of a plurality of weight set candidates may be encoded and signaled.

The residual signal Res_{BM_Inter}(x, y) of a target block may be derived by subtracting a final prediction signal from the original signal of a target block. The residual signal of a target block may be encoded and signaled. In a decoder, the residual signal of a target block may be decoded and a final prediction signal may be added to a residual signal to derive a reconstructed signal. As an example, a reconstructed signal at the position of (x, y) within a target block may be derived as in the example of Equation 30 below.

$$R e {c}_{t} ( x , y ) = ( {w}_{1} \cdot {P}_{BM} ( x , y ) + {w}_{2} \cdot {P}_{Inter} ( x + {x}_{inter} , y + {y}_{inter} ) ) + {Res}_{BM\_Inter} ( x , y ) \qquad [ Equation 30 ]$$

Let's assume that the motion vector MV Inter of a target block is (1, 2). When the value of a weight w₁ applied to a BM optimal block is the same as the value of a weight w₂ applied to an inter prediction signal (e.g., ½), Equation 29 may be modified and indicated as in Equation 31 below.

$${Res}_{BM\_Inter} ( x , y ) = {O}_{t} ( x , y ) - ( {P}_{B M} ( x , y ) + {w}_{2} \cdot {P}_{Inter} ( x + 1 , y + 2 ) + offset ) ≫ shift \qquad [ Equation 31 ]$$

In addition, Equation 30 may be modified and indicated as in Equation 32 below.

$$R e {c}_{t} ( x , y ) = ( {P}_{BM} ( x , y ) + {P}_{Inter} ( x + 1 , y + 2 ) + offset ) ≫ shift + {Res}_{BM\_Inter} ( x , y ) \qquad [ Equation 32 ]$$

In Equation 31, Pᵢₙₜₑᵣ(x+1, y+2) represents a prediction signal at the position of (x, y) within a target block, derived as the motion vector of a target block. As in the example of Equations 31 and 32, the final prediction signal of a target block may be expressed as ((P_{BM}(x, y)+Pᵢₙₜₑᵣ(x+1, y+2)+offset)>>shift).

In this case, shift represents a shifting parameter for calculating an average. The shifting parameter may be determined based on at least one of Internal Bit Depth (IBD) and Sample Bit Depth (bitDepth). shift may have a value predefined in an encoder and a decoder. As an example, shift may be 1.

Alternatively, shift may be determined based on at least one of Internal Bit Depth (IBD) or Sample Bit Depth (bitDepth).

Alternatively, shift may be determined as in Max (3, (1+IBD)-bitDepth). Here, a function MAX (a, b) is a function that returns a larger value of a and b. When IBD is 14 and bitDepth is 10, shift may be set as 5. Alternatively, when IBD is 14 and bitDepth is 8, shift may be set as 7.

offset represents an offset parameter for rounding off. Offset may be determined based on at least one of Internal Bit Depth (IBD) or Sample Bit Depth (bitDepth).

As an example, offset may be set as the median value of a N-bit image. In other words, for a 10-bit image, it may be set as 512 and for a 8-bit image, offset may be set as 128.

As another example, offset may be derived as in (1<<(shift−1)).

A syntax element (e.g., p_inter_bm_blending_mode) showing whether P inter and BM blending prediction is applied to a target block may be encoded and signaled.

As an example, when the value of p_inter_bm_blending_mode is a first value, P inter and BM blending prediction may be applied to a target block. In this case, the prediction block of a target block may be obtained by blending an inter prediction block and a BM optimal block.

On the other hand, when the value of p_inter_bm_blending_mode is a second value, P inter and BM blending prediction may not be applied to a target block. In this case, the prediction block of a target block may be set as an inter prediction block (i.e., a P inter prediction block) or a BM optimal block.

Which of an inter prediction block and a BM optimal block is set as the prediction block of a target block may be predefined in an encoder and a decoder. Alternatively, information indicating one of an inter prediction block and a BM optimal block may be encoded and signaled. One of an inter prediction block and a BM optimal block indicated by the information may be set as the prediction block of a target block.

Meanwhile, in performing inter prediction, an inter prediction block may be obtained by using a BM reference image as a reference image.

Alternatively, a syntax element (e.g., inter_bm_sharing_ref_flag) indicating whether a reference image for inter prediction is the same as a BM reference image may be encoded and signaled.

As an example, when the value of inter_bm_sharing_ref_flag is a first value, it shows that a reference image for the inter prediction of a target block is the same as a BM reference image. In this case, encoding/decoding of at least one of information for specifying a reference image for the inter prediction of a target block or information for specifying a BM reference image may be omitted.

On the other hand, when the value of inter_bm_sharing_ref_flag is a second value, it shows that a reference image for the inter prediction of a target block is not the same as a BM reference image. In this case, information indicating a reference image for the inter prediction of a target block and information for specifying a BM reference image may be encoded/decoded, respectively.

Alternatively, a first reference image in a reference image list may be set as a reference image for the inter prediction of a target block and encoding/decoding of information indicating a reference image for the inter prediction of a target block may be omitted.

Alternatively, a first reference image in a reference image list may be set as a BM reference image and encoding/decoding of information indicating a reference image for the inter prediction of a target block may be omitted.

Meanwhile, inter and BM blending prediction may be classified as follows.
P inter and BM blending prediction
B inter and BM blending prediction

B inter and BM Blending prediction refers to encoding/decoding a target block by using a BM optimal block and a prediction signal obtained through the inter prediction (i.e., unidirectional prediction or bidirectional prediction) of a B slice together.

As an example, when the first motion vector MV_{Inter_l0} of a target block is (x_{Inter_l0}, y_{Inter_l0}) and the second motion vector MV_{Inter_l1} of a target block is (x_{Inter_l1}, y_{Inter_l1}), a residual signal ReS_{BM_Inter_B} (x, y) for the position of (x, y) within a target block may be derived as in Equation 33 below.

$${Res}_{BM\_Inter \_B} ( x , y ) = {O}_{t} ( x , y ) - ( {w}_{1} \cdot {P}_{BM} ( x , y ) + {w}_{2} \cdot {P}_{Inter\_l 0} ( x + {x}_{Inter\_l 0} , y + {y}_{Inter\_l 0} ) + {w}_{3} \cdot {P}_{Inter\_l 1} ( x + {x}_{Inter\_l 1} , y + {y}_{Inter\_l 1} ) ) \qquad [ Equation 33 ]$$

In Equation 33 above, Oₜ(x, y) represents an original signal at the position of (x, y) within a target block. P_{BM}(x, y) represents a signal at the position of (x, y) within a BM optimal block. P_{inter_l0} (x+x_{inter_l0}, y+y_{inter_l0}) represents a first inter prediction signal obtained by the first motion vector of a target block. Specifically, a first inter prediction signal may be obtained based on a sample at a position separated by the first motion vector (x_{inter_l0}, y_{inter_l0}) of a target block from the position (x, y) of a target block within the first reference image of a target block. P_{inter_l1} (x+x_{inter_l1}, y+y_{inter_l1}) represents a second inter prediction signal obtained by the second motion vector of a target block. Specifically, a second inter prediction signal may be obtained based on a sample at a position separated by the second motion vector (x_{inter_l1}, y_{inter_l1}) of a target block from the position (x, y) of a target block within the second reference image of a target block.

As in an example shown in Equation 33, a final prediction signal at the position of (x, y) within a target block may be obtained through the weighted prediction of a signal P_{BM}(x, y) within a BM optimal block, a first inter prediction signal prediction P_{inter_l0} (x+x_{inter_l0}, y+y_{inter_l0}) and a second inter prediction signal P_{inter_l1} (x+x_{inter_l1}, y+y_{inter_l1}).

Meanwhile, in Equation 33, w₁ represents a weight applied to a BM optimal block, w₂ represents a weight applied to a first inter prediction signal and w₃ represents a weight applied to a second inter prediction signal.

A weight set including w₁, w₂ and w₃ may be adaptively determined based on at least one of the size/shape of a target block, whether BM is applied to a neighboring block or whether the cost of a BM optimal block is less than a threshold value.

As an example, as the cost of a BM optimal block is smaller, a weight w₁ applied to a BM optimal block may have a greater value and weights w₂ and w₃ applied to inter prediction signals may have a smaller value. On the other hand, as the cost of a BM optimal block is greater, a weight w₁ applied to a BM optimal block may have a smaller value and weights w₂ and w₃ applied to inter prediction signals may have a greater value.

Alternatively, information for determining a weight set may be explicitly encoded and signaled. As an example, an index indicating one of a plurality of weight set candidates may be encoded and signaled.

Alternatively, the weighted summation operation of a first inter prediction signal and a second inter prediction signal may be performed to obtain the final inter prediction signal of a target block, and then the weighted summation of a BM optimal block and a final inter prediction signal may be performed to obtain the final prediction signal of a target block.

In this case, a weight w₂ applied to a first inter prediction signal and a weight w₃ applied to a second inter prediction signal may be derived from a neighboring block adjacent to a target block or may be set by an index indicating one of a plurality of weight sets. As an example, weights w₂ and w₃ may be determined based on bcw_idx decoded from a bitstream.

bcw_idx may indicate one of a plurality of weight candidates. As an example, one of w₂ and w₃ may be set to be the same as a weight candidate indicated by bcw_idx and the other may be derived by subtracting the weight candidate from a predefined constant.

Meanwhile, a weight applied to a BM optimal block and a weight applied to a final inter prediction signal may be determined in the same manner as determining a weight w₁ applied to a BM optimal block and a weight w₂ applied to an inter prediction signal in prediction using the BM of a P slice.

The residual signal Res_{BM_Inter_B} (x, y) of a target block may be derived by subtracting a final prediction signal from the original signal of a target block. The residual signal of a target block may be encoded and signaled. In a decoder, the residual signal of a target block may be decoded and a final prediction signal may be added to a residual signal to derive a reconstructed signal. As an example, a reconstructed signal at the position of (x, y) within a target block may be derived as in the example of Equation 34 below.

$${Rec}_{t} ( x , y ) = ( {w}_{1} \cdot {P}_{BM} ( x , y ) + {w}_{2} \cdot {P}_{Inter\_l 0} ( x + {x}_{inter\_l 0} , y + {y}_{inter\_l 0} ) + {w}_{3} \cdot {P}_{Inter\_l 1} ( x + {x}_{inter\_l 1} , y + {y}_{inter\_l 1} ) ) + {Res}_{BM\_Inter \_B} ( x , y ) \qquad [ Equation 34 ]$$

Let's assume that the first motion vector MV_{Inter_l0} of a target block is (1, 2) and a second motion vector MV_{Inter_l1} is (2, 3). When values of a weight wᵢ applied to a BM optimal block, a weight w₂ applied to a first inter prediction signal and a weight w₃ applied to a second inter prediction signal are all the same (e.g., ⅓), Equation 33 may be modified and indicated as in Equation 35 below.

$${Res}_{BM\_Inter \_B} ( x , y ) = {O}_{t} ( x , y ) - ( \frac{1}{3} \cdot {P}_{BM} ( x , y ) + \frac{1}{3} \cdot {P}_{Inter\_l 0} ( x + 1 , y + 2 ) + \frac{1}{3} \cdot {P}_{Inter\_l 1} ( x + 2 , y + 3 ) ) \qquad [ Equation 35 ]$$

In addition, Equation 34 may be modified and indicated as in Equation 36 below.

$${Rec}_{t} ( x , y ) = ( \frac{1}{3} \cdot {P}_{BM} ( x , y ) + \frac{1}{3} \cdot {P}_{Inter\_l 0} ( x + 1 , y + 2 ) + \frac{1}{3} \cdot {P}_{Inter\_l 1} ( x + 2 , y + 3 ) ) + {Res}_{BM\_Inter \_B} ( x , y ) \qquad [ Equation 36 ]$$

In Equation 35, P_{inter_l0}(x+1, y+2) represents a first inter prediction signal at the position of (x, y) within a target block, derived from the first motion vector of a target block. In addition, P_{inter_l1}(x+2, y+3) represents a second inter prediction signal at the position of (x, y) within a target block, derived from the second motion vector of a target block. As in the example of Equations 35 and 36, the final prediction signal of a target block may be expressed as ((P_{BM}(x, y)/3+P_{inter_l0}(x+1, y+2)/3+p_{inter_l1}(x+2, y+3)/3).

A syntax element (e.g., b_inter_bm_blending_mode) showing whether B inter and BM blending prediction is applied to a target block may be encoded and signaled.

As an example, when the value of b_inter_bm_blending_mode is a first value, B inter and BM blending prediction may be applied to a target block. In this case, the prediction block of a target block may be obtained by blending a first inter prediction block, a second inter prediction block and a BM optimal block.

On the other hand, when the value of b_inter_bm_blending_mode is a second value, P inter and BM blending prediction may not be applied to a target block. In this case, the prediction block of a target block may be set as a final inter prediction block or may be set as a BM optimal block. In this case, a final inter prediction block may be obtained through the weighted summation operation of a first inter prediction block and a second inter prediction block.

Which of a final inter prediction block and a BM optimal block is set as the prediction block of a target block may be predefined in an encoder and a decoder. Alternatively, information indicating one of a final inter prediction block and a BM optimal block may be encoded and signaled. One of a final inter prediction block and a BM optimal block indicated by the information may be set as the prediction block of a target block.

Meanwhile, in performing inter prediction, an inter prediction block may be obtained by using a BM reference image as a reference image.

Alternatively, a syntax element (e.g., inter_bm_sharing_ref_flag) indicating whether a reference image for inter prediction is the same as a BM reference image may be encoded and signaled.

As an example, when the value of inter_bm_sharing_ref_flag is a first value, it shows that a reference image for the inter prediction of a target block is the same as a BM reference image. In this case, encoding/decoding of at least one of information for specifying a reference image for the inter prediction of a target block or information for specifying a BM reference image may be omitted.

On the other hand, when the value of inter_bm_sharing_ref_flag is a second value, it shows that a reference image for the inter prediction of a target block is not the same as a BM reference image. In this case, information indicating a reference image for the inter prediction of a target block and information for specifying a BM reference image may be encoded/decoded, respectively.

Alternatively, a first reference image in a reference image list may be set as a reference image for the inter prediction of a target block and encoding/decoding of information indicating a reference image for the inter prediction of a target block may be omitted.

Alternatively, a first reference image in a reference image list may be set as a BM reference image and encoding/decoding of information indicating a reference image for the inter prediction of a target block may be omitted.

Meanwhile, the syntax element may be encoded and signaled for a L0 direction and a L1 direction, respectively.

At least one of the listed [D3-1] to [D3-6] may be used in encoding/decoding a target block. However, step [D3] is not necessarily used in encoding/decoding an image. As an example, the performance of step [D3] is omitted, and a step disclosed in [D1] to [D2] may be used to refine the motion vector of a target block.

A refined motion vector obtained through BM-based motion vector refinement may be set as the final motion vector of a target block and motion compensation for a target block may be performed based on the final motion vector of a target block. In this case, the refinement of a motion vector may be performed according to the same rule in an encoder and a decoder.

A motion vector refinement process may be configured as a multi-pass process. A multi-pass refinement process may include the following steps.

### 1) First Pass-Block-Based BM Motion Vector Refinement

Based on the initial motion vector of a target block, a BM reference block within the search region of a BM reference image is determined. Specifically, based on a first initial motion vector and a second initial motion vector, a pair of a first BM reference block and a second reference block having the lowest matching criteria may be determined from a first BM reference image and a second reference image.

A distance between a first initial motion vector and a first BM reference block may be set as a first block level refinement vector and a distance between a second initial motion vector and a second BM reference block may be set as a second block level refinement vector.

The block level motion vector of a target block may be derived by adding an initial motion vector and a block level refinement vector. In other words, a first block level motion vector may be derived as a value obtained by combining a first initial motion vector and a first block level refinement vector and a second block level motion vector may be derived as a value obtained by combining a second initial motion vector and a second block level refinement vector.

### 2) Second Pass-Sub-Block-Based BM Motion Vector Refinement

A target block may be divided into a plurality of sub-blocks, and based on the block level motion vector of a target block, BM motion vector refinement may be performed in a unit of a sub-block within a target block. Specifically, a block level motion vector derived through a first pass may be set as the initial motion vector of each sub-block and BM search may be performed on each sub-block. For convenience of a description, the initial motion vector of a sub-block is referred to as an initial sub-block motion vector.

As an example, based on a first initial sub-block motion vector and a second initial sub-block motion vector, a pair of a first BM sub-reference block and a second sub-reference block having the lowest matching criteria may be determined from a first BM reference image and a second reference image.

A distance between a first initial sub-block motion vector and a first BM sub-reference block may be set as a first sub-block level refinement vector and a distance between a second initial sub-block motion vector and a second BM sub-reference block may be set as a second sub-block level refinement vector.

Meanwhile, the size of a sub-block may be predefined in an encoder and a decoder. Alternatively, the size or shape of a sub-block may be adaptively determined according to the size or shape of a target block.

The size of a BM search region in a first pass may be different from the size of a BM search region in a second pass. As an example, the size of a BM search region in a first pass may be determined based on the size of a target block, while the size of a BM search region in a second pass may be determined based on the size of a sub-block.

Alternatively, the shape of a BM search region in a first pass may be different from the shape of a BM search region in a second pass. As an example, a BM search region in a first pass may be square/rectangular, while a BM search region in a second pass may be rhombic.

Alternatively, a cost function used to calculate matching criteria in a first pass may be different from a cost function used to calculate matching criteria in a second pass. As an example, in a first pass, matching criteria may be calculated based on SAD, while in a second pass, matching criteria may be calculated based on SATD.

A sub-block motion vector for a sub-block may be derived by adding a sub-block level refinement vector to the initial sub-block motion vector of a sub-block. In other words, a first sub-block motion vector may be derived by adding a first sub-block level refinement vector to a first initial sub-block motion vector and a second sub-block motion vector may be derived by adding a second sub-block level refinement vector to a second initial sub-block motion vector. Here, a first sub-block level refinement vector represents a distance between a first initial sub-block motion vector and a first BM reference sub-block and a second sub-block level refinement vector represents a distance between a second initial sub-block motion vector and a second BM reference sub-block.

### 3) Third Pass—Bi-Directional Optical Flow (BDOF)-Based Motion Vector Refinement

BDOF may be applied to a sub-block to refine a sub-block motion vector obtained in a second pass. Specifically, a sub-block may be partitioned into a plurality of sub-blocks again, and a refinement vector may be derived for each partitioned sub-block by applying BDOF.

As an example, when a sub-block motion vector is derived in a unit of a 16×16-sized sub-block, a 16×16-sized sub-block may be partitioned again into 8×8 or 4×4-sized sub-blocks and a refinement vector may be derived for each partitioned sub-block through BDOF. Afterwards, a refinement vector may be added to a sub-block motion vector to derive the final sub-block motion vector of a partitioned sub-block.

When the final motion vector of a sub-block is derived, motion compensation for a sub-block may be performed based on a derived final motion vector.

Meanwhile, the final motion vector of a sub-block may be derived by omitting any one of a second pass and a third pass described above. As an example, a sub-block motion vector obtained in a second pass may be set as a final sub-block motion vector. Alternatively, based on a block level motion vector obtained in a first pass, the final motion vector of a sub-block may be derived by performing BDOF in a unit of a sub-block.

Meanwhile, a third pass process may be repeatedly performed while reducing the size of a sub-block. As an example, a sub-block is partitioned into ¼-sized sub-blocks to perform BDOF, but when the size of a partitioned sub-block does not reach a predefined size, a third pass may be applied again.

As an example, let's assume that a predefined size is 4×4 and a sub-block in a second pass has a size of 16×16. In this case, a 16×16-sized sub-block may be partitioned into 8×8-sized sub-blocks to apply BDOF. As a result, a refined sub-block motion vector may be derived in a unit of a 8×8-sized sub-block.

Meanwhile, since the size of a sub-block does not reach 4×4, a 8×8-sized sub-block may be partitioned again to apply BDOF. As a result, a re-refined sub-block motion vector may be derived in a unit of a 4×4-sized sub-block. Since the size of a sub-block reaches 4×4, the motion vector of a re-refined sub-block may be used as a final sub-block motion vector to terminate motion vector refinement.

Motion vector refinement using a BM method may also be applied to a merge candidate. In other words, at least one of the L0 motion vector or the L1 motion vector of a merge candidate may be refined by using motion vector refinement.

As an example, the motion vector of a merge candidate may be set as the initial motion vector of a target block, and then a BM reference block may be derived through BM search. Afterwards, the motion vector of a merge candidate may be refined by using a refinement vector and the motion vector of a merge candidate may be updated to a refined motion vector.

Alternatively, while maintaining a pre-refinement merge candidate as it is, a merge candidate with a refined motion vector may be newly added to a merge candidate list.

As another example, one of the merge candidates included in a merge candidate list may be selected, and when the motion information of a selected merge candidate satisfies a DMVR performance condition, refinement on the motion vector of a selected merge candidate may be performed. As an example, refinement on the motion vector of a selected merge candidate may be performed based on the above-described multi-pass motion vector refinement.

As above, when refining a motion vector derived from a merge candidate, the performance of a first pass may be omitted. In other words, a first block level refinement vector and/or a second block level refinement vector may be assumed to be 0 and the process of a second pass or a third pass may be performed.

Alternatively, when refining a motion vector derived from a merge candidate, any one of a first block level refinement vector or a second block level refinement vector may be assumed to be 0 in a first pass and the process of a second pass or a third pass may be performed.

Meanwhile, in the above-described example, a DMVR performance condition may include at least one of whether a selected merge candidate has bidirectional motion information, whether the first reference image and the second reference image of a selected merge candidate are in a different direction or whether a first distance between the first reference image of a selected merge candidate and a target picture is the same as a second distance between a second reference image and a target picture. Whether to refine a motion vector derived from a merge candidate may be determined according to whether the motion information of a selected merge candidate satisfies a DMVR performance condition.

Alternatively, a merge mode where motion vector refinement based on a BM method is performed may be defined as a new merge mode. For example, information showing whether a merge mode where motion vector refinement based on a BM method is performed (hereinafter, referred to as a BM merge mode) is applied to a target block may be encoded and signaled. The information may be encoded and signaled when it is determined that a regular merge mode is not applied to a target block, i.e., when the value of regular_merge_flag is 0.

When it is determined that a BM merge mode is applied to a target block, on a merge candidate list, only merge candidates satisfying a DMVR performance condition may be included in a merge candidate list. Meanwhile, a merge candidate included in a merge candidate list may be derived from a spatial neighboring block, a spatial non-neighboring block or a temporal neighboring block or may be one of a candidate included in a HMVP list or a pair-wise merge candidate. In other words, when a block or a candidate to be included in a merge candidate list does not satisfy a DMVR performance condition, a corresponding block or a corresponding candidate may be determined to be unavailable under a BM merge mode and may not be added to a merge candidate list.

When an affine motion model or Sub-block Temporal Motion Vector Prediction (SbTMVP) is applied, a motion vector may be derived in a unit of a sub-block within a target block. In this case, a BM method described above may be applied to each sub-block within a target block.

As an example, steps [D1] to [D2] may be applied to perform refinement on the motion vector of a sub-block, or step [D3] may be additionally applied to derive a BM optimal block for a sub-block and a BM optimal block may be used to encode/decode a sub-block.

Meanwhile, in applying a BM method to a sub-block, the control point motion vector of a target block (when an affine motion model is applied) or the motion vector of a sub-block derived from a corresponding sub-block within a reference image (when SbTMVP is applied) may be set as the initial motion vector of a sub-block.

Meanwhile, information showing whether motion vector refinement using a BM method is performed for a sub-block may be encoded and signaled. As an example, in addition to a general affine merge mode, an affine merge mode where motion vector refinement is performed based on a BM method (hereinafter, referred to as an affine BM merge mode) may be defined separately. As an example, when an affine motion model is applied to a target block, one of an affine merge mode, an affine BM merge mode or an affine AMVP mode may be applied to a target block.

When an affine motion model is applied to a target block, a translation motion vector for a sub-block may be derived by using the control point motion vectors of a target block. Specifically, a translation motion vector for a sub-block may be derived based on non-translation parameters derived based on control point motion vectors. In order to derive a translation motion vector for a sub-block, four or six non-translation parameters may be used.

Meanwhile, after performing BM-based motion vector refinement for each sub-block, refinement for the control point motion vectors of a target block may be performed by synthesizing results of performing refinement for sub-blocks.

Specifically, BM-based motion vector refinement is performed for each sub-block and the matching criteria value of each sub-block is accumulated and stored. In this case, motion vector refinement for each sub-block may include at least one of refinement in a unit of an integer pixel or refinement in a unit of a decimal pixel.

Next, the refined motion vector of sub-blocks derived by BM-based motion vector refinement is input and the control point motion points of a target block are output through linear regression analysis.

Specifically, non-translation parameters may be modified so that the sum of matching criteria of sub-blocks is reduced, and the refined control point motion vectors of a target block may be output by using modified non-translation parameters.

In this case, one of the control point motion vectors may be set as a basic vector. A basic vector may be kept unmodified, and one or two residual control point motion vectors may be modified by modified non-translation parameters.

In the above-described BM method, any one of the first initial motion vector or the second initial motion vector of a target block may be derived based on an AMVP mode and the other may be derived based on a merge mode. In this case, when a selected AMVP candidate and a selected merge candidate satisfy a DMVR condition, a BM method may be applied to a target block.

As an example, when at least one of a case in which any one of a first reference image determined in an AMVP mode and a second reference image determined in a merge mode is a past image and the other is a future image or a case in which a first distance between a first reference image and a target image is the same as a second distance between a target image and a second reference image is satisfied, a BM method may be performed based on a motion vector determined in an AMVP mode and a motion vector determined in a merge mode.

Meanwhile, in order to derive an initial motion vector for a L0 direction or a L1 direction based on an AMVP mode, a motion vector difference value and an index indicating one of the candidates included in an AMVP candidate list may be encoded and signaled. In addition, a reference picture index for specifying a BM reference image for a L0 direction or a L1 direction may be encoded and signaled.

Alternatively, when an initial motion vector is derived based on an AMVP mode, encoding/decoding of a motion vector difference value may be omitted and a motion vector prediction value may be set as an initial motion vector.

When information on a L0 or L1 direction is derived by AMVP encoding information, information on the other direction of a L0 or L1 direction may be derived from a merge candidate. As an example, when L0 direction information for performing a BM method is derived by AMVP encoding information, L1 direction information for performing a BM method may be derived from a merge candidate. Accordingly, a merge candidate that does not have motion information in a different direction from motion information derived by AMVP encoding information may be determined to be unavailable.

When configuring a merge candidate list, an unavailable merge candidate may be set not to be included or a merge index may be set to indicate one of the available merge candidates among the merge candidates included in a merge candidate list. As an example, when M of N merge candidates included in a merge candidate list are unavailable, a merge index may be encoded and signaled as a value from 0 to (N−M−1).

As another example, BM search may be performed based on the first direction motion information derived by AMVP encoding information and the second direction motion information of an available merge candidate. As a result of BM search for an available merge candidate, the lowest matching criteria value may be output.

BM search as above may be performed on all available merge candidates in a merge candidate list. Afterwards, the matching criteria value of each merge candidate may be compared to select a merge candidate with the lowest matching criteria value. In this case, a merge candidate in a merge candidate list may be selected without encoding/decoding a merge index.

Afterwards, motion information derived based on AMVP encoding information and motion information derived based on a selected merge candidate may be used to apply a BM method to a target block.

At least one of steps [D1] to [D3] may be allowed when the size of a target block is larger than a predetermined size. In other words, at least one of steps [D1] to [D3] may not be allowed when the size of a target block is smaller than a predetermined size. A BM-based encoding method may be allowed when the size of a target block is larger than a predetermined size. In other words, a BM-based encoding method may not be allowed when the size of a target block is smaller than a predetermined size.

The block may be at least one of an encoding tree block, an encoding block, a prediction block, a transform block, a VPDU or a block in a predetermined size.

For example, a predetermined size above may be the maximum CTU.

For example, a predetermined size above may be the maximum CTU size>>1 (=maximum CTU size/2).

For example, a predetermined size above may be 1 VPDU.

For example, a predetermined size above may be VPDU size>>2 (=VPDU size/4).

A predetermined size above may be M×N, and in this case, M and N may be a positive integer.

At least one of steps [D1] to [D3] may be allowed when the size of a target block is smaller than a predetermined size. In other words, at least one of steps [D1] to [D3] may not be allowed when the size of a target block is larger than a predetermined size. A BM-based encoding method may be allowed when the size of a target block is smaller than a predetermined size. In other words, a BM-based encoding method may not be allowed when the size of a target block is larger than a predetermined size

The block may be at least one of an encoding tree block, an encoding block, a prediction block, a transform block, a VPDU or a block in a predetermined size.

For example, a predetermined size above may be the maximum CTU.

For example, a predetermined size above may be the maximum CTU size>>1 (=maximum CTU size/2).

For example, a predetermined size above may be 1 VPDU.

For example, a predetermined size above may be VPDU size>>2 (=VPDU size/4).

A predetermined size above may be M×N, and in this case, M and N may be a positive integer.

At least one of steps [D1] to [D3] may be allowed according to the encoding mode of a neighboring block of a target block. In other words, at least one of steps [D1] to [D3] may not be allowed according to the encoding mode of a neighboring block. A BM-based encoding method may be allowed according to the encoding mode of a neighboring block of a target block. In other words, a BM-based encoding method may not be allowed according to the encoding mode of a neighboring block.

The block may be at least one of an encoding tree block, an encoding block, a prediction block, a transform block, a VPDU or a block in a predetermined size.

At least one of embodiments 1 to 3 below may be applied.

1. At least one of steps [D1] to [D3] may be allowed only when the adjacent pixel (or block) of a target block is intra-encoded (intra-coded block). In other words, at least one of steps [D1] to [D3] may not be allowed when the adjacent pixel (or block) of a target block is not intra-encoded. A BM-based encoding method may be allowed when the adjacent pixel (or block) of a target block is intra-encoded. In other words, a BM-based encoding method may not be allowed when the adjacent pixel (or block) of a target block is not intra-encoded. In addition, when the adjacent pixel (or block) of a target block is not intra-encoded, at least one of steps [D1] to [D3] may not include a pixel which is not intra-encoded.

2. At least one of steps [D1] to [D3] may be allowed only when the adjacent pixel (or block) of a target block is inter-encoded (intra-coded block). In other words, at least one of steps [D1] to [D3] may not be allowed when the adjacent pixel (or block) of a target block is not inter-encoded. A BM-based encoding method may be allowed when the adjacent pixel (or block) of a target block is inter-encoded. In other words, a BM-based encoding method may not be allowed when the adjacent pixel (or block) of a target block is not inter-encoded. In addition, when the adjacent pixel (or block) of a target block is not inter-encoded, at least one of steps [D1] to [D3] may not include a pixel which is not inter-encoded.

3. At least one of steps [D1] to [D3] may be allowed only when the adjacent pixel (or block) of a target block is encoded in an intra block copy mode. In other words, at least one of steps [D1] to [D3] may not be allowed when the adjacent pixel (or block) of a target block is not encoded in an intra block copy mode. A BM-based encoding method may be allowed when the adjacent pixel (or block) of a target block is encoded in an intra block copy mode. In other words, a BM-based encoding method may not be allowed when the adjacent pixel (or block) of a target block is not encoded in an intra block copy mode. In addition, when the adjacent pixel (or block) of a target block is not encoded in an intra block copy mode, at least one of steps [D1] to [D3] may not include a pixel which is not encoded in an intra block copy mode.

At least two of 1 to 3 above may be applied in combination.

As an example, at least one of steps [D1] to [D3] may be allowed only when the adjacent pixel (or block) of a target block is intra-encoded or is encoded in an intra block copy mode. In other words, at least one of steps [D1] to [D3] may not be allowed when the adjacent pixel (or block) of a target block is not intra-encoded or is not encoded in an intra block copy mode. A BM-based encoding method may be allowed when the adjacent pixel (or block) of a target block is intra-encoded or is encoded in an intra block copy mode. In other words, a BM-based encoding method may not be allowed when the adjacent pixel (or block) of a target block is not intra-encoded or is not encoded in an intra block copy mode. In addition, when the adjacent pixel (or block) of a target block is not intra-encoded or is not encoded in an intra block copy mode, at least one of steps [D1] to [D3] may not include a pixel which is not intra-encoded or is not encoded in an intra block copy mode.

The embodiments may be performed using the same method by the encoding apparatus 1600 and by the decoding apparatus 1700. Also, the image may be encoded/decoded using at least one of the embodiments or at least one combination thereof.

The order of application of the embodiments may be different from each other by the encoding apparatus 1600 and the decoding apparatus 1700, and the order of application of the embodiments may be (at least partially) identical to each other by the encoding apparatus 1600 and the decoding apparatus 1700.

The embodiments may be performed for each of a luma signal and a chroma signal, and may be equally performed for the luma signal and the chroma signal.

The form of a block to which the embodiments are applied may have a square or non-square shape.

Whether at least one of the above-described embodiments is to be applied and/or performed may be determined based on a condition related to the size of a block. In other words, at least one of the above-described embodiments may be applied and/or performed when the condition related to the size of a block is satisfied. The condition includes a minimum block size and a maximum block size. The block may be one of blocks described above in connection with the embodiments and the units described above in connection with the embodiments. The block to which the minimum block size is applied and the block to which the maximum block size is applied may be different from each other.

For example, when the block size is equal to or greater than the minimum block size and/or less than or equal to the maximum block size, the above-described embodiments may be applied and/or performed. When the block size is greater than the minimum block size and/or less than or equal to the maximum block size, the above-described embodiments may be applied and/or performed.

For example, the above-described embodiments may be applied only to the case where the block size is a predefined block size. The predefined block size may be 2×2, 4×4, 8×8, 16×16, 32×32, 64×64, or 128×128. The predefined block size may be (2*SIZE_{X})×(2*SIZE_{Y}). SIZE_{X} may be one of integers of 1 or more. SIZE_{Y} may be one of integers of 1 or more.

For example, the above-described embodiments may be applied only to the case where the block size is equal to or greater than the minimum block size. The above-described embodiments may be applied only to the case where the block size is greater than the minimum block size. The minimum block size may be 2×2, 4×4, 8×8, 16×16, 32×32, 64×64, or 128×128. Alternatively, the minimum block size may be (2*SIZE_{MIN_X})×(2*SIZE_{MIN_Y}). SIZE_{MIN_X} may be one of integers of 1 or more. SIZE_{MIN_Y} may be one of integers of 1 or more.

For example, the above-described embodiments may be applied only to the case where the block size is less than or equal to the maximum block size. The above-described embodiments may be applied only to the case where the block size is less than the maximum block size. The maximum block size may be 2×2, 4×4, 8×8, 16×16, 32×32, 64×64, or 128×128. Alternatively, the maximum block size may be (2*SIZE_{MAX_X})×(2*SIZE_{MAX_Y}). SIZE_{MAX_X} may be one of integers of 1 or more. SIZE_{MAX_Y} may be one of integers of 1 or more.

For example, the above-described embodiments may be applied only to the case where the block size is equal to or greater than the minimum block size and is less than or equal to the maximum block size. The above-described embodiments may be applied only to the case where the block size is greater than the minimum block size and is less than or equal to the maximum block size. The above-described embodiments may be applied only to the case where the block size is equal to or greater than the minimum block size and is less than the maximum block size. The above-described embodiments may be applied only to the case where the block size is greater than the minimum block size and is less than the maximum block size.

In the above-described embodiments, the block size may be a horizontal size (width) or a vertical size (height) of a block. The block size may indicate both the horizontal size and the vertical size of the block. The block size may indicate the area of the block. Each of the area, minimum block size, and maximum block size may be one of integers equal to or greater than 1. In addition, the block size may be the result (or value) of a well-known equation using the horizontal size and the vertical size of the block, or the result (or value) of an equation in embodiments.

Further, in the embodiments, a first embodiment may be applied to a first size, and a second embodiment may be applied to a second size.

The embodiments may be applied depending on a temporal layer. In order to identify a temporal layer to which the embodiments are applicable, a separate identifier may be signaled, and the embodiments may be applied to the temporal layer specified by the corresponding identifier. Here, the identifier may be defined as the lowest (bottom) layer and/or the highest (top) layer to which the embodiments are applicable, and may be defined as being indicating a specific layer to which the embodiments are applied. Further, a fixed temporal layer to which the embodiments are applied may also be defined.

For example, the embodiments may be applied only to the case where the temporal layer of a target image is the lowermost layer. For example, the embodiments may be applied only to the case where the temporal layer identifier of a target image is equal to or greater than 1. For example, the embodiments may be applied only to the case where the temporal layer of a target image is the highest layer.

A slice type or a tile group type to which the embodiments to which the embodiments are applied may be defined, and the embodiments may be applied depending on the corresponding slice type or tile group type.

In the above-described embodiments, it may be construed that, during the application of specific processing to a specific target, assuming that specified conditions may be required and the specific processing is performed under a specific determination, a specific coding parameter may be replaced with an additional coding parameter when a description has been made such that whether the specified conditions are satisfied is determined based on the specific coding parameter, or such that the specific determination is made based on the specific coding parameter. In other words, it may be considered that a coding parameter that influences the specific condition or the specific determination is merely exemplary, and it may be understood that, in addition to the specific coding parameter, a combination of one or more additional coding parameters functions as the specific coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the disclosure.

The above-described embodiments include examples in various aspects. Although all possible combinations for indicating various aspects cannot be described, those skilled in the art will appreciate that other combinations are possible in addition to explicitly described combinations. Therefore, it should be understood that the present disclosure includes other replacements, changes, and modifications belonging to the scope of the accompanying claims.

The above-described embodiments according to the present disclosure may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present disclosure, or may be known to or available to those who have ordinary knowledge in the field of computer software.

A computer-readable storage medium may include information used in the embodiments of the present disclosure. For example, the computer-readable storage medium may include a bitstream, and the bitstream may contain the information described above in the embodiments of the present disclosure.

A bitstream may include a computer-executable code and/or program. A computer-executable code and/or program may include information described in embodiments and may include syntax elements described in embodiments. In other words, information and syntax elements described in embodiments may be considered as a computer-executable code within a bitstream and may be considered as at least a part of a computer-executable code and/or program expressed in a bitstream. The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

As described above, although the present disclosure has been described based on specific details such as detailed components and a limited number of embodiments and drawings, those are merely provided for easy understanding of the entire disclosure, the present disclosure is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present disclosure.

1. A method of decoding an image, the method comprising:
deriving a first initial motion vector and a second initial motion vector for a target block;
performing a bilateral matching (BM) search for a first BM reference image and a second BM reference image by using the first initial motion vector and the second initial motion vector; and
reconstructing the target block by using a first BM reference block and a second BM reference block obtained through the BM search.

2. The method of claim 1, wherein a BM optimal block is derived based on an average operation or a weighted sum operation of the first BM reference block and the second BM reference block.

3. The method of claim 2, wherein the BM optimal block is configured as a prediction block of the target block.

4. The method of claim 2, wherein a final prediction block of the target block is obtained by performing a weighted sum operation between the BM block and an intra prediction block obtained by performing an intra prediction on the target block.

5. The method of claim 4, wherein the intra prediction block is obtained by using an intra prediction mode predefined in a decoder.

6. The method of claim 4, wherein an intra prediction mode for the intra prediction is derived from the first BM reference block or the second BM reference block encoded by the intra prediction.

7. The method of claim 4, wherein a first weight applied to the intra prediction block and a second weight applied to the BM optimal block are determined by comparing a threshold value with matching criteria between the first BM reference block and the second BM reference block.

8. The method of claim 2, wherein a final prediction block of the target block is obtained by performing a weighted sum operation between the BM block and an inter prediction block obtained by performing an inter prediction on the target block.

9. The method of claim 8, wherein the first BM reference image or the second BM reference image is configured as a reference image for the inter prediction.

10. The method of claim 2, wherein a residual block of the target block is derived as a sum of a prediction residual block and a BM residual block,
wherein the BM residual block is obtained from residual coefficients decoded from a bitstream, and
wherein a residual block of the BM optimal block is configured as the prediction residual block.

11. The method of claim 10, wherein the residual block of the BM optimal block is derived by subtracting a prediction block of the target block from the BM optimal block.

12. The method of claim 10, wherein residual samples in the residual block are reconstructed by using prediction residual samples in the prediction residual block only in a partial region of the target block.

13. The method of claim 1, wherein the first initial motion vector is derived based on Advanced Motion Vector Prediction (AMVP) encoding information, and
wherein the second initial motion vector is derived based on merge encoding information.

14. The method of claim 1, wherein the first initial motion vector is configured to be a same as a motion vector of a merge candidate included in a merge candidate list, and
wherein a vector that a size is a same as and a direction is opposite to the first initial motion vector is configured as the second initial motion vector.

15. The method of claim 1, wherein the BM search is performed only in a BM search region within the first BM reference image and the second BM reference image.

16. The method of claim 15, wherein a shape of the BM search region is determined based on index information indicating one of shape candidates, and
wherein among the shape candidates, a first shape candidate is a rectangular shape and a second shape candidate is a rhombus shape.

17. The method of claim 15, wherein the BM search region is configured as N times a size of a basic unit (N is a natural number greater than or equal to 1) based on a position indicated by an initial motion vector, and
wherein the basic unit is at least one of the target unit, a coding tree unit or a virtual pipeline data unit (VPDU).

18. The method of claim 17, wherein when at least a part of a region to be configured as the BM search region is beyond an image boundary, a residual region excluding a region beyond the image boundary is configured as the BM search region.

19. A method of encoding an image, the method comprising:
deriving a first initial motion vector and a second initial motion vector for a target block;
performing a bilateral matching (BM) search for a first BM reference image and a second BM reference image by using the first initial motion vector and the second initial motion vector; and
encoding the target block by using a first BM reference block and a second BM reference block obtained through the BM search.

20. A recording medium storing a bitstream generated by an image encoding method, the recording medium comprising:
deriving a first initial motion vector and a second initial motion vector for a target block;
performing a bilateral matching (BM) search for a first BM reference image and a second BM reference image by using the first initial motion vector and the second initial motion vector; and
encoding the target block by using a first BM reference block and a second BM reference block obtained through the BM search.
